(19) United States
(12) Patent Application Publication
(10) Pub. No.: US 2003/0195896 A1
(43) Pub. Date: Oct. 16, 2003

(54) Method and apparatus for managing imported or exported data

(76) Inventors: Aruna Rohra Suda, Yokohama-Shi (JP); Suresh Jeyachandran, Yokohama-Shi (JP); Prem Anand Joseph, Yokohama-Shi (JP)

Correspondence Address: MORGAN & FINNEGAN, L.L.P., 345 Park Avenue, New York, NY, 10154-0053, US

(21) Appl. No.: 10/387,005

(22) Filed: Mar. 12, 2003

(30) Foreign Application Priority Data
Apr. 15, 2002 (JP) 2002-111801
Jul. 5, 2002 (JP) 2002-198009

(51) Int. Cl. G06F 17/00

(52) U.S. Cl. 707/101

(57) ABSTRACT

In a data processing apparatus, data displayed by a browser are obtained, data to be displayed are imported without displaying the data, and the obtained data and the imported data are stored in a memory and managed with distinguishing between the obtained data and the imported data. A data specified from the managed data can be exported to a database.

### CLAIM FOR PRIORITY

This application claims priority from Application Nos. 2002-111801 and 2002-198009, filed on Apr. 15, 2002 and Jul. 5, 2002 respectively in JAPAN.

### FIELD

This invention relates to a data processing method and apparatus, and more particularly a method and apparatus for processing data obtained from the Internet.

### BACKGROUND

A conventional personal computer can access and display data in an Internet using browser software. The conventional computer also can open a file application and store data in a file. A computer which can store a page currently displayed by the browser is proposed.

However the data to be displayed by the browser is not stored until the data is displayed. The data to be stored must be displayed if the display of the data is not required by the user.

Accordingly, there is a need for a method and apparatus that resolves the above-mentioned problems.

### SUMMARY

According to one of the embodiments, the present invention relates to a data processing method comprising the steps of obtaining data displayed by a browser; importing data without displaying the data; and storing and managing the obtained data and the imported data.

According to another embodiment, the present invention relates to a data processing method comprising the steps of obtaining data displayed by a browser; storing and managing the obtained data; and exporting the managed data.

According to still another embodiment, the present invention relates to a data processing apparatus comprising obtaining means for obtaining data displayed by a browser; importing means for importing data without displaying the data; and management means for storing and managing the obtained data and the imported data.

According to yet another embodiment, the present invention relates to a data processing apparatus comprising obtaining means for obtaining data displayed by a browser; management means for storing and managing the obtained data; and exporting means for exporting the managed data.

According to a further embodiment, the present invention relates to a computer-executable program for controlling a computer to perform data processing, said program comprising codes for causing the computer to perform the steps of obtaining data displayed by a browser; importing data without displaying the data; and storing and managing the obtained data and the imported data.

According to a further embodiment, the present invention relates to a computer-executable program for controlling a computer to perform data processing, said program comprising codes for causing the computer to perform the steps of obtaining data displayed by a browser; storing and managing the obtained data; and exporting the managed data.

Other features and advantages of the present invention will be apparent from the following description taken in conjunction with the accompanying drawings, in which like reference characters designate the same or similar parts throughout the figures thereof.

### BRIEF DESCRIPTION OF THE FIGURES

The accompanying drawings, which are incorporated in and constitute a part of the specification, illustrate embodiments of the invention and, together with the description, serve to explain the principles of the invention.

FIG. 1 is a block diagram illustrating the hardware configuration according to an embodiment of the present invention.

FIG. 2 shows the functional block diagram of information processing system embodying the present invention.

FIG. 3 is a flowchart of the main procedural steps.

FIG. 4 is a flowchart of INITIALIZE procedure.

FIG. 5 is a flowchart of MAIN-PROCESSOR.

FIG. 6 is a flowchart of the procedural steps of UserAction.

FIG. 7 is a flowchart of the procedural steps of CheckExisting.

FIG. 8 is a flowchart of the procedural steps of Annotate.

FIG. 9 is a flowchart of the procedural steps of Extract.

FIG. 10 is a flowchart of the procedural steps of Mgmt.

FIG. 11 is a flowchart of the procedural steps of ShowSession.

FIG. 12 is a flowchart of the procedural steps of ShowLinks.

FIG. 13 is a flowchart of the procedural steps of ExecuteAction.

FIG. 14 is a flowchart of the procedural steps of SaveContents.

FIG. 15 is a flowchart of the procedural steps of WebFetch.

FIG. 16 is a flowchart of the procedural steps of SendContents.

FIG. 17 is a flowchart of the procedural steps of SaveFileContents.

FIG. 18 is a flowchart of the procedural steps of FillKptAction.

FIG. 19 is a flowchart of the procedural steps of TERMINATE.

FIG. 20 is a flowchart of KPTIMPORT.

FIG. 21 is a flowchart of the procedural steps of ImportData.

FIG. 22 is a flowchart of the procedural steps of IndexData.

FIG. 23 is a flowchart of KPTEXPORT.

FIG. 24 is a flowchart of the procedural steps of ExportData.

FIGS. 25 and 26 show examples of the knowledge structures in the knowledge base.

FIGS. 27 and 28 show examples content of the knowledge base.

FIG. 29 is an example of Import UI.

FIG. 30 is an example user interface of browsing files to import.

FIG. 31 is an example of Show all Links sorted by Domain.

FIG. 32 is an example of Show all Links sorted by Organizations.

FIG. 33 is an example of Show Sessions.

FIG. 34 is an example of Show all Links sorted by Keywords.

FIG. 35 is another example of Show Sessions, in which the imported conference sessions are shown.

FIG. 36 is another example of Show all Links sorted by Keywords, for imported conference information.

FIG. 37 is a warning dialog to prompt the user to insert the CD containing the full proceedings of the conference.

FIG. 38 is another example of Show all Links sorted by Keywords, for imported conference information.

FIG. 39 is another example of Show all Links sorted by Organizations, for imported conference information.

FIG. 40 is another example of Show all Links, sorted by Table of Contents.

FIG. 41 is another example of Show Sessions, in which the conference information and other web information saved are shown in separate nodes.

FIG. 42 is another example of Show all Links, sorted by Keywords, in which the conference information and other web information saved are shown in separate nodes.

FIG. 43 is another example of Show all Links, first sorted by Organization and then by Authors below each node.

FIG. 44 is another example of Show all Links, sorted by Authors and Organization.

FIG. 45 is an example user interface of AutoFetch List.

FIG. 46 is an example user interface of specifying a new auto fetch instruction.

FIG. 47 is an example user interface for specifying the output report to be generated.

FIG. 48 is an example user interface to specify the information sources to look for.

FIG. 49 is an example of Show Sessions of the auto fetch results.

FIG. 50 is another example of Show Sessions of the auto fetch results in a graphical format.

FIG. 51 is another example of Show Sessions of the auto fetch results in a graphical format.

FIGS. 52, 53 and 54 are examples of Show Sessions of the imported information.

FIG. 55 is another example of Get all Links for imported association members.

FIG. 56 is an example user interface of Export.

FIG. 57 is an example user interface to specify the information to be exported.

FIG. 58 is an example user interface to specify some parameters for export.

FIG. 59 is an example user interface to specify the format of the information to be exported.

FIG. 60 is an example of exported data in a browser independent format.

FIG. 61 is another example of exported data, in which the information can be sorted by the user.

FIG. 62 is another example user interface to specify the information to be exported.

FIG. 63 is an example output of the exported address book data.

FIG. 64 is an example output of the exported address book data in CSV format.

FIG. 65 is an example output of the exported address book data in Text format.

FIG. 66 is an example output of the exported address book data in HTML format.

FIG. 67 is example information as seen in a browser of the exported address book data.

FIG. 68 is an example of viewing the published information from this embodiment.

FIG. 69 is a flowchart of the procedural steps of ShowLinks.

FIG. 70 is a flowchart of the procedural steps of CreateTree.

FIG. 71 is a flowchart of the procedural steps of SortTreeView.

FIG. 72 is a flowchart of the procedural steps of ShowTreeView.

FIG. 73 is a flowchart of the procedural steps of ProcessLeafAction.

FIG. 74 is a flowchart of the procedural steps of ProcessNodeAction.

FIG. 75 is another example of user interface for Import.

FIG. 76 is an example user interface to specify the emails to be imported.

FIG. 77 is another flowchart of the procedural steps of SaveContents.

FIG. 78 is another flowchart of the procedural steps WebFetch.

FIG. 79 is an example of Get all Links sorted by Sender for the imported email information.

FIG. 80 is another example of Get all Links sorted by Sender for the imported email information.

FIG. 81 is an example of Show Sessions for the imported email information.

FIG. 82 is an example of Get all Links sorted by Name for the imported documents.

FIG. 83 is another example of Get all Links sorted by Name for the imported documents.

FIG. 84 is a flowchart of the procedural steps of ImportData.

FIG. 85 is a flowchart of the procedural steps of GetType.

FIG. 86 is a flowchart of the procedural steps of SetIndex.

### DETAILED DESCRIPTION

A preferred embodiment of the present invention will now be described in detail with reference to the accompanying drawings.

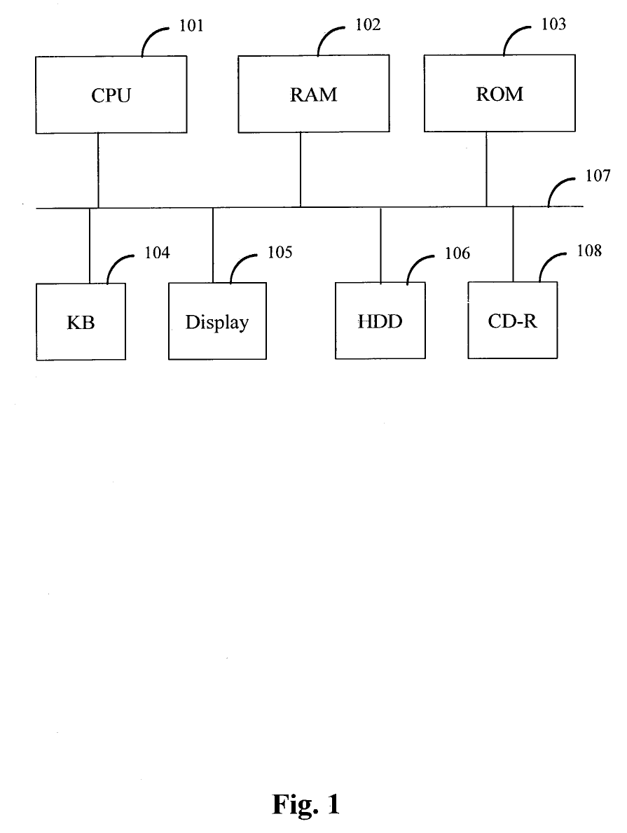

FIG. 1 is a block diagram illustrating the hardware configuration according to an embodiment of the present invention. In this figure, a central processing unit (CPU) 101 is operative to perform operations for various processing and make a logical decision or the like and further controls each composing element connected to a bus 107.

A RAM 102 temporarily stores variables and intermediate data generated during the processing. A program from an external source may be loaded into the RAM 102. A ROM 103 is used to store programs, which correspond to individual flowcharts that will be described later and which are to be executed by the CPU 101, and fixed data.

A keyboard (KB) 104 is used for inputting data and an instruction by a user. A mouse or other input devices may be used with the keyboard 104. Display 105 displays data and a hard disk drive (HDD) stores data of a database, a program, and the like.

The bus 107 is used to transfer an address signal indicating a composing element to be controlled by the CPU 101, a control signal used for controlling each composing element and data to be exchanged between the composing equipments.

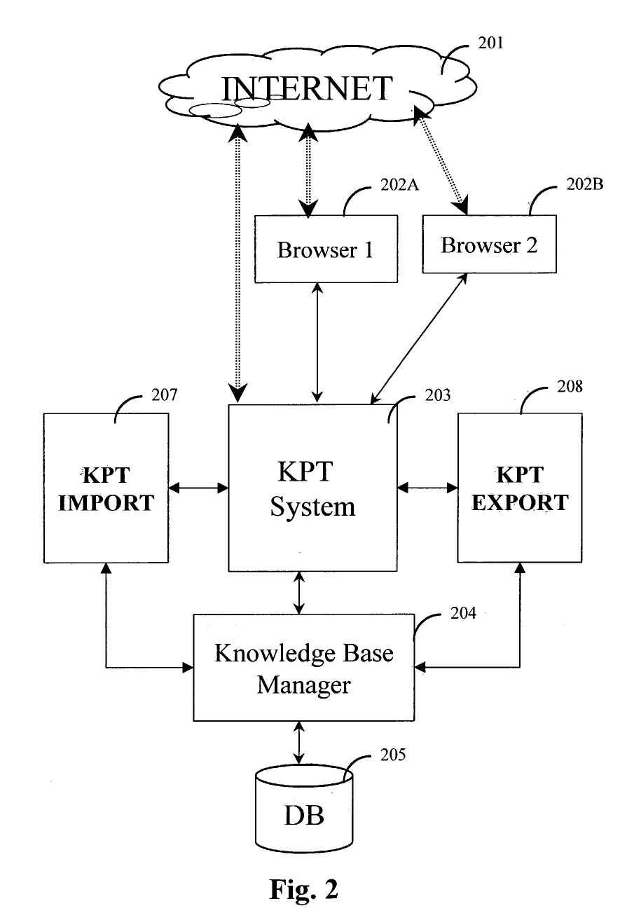

FIG. 2 shows the functional block diagram of information processing system embodying the present invention. The information on the Internet 201 is browsed using multiple browsers 202A, 202B simultaneously. Information Management System, KPT System 203 is for managing information. KPT System interacts and acts as a controlling system as explained in detail in this embodiment to Browser 202, KPT IMPORT 207, to import information and KPT EXPORT 208 to export the information, as explained in detail in this embodiment. Knowledge Base Management 204 is the management of knowledge accessed/stored from/to the Database 205. KPT System also handles and processes the information from individual browsers separately as independent sessions.

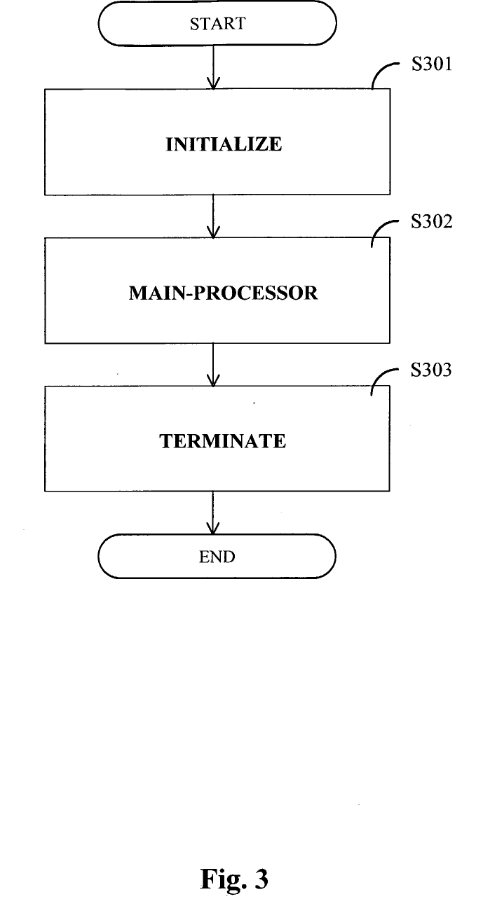

FIG. 3 is a flowchart of the main procedural steps of KPT System. In step S301, initialization processes to connect to the Internet are executed. In step S302, main function processing browsing, annotating, saving etc. of this embodiment is performed. In step S303, terminate or clean-up processing is executed.

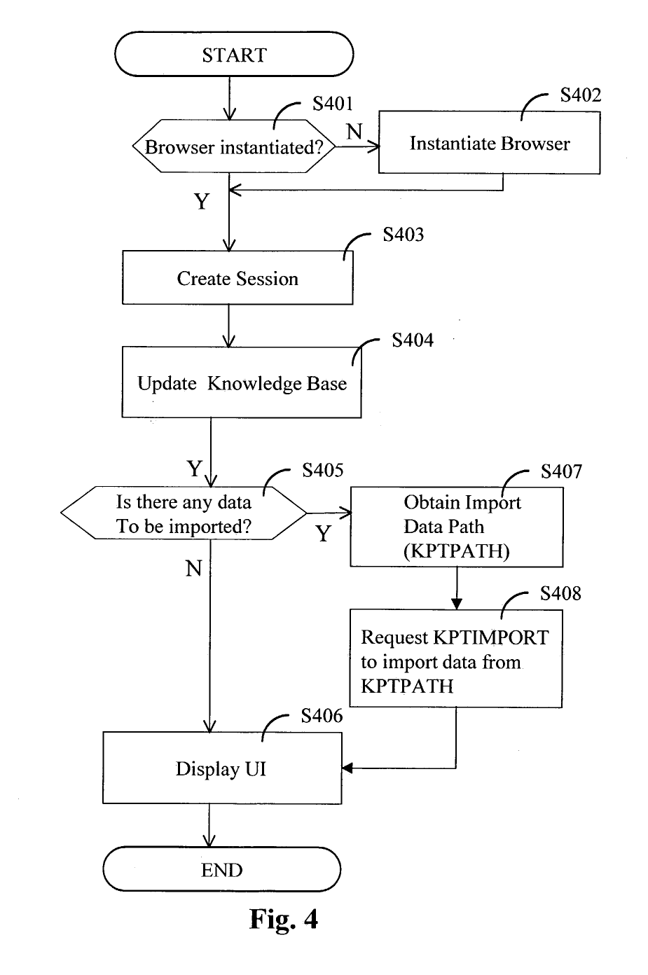

FIG. 4 is a flowchart of INITIALIZE procedure of step S301. In step S401 a check is made to determine if the browser needs to be instantiated or not. If browser is not instantiated, it is instantiated in step S402. In step S403, a new session is created. In step S404, the knowledge base is updated. A check is made in step S405 to determine if there is any information to be imported. If so, the import data path, KPTPATH is obtained in step S407 and a request is made to KPTIMPORT to import the information from KPTPATH, in step S408. In either case, step S406 is executed, wherein the main user interface is displayed and the process ends.

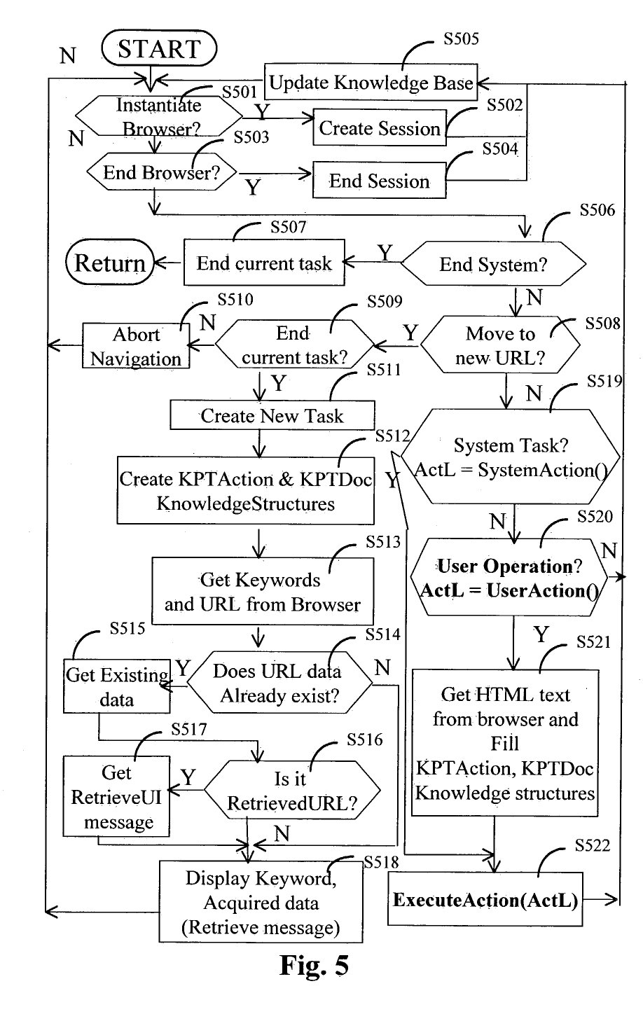

FIG. 5 is a flowchart of MAIN-PROCESSOR of step S302. In step S501, a check is made to determine if the browser was instantiated or not. If so, a new session is created in step S502 and the process proceeds to step S505, wherein the knowledge base is updated. If not, a check is made in step S503 to determine if the browser was terminated or ended. If so, the session associated with the browser is ended and proceeds to step S505. If not, a check is made in step S506 to determine if an action was performed to end the system. If so, all the current tasks are terminated in step S507 and the process returns.

If not, a check is made in step S508 to determine if the user is navigating to a new URL. If so, a check is made in step S509 to confirm with the user that the current task should be terminated. If not, the process proceeds to step S510, where the navigation is aborted and the process continues to step S501. If the current task is to be ended in step S509, step S511 is executed wherein, the previous task is terminated and then a new task is created. In step S512, the knowledge structures KPTAction and KPTDocument are created.

In step S513, the URL and the keywords are obtained from the Browser. A check is made in step S514 to determine if the URL data already exists in the knowledge base. If so, all the existing data for the current URL is procured from the knowledge base in step S515 and moves to step S516, where a check is made to determine if it is a RetrievedURL i.e., the user is trying to view the contents of an already stored page. If so, step S517 is executed to get the RetrieveUI message and control goes to S518. If URL data does not already exist in step S514, step S518 is executed to display the keywords, other acquired data from browser like the URL, page title etc . . . and other existing data if any from the knowledge base like Keep As, validity period etc . . . and the process proceeds to step S501.

In step S508, if the user is not moving to a new URL, a check is made in step S519 to determine if any SystemTask ActL needs to be executed. If so, step S522 ExecuteAction (ActL) is executed and the control moves to step S505 to update the knowledge base. If not, a check is made in step S520 to determine if any User Operation was performed. If not, step S505 is executed, otherwise in step S521, the HTML text is obtained from the browser and the KPTAction and KPTDocument structures created in step S512 are updated and ExecuteAction(ActL) for the UserAction is executed in step S522 and the process moves to step S505 to update the knowledge base.

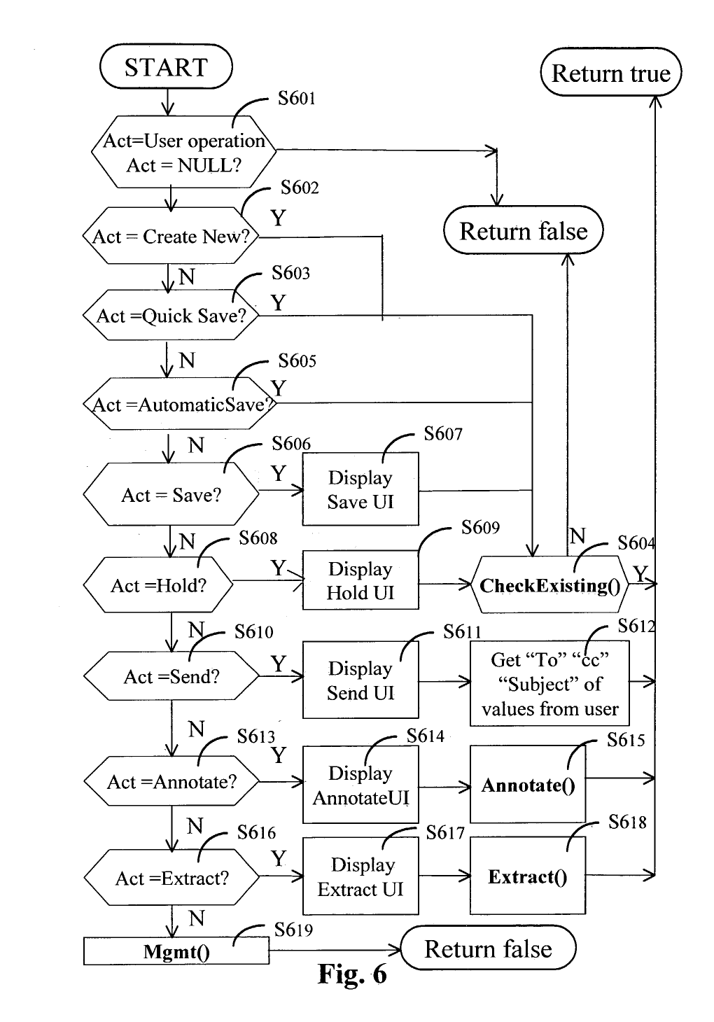

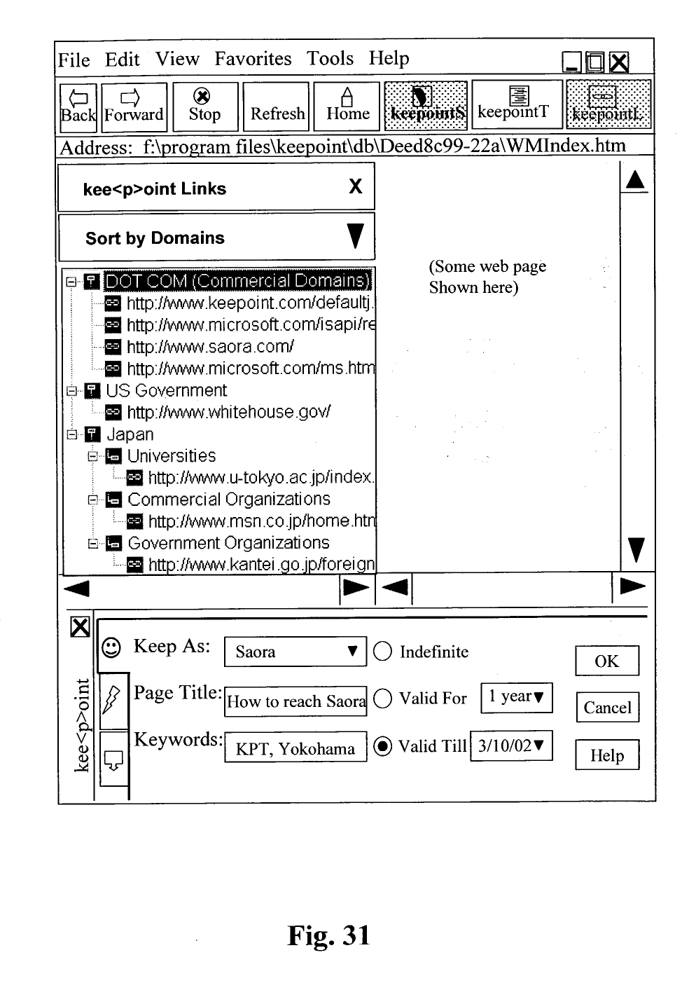

FIG. 6 is a flowchart of the procedural steps of S520 UserAction. A check is first made in step S601 to set Act equal to the User operation performed by user and to determine if Act is equal to NULL. If so, the process returns false. If it is not NULL, the process proceeds to step S602, a check is made to determine whether Act is Create New. If so, the process proceeds to step S604. If not, the process proceeds to step S603, a check is made to determine whether Act is Quick Save. If so, the process proceeds to step S604. If not, a check is made in step S605 to determine whether Act is Automatic Save. If so, the process proceeds to step S604. If not, a check is made in step S606 to determine whether Act is Save. If Act is Save, Save UI, an example of which is shown in FIG. 31, is displayed in step S607 and proceeds to step S604. If not, a check is made in step S608 to determine if the Act is Hold. If so, Hold UT is displayed in step S609 and proceeds to step S604. In step S604, a check is made to determine if the information being saved or held is already exists using CheckExisting, which is explained in detail later and if so, returns true, otherwise return false.

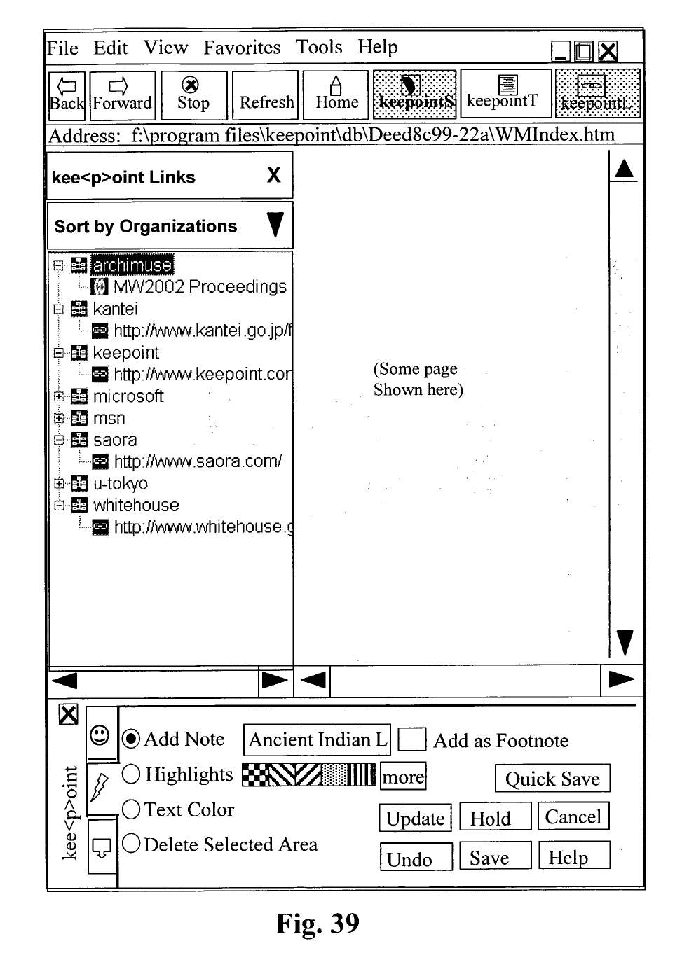

In step S608, if Act is not Hold, a check is made in step S610 to determine if the Act is Send. If so, Send UI, is displayed in step S611 and the recipients (To, CC) information, Subject, Contents and/or the like are obtained from the user in step S612 and proceeds to step S620. If not, a check is made in step S613 to determine if Act is Annotate. If so, Annotate UT, an example of which is shown in FIG. 39 is displayed in step S614 and the actual Annotations executed using Annotate, which is explained in detail later, in step S615 and process returns true. If not, a check is made in step S616 to determine if Act is Extract.

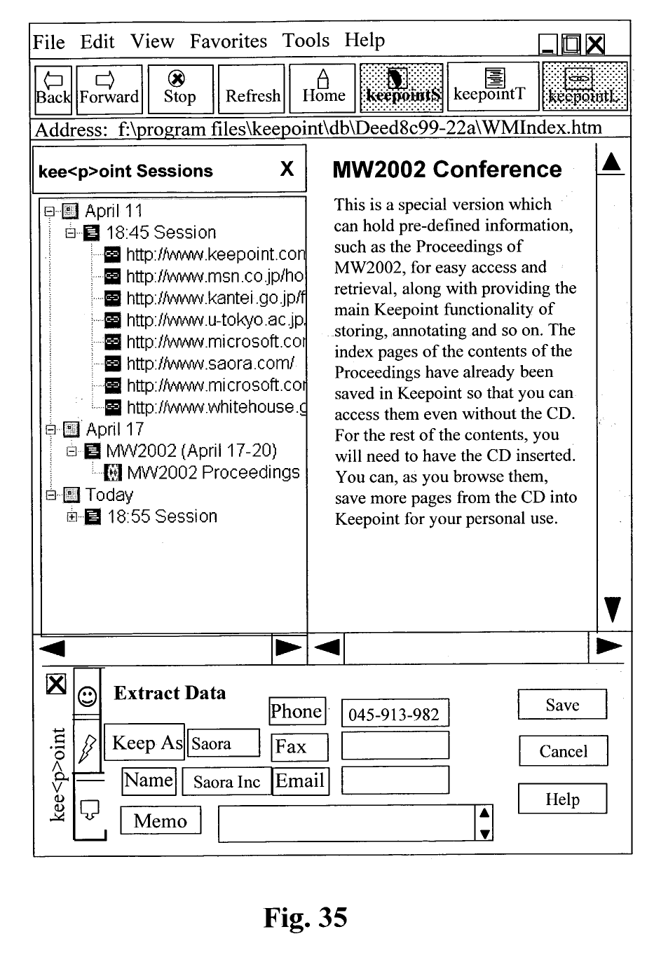

If so, Extract UI, an example of which is shown in FIG. 35, is displayed in step S617 and the actual Extract information executed using Extract, which is explained in detail later, in step S618 and process returns true. If not, Mgmt, which is explained in detail later, is executed in step S619 and process returns false.

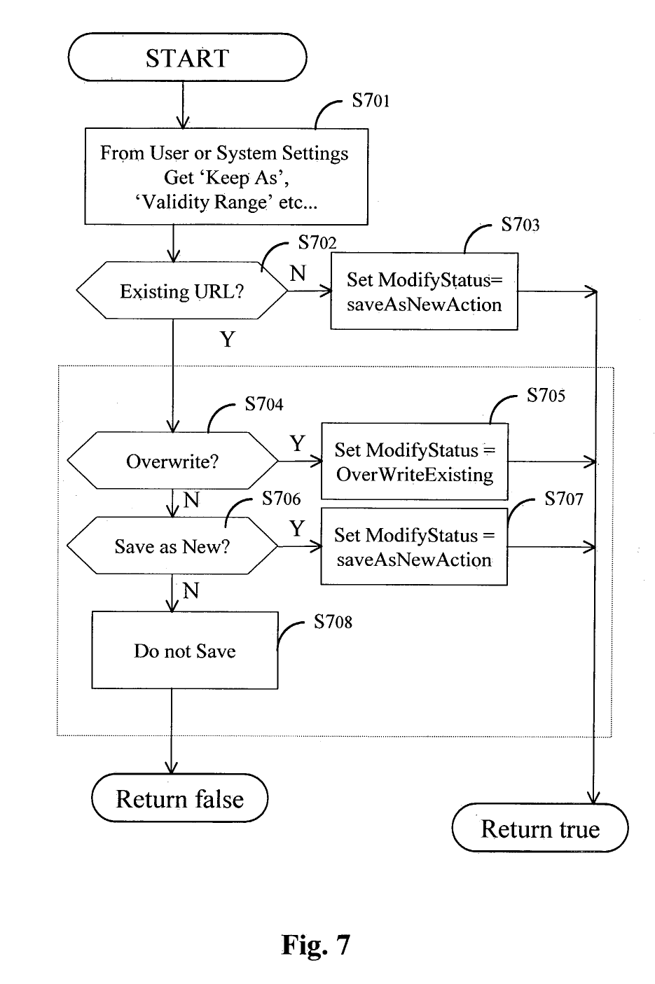

FIG. 7 is a flowchart of the procedural steps of S604 CheckExisting to check if the information already exists in the knowledge base or not. In step S151, the values of Keep As, Validity Range etc . . . are either obtained from the user or from the system settings. In step S152, a check is made to determine whether the URL already exists. If URL does not exist, the process proceeds to step S153 where Modifystatus is set to SaveAsNewAction is set to and returns true. If URL exists, a check is made in step S154 to determine if the information needs to be over-written (i.e., update or modify the previous information). This is done either by asking the user, whether he would like to overwrite the existing information, save as new do not save or based on the user settings. If so, in step S155, ModifyStatus is set to OverWriteExisting and the process returns true. If not, a check is made in step S156 to determine if the information needs to be saved as new, (i.e., without modifying the existing information, save the current information as a separate entity). If so, ModifyStatus is set to saveAsNewAction and the process returns true. If not, the process returns false.

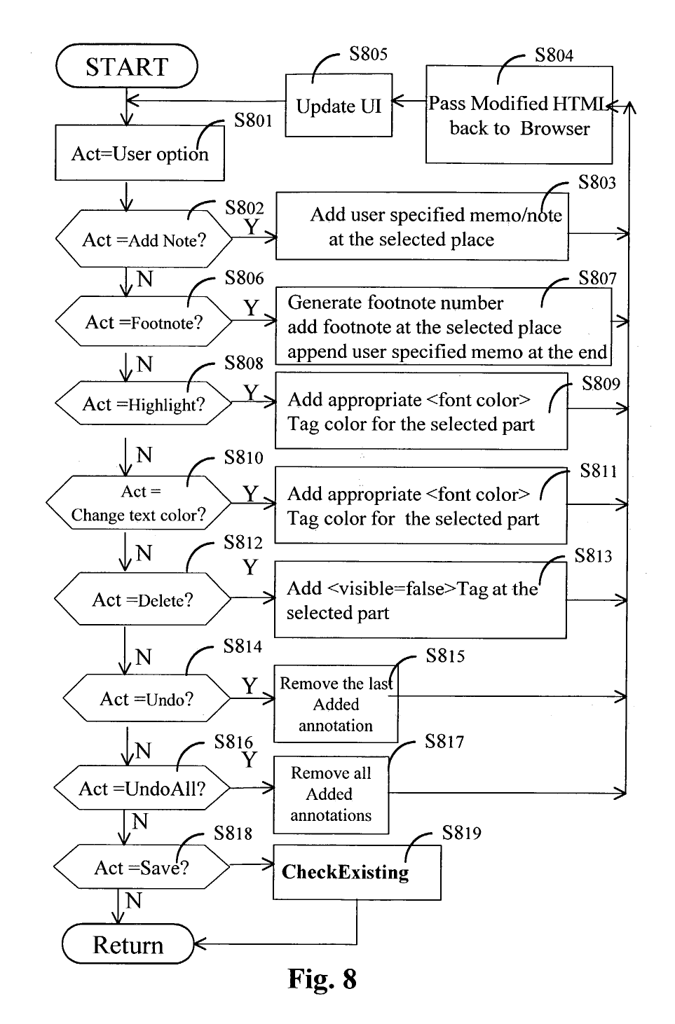

FIG. 8 is a flowchart of the procedural steps of S615 Annotate and FIG. 39 shows an example user interface for annotating a web page currently being browsed. In step S801, the user-performed operation is set to Act. A check is made in step S802 to determine if Act is Add Note. If so, the user specified memo/note is added to the selected place in step S803 and goes to step S804. If not, a check is made in step S806 to determine if the Act is Footnote. If so, the footnote number is created based on a sequence and the footnote number is added to the selected place in the page and the actual contents of the footnote are added to the end of the page in form of a table and proceeds to step S804. The notes added to the page are added based on user settings, to set the “annotation demarkers”, “default annotation text”, the color of annotation etc. The annotations are added as standard HTML tags. If Act is not Footnote in step S806, a check is made in step S808 to determine if the Act is Highlight. If so, a Font tag <font bgcolor= . . . > is added around the selected text with the background color set to the selected color in step S809 and proceeds to step S804. If not, a check is made in step S810 to determine if the Act is Change text color. If so, a Font tag <font color= . . . > is added around the selected text with the foreground color set to the selected color in step S811 and proceeds to step S804. If not, a check is made in step S812 to determine if Act is Delete. If so, the tag is modified to <visible=false> to hide the selected part of the text in step S813 and proceeds to step S804. If not, a check is made in step S814 to determine if Act is Undo. If so, the last performed annotation is undone and proceeds to step S804. If not, a check is made in step S816 to determine if Act is UndoAll. If so, all the annotation performed by the user on this page during this session are removed and proceeds to step S804. If not a check is made in step S818 to determine if the Act is Save, in which case step S819, CheckExisting explained earlier is executed. In either case the function returns, if no more action needs to be performed by the user. In step S804, the modified HTML tag page is passed back to the browser, which will render and update the UI in step S805 and return to step S801. If Act is none of the ones specified in the flowchart, the function returns.

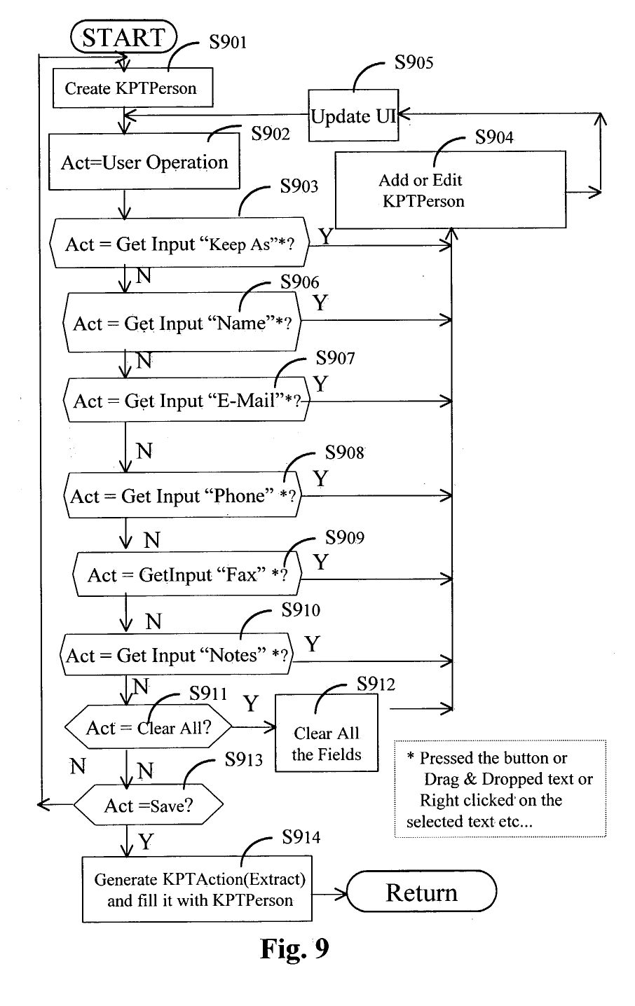

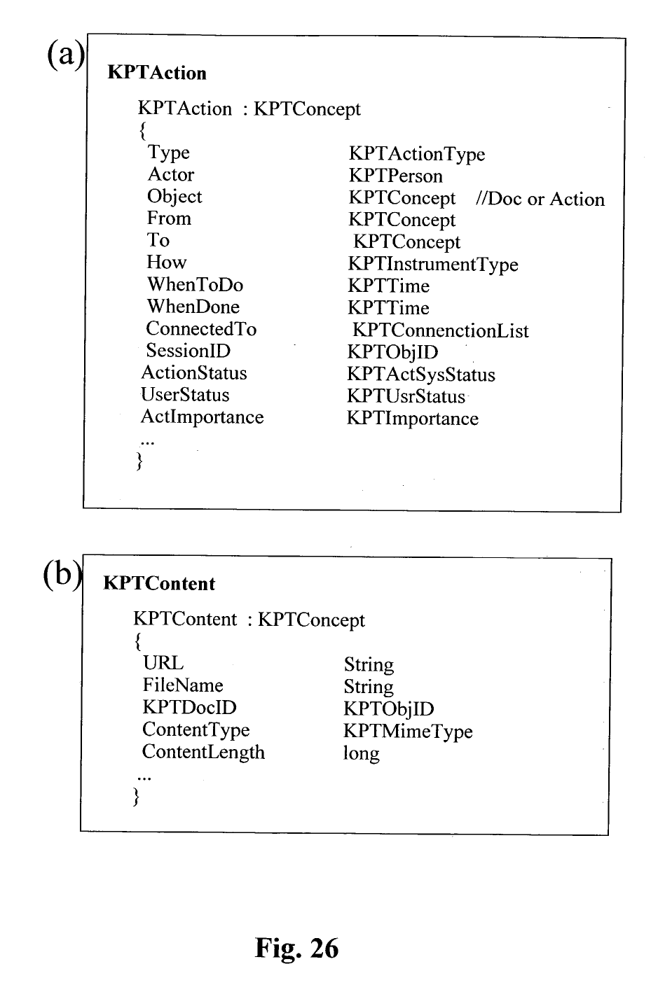

FIG. 9 is a flowchart of the procedural steps of S618 Extract. In step S901, an instance of the knowledge structure for person—KPTPerson is created. In step S902, the User operation is set to Act. An example User interface to describe some of the action is shown in FIG. 26. First a check is made to determine the type of Act (i.e., if Keep As, Name, Email, Phone, Fax, Notes) was input by the user (steps S903, S907˜S910). This action can be performed in various ways, like first selecting the text to be extracted and pressing a predefine button, or dragging and dropping the text to be extracted to the appropriate field or by right clicking on the selected text and specifying it to be the extracted data. If so, the KPTPerson knowledge structure is modified appropriately in step S904 and the UI gets updated in step S905 and the process returns to S902. If the Act is Clear All (step S911), all the fields are cleared in step S912 and process proceeds to S904. If the Act is Save (step S913), a new action KPTAction is created of type Extract and the KPTPerson is filled as associate object and the process returns.

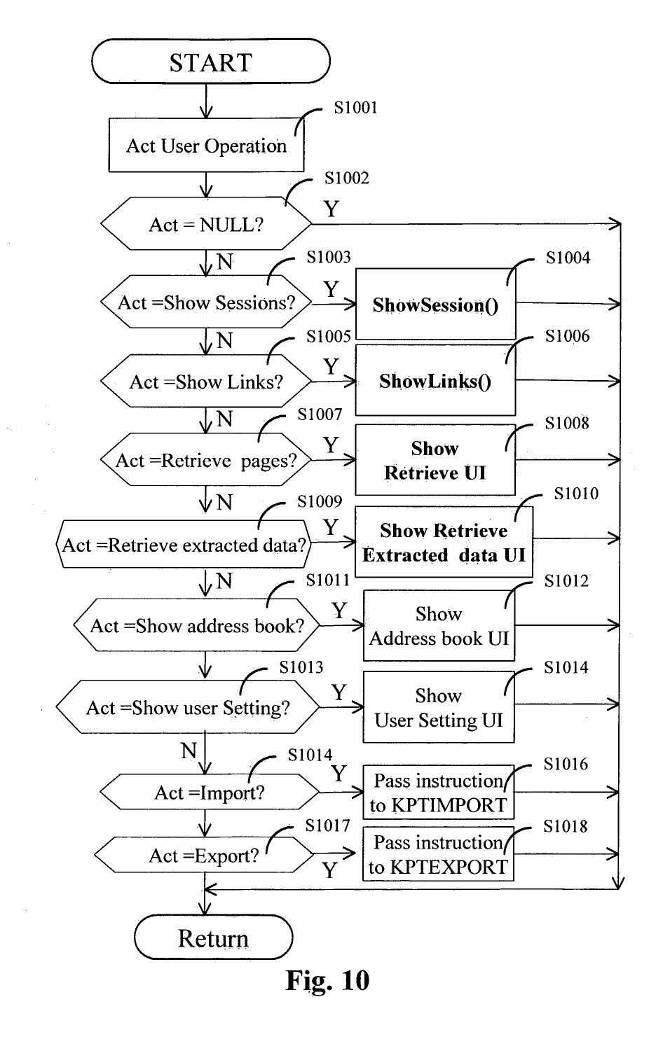

FIG. 10 is a flowchart of the procedural steps of S619 Mgmt. In step S1001, Act is set to the user-performed operation. In step S1002, a check is made to determine if Act is NULL. If so, the process returns. If not, a check is made in step S1003 to determine if Act is Show Sessions. If so, ShowSession is executed, in which all the links are sorted in time order and displayed in step S1004 and the process returns. If not, a check is made in step S1005 to determine if the Act is Show Links. If so, ShowLinks is executed, in which all the links are sorted in the specified order and displayed in step S1006 and the process returns. If not, a check is made in step S1007 to determine whether Act is Retrieve pages. If Act is to retrieve a page, the process proceeds to step S1008 where RetrieveUI is displayed. If not, a check is made in step S 1009 to determine if Act is Retrieve extracted data. If so, Show Retrieve Extracted data UI is displayed. If not, a check is made in step S1011 to determine if Act is Show address book. If so, Show Address book UI is displayed and the process returns. If not a check is made in step S1013 to determine if Act is Show User Settings. If so, the user settings are displayed to the user in step S1014 and the process returns. If not a check is made in step S1014 to determine if Act is Import. If so, the import instruction is passed on to KPTIMPORT in step S1016 and the process returns. If not a check is made in step S1017 to determine if Act is Export. If so, the export instruction is passed on to KPTEXPORT in step S1018 and the process returns

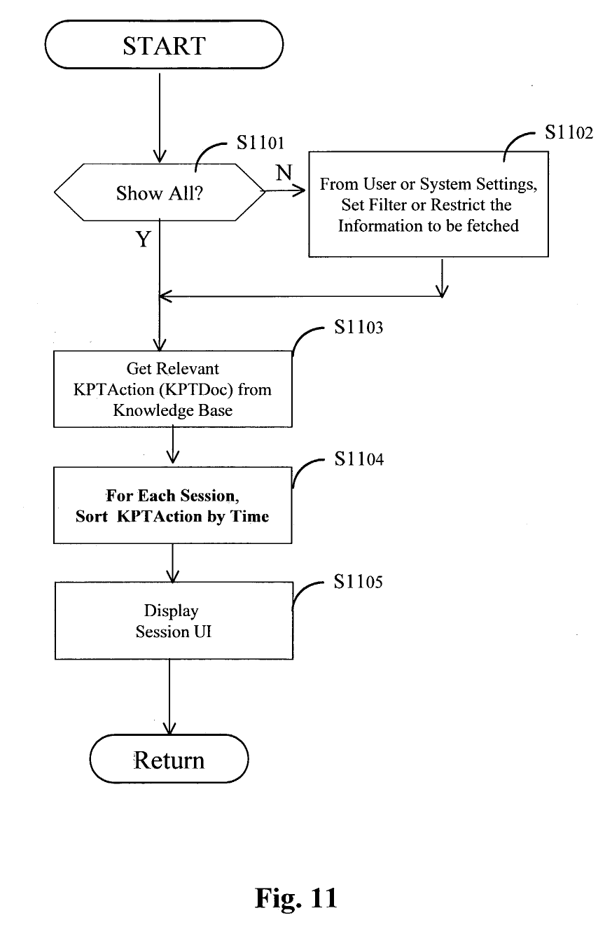

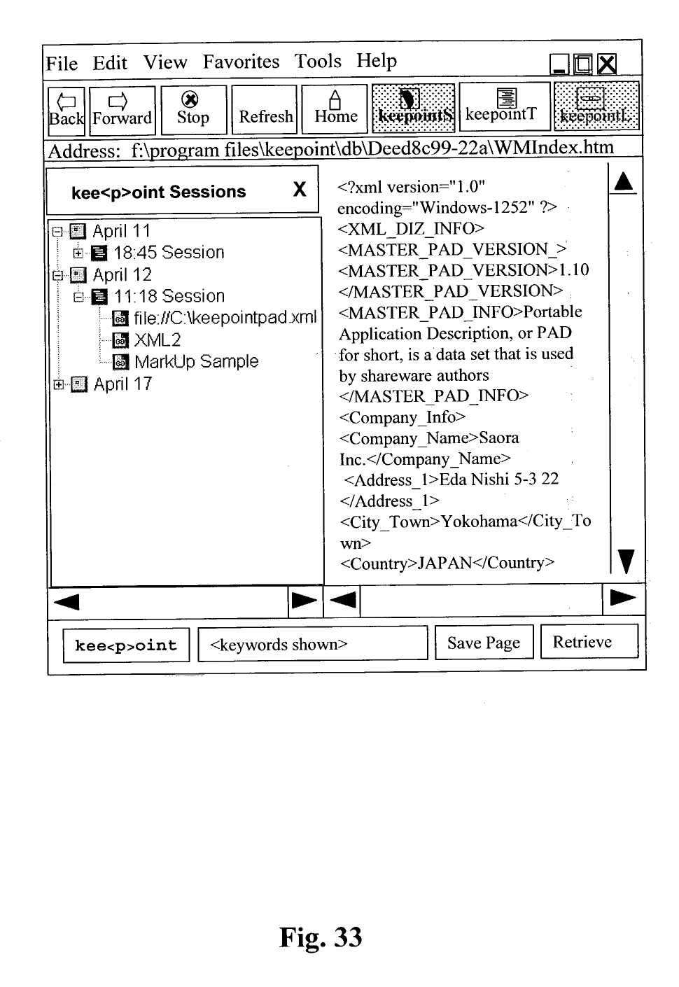

FIG. 11 is a flowchart of the procedural steps of S1004, ShowSession of this embodiment. A check is made in step S1101 to determine if all the information needs to be displayed. If not, the process proceeds to step S1102, wherein based on either User settings and/or interaction and/or input and/or System settings, the filter or the constraint on the information to be displayed is obtained. In either case the process proceeds to step S1103, wherein the relevant KPTAction and the associated KPTDocument are got from Knowledge Base. In step S1104, KPTAction is sorted for each session by time. In step S1105, Session UI is displayed, an example of which is shown in FIG. 33 and the process returns.

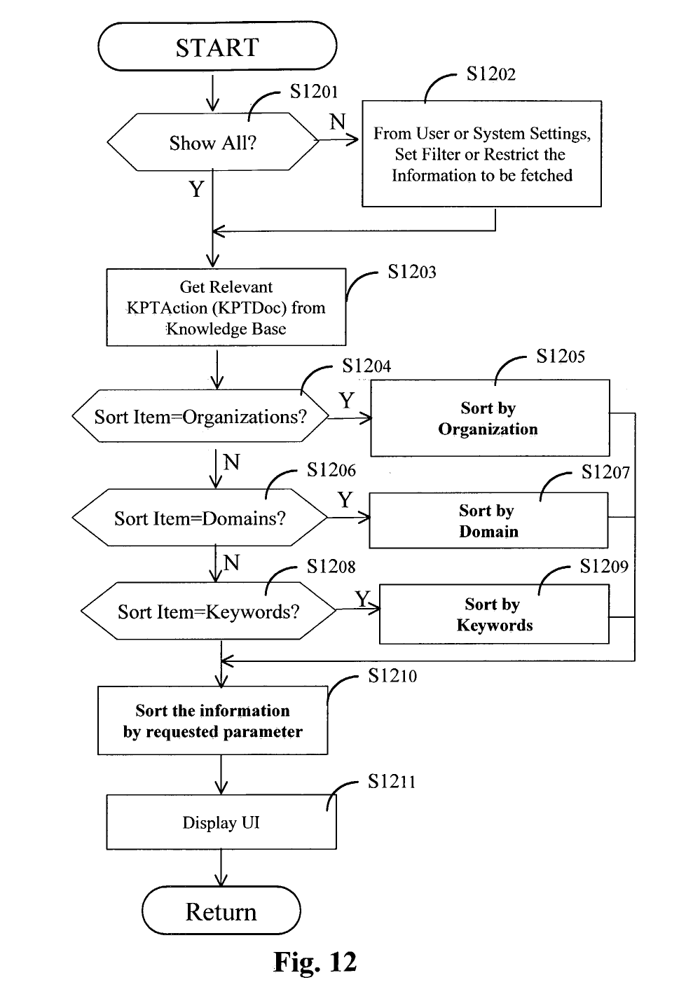

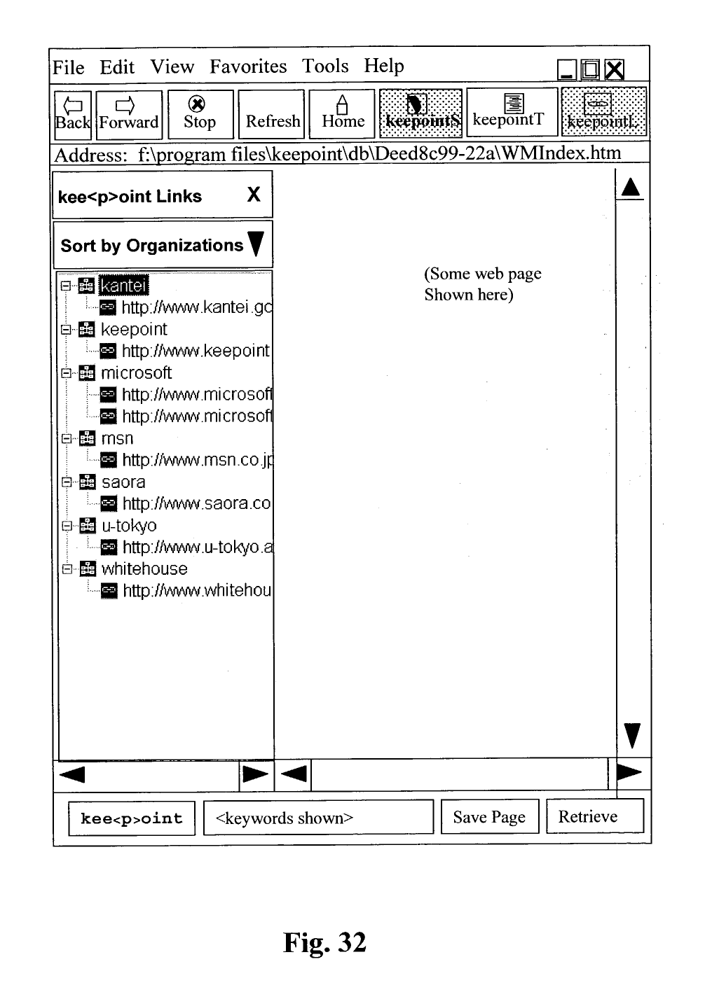

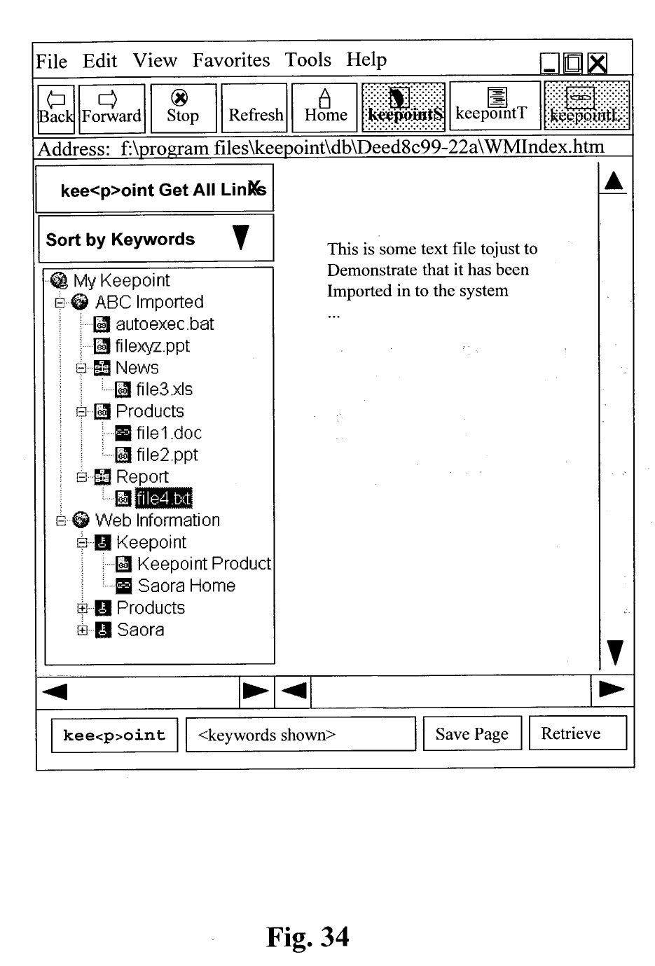

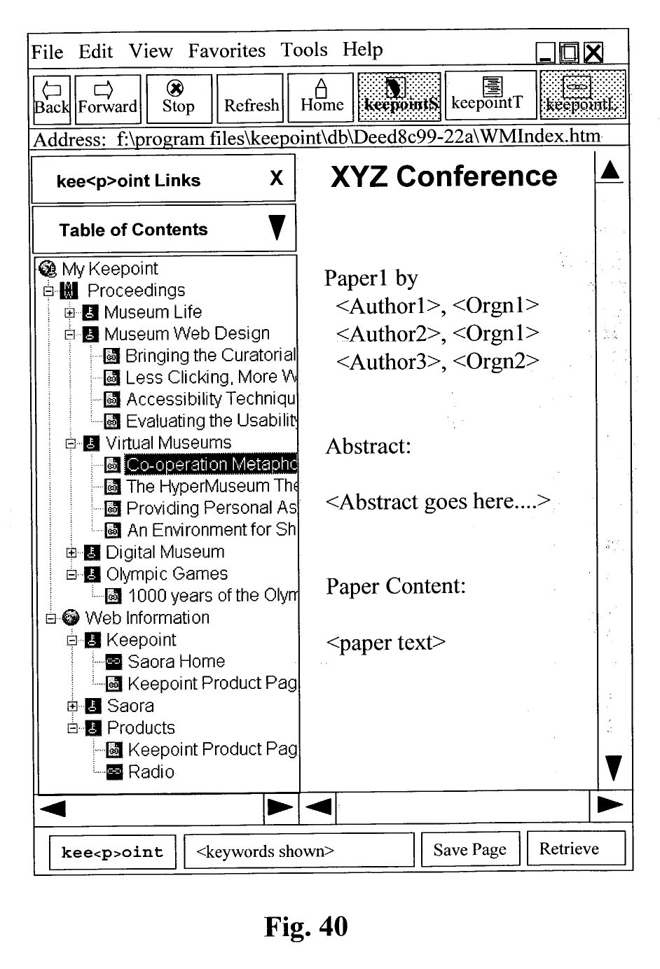

FIG. 12 is a flowchart of the procedural steps of S1006, ShowLinks of this embodiment. A check is made in step S1201 to determine if all the information needs to be displayed. If not, the process proceeds to step S1202, wherein based on either User settings and/or interaction and/or input and/or System settings, the filter or the constraint on the information to be displayed is obtained. In either case the process proceeds to step S1203, wherein the relevant KPTAction and the associated KPTDocument are got from Knowledge Base. In step S1204, a check is made to determine if the Sort Item is equal to Organizations. If so, the information is sorted by Organization, in step S1205 and proceeds to S1211, where it is displayed, an example of which is shown in FIG. 32. If not, a check is made in step S1206 to determine if the sorting is by Domains. If so, the information is sorted by Domain, in step S1207 and proceeds to step S1211, where it is displayed, an example of which is shown in FIG. 31. If not, a check is made in step S1208 to determine if the sorting is by Keywords. If so, the information is sorted by Keywords, in step S1209 and proceeds to step S1211, where it is displayed, an example of which is shown in FIG. 34. If not the information is sorted by requested parameter, in step S1210 and proceeds to step S1211, where it is displayed, an example of which is shown in FIG. 40, wherein the information is sorted by Table of Contents and the process returns.

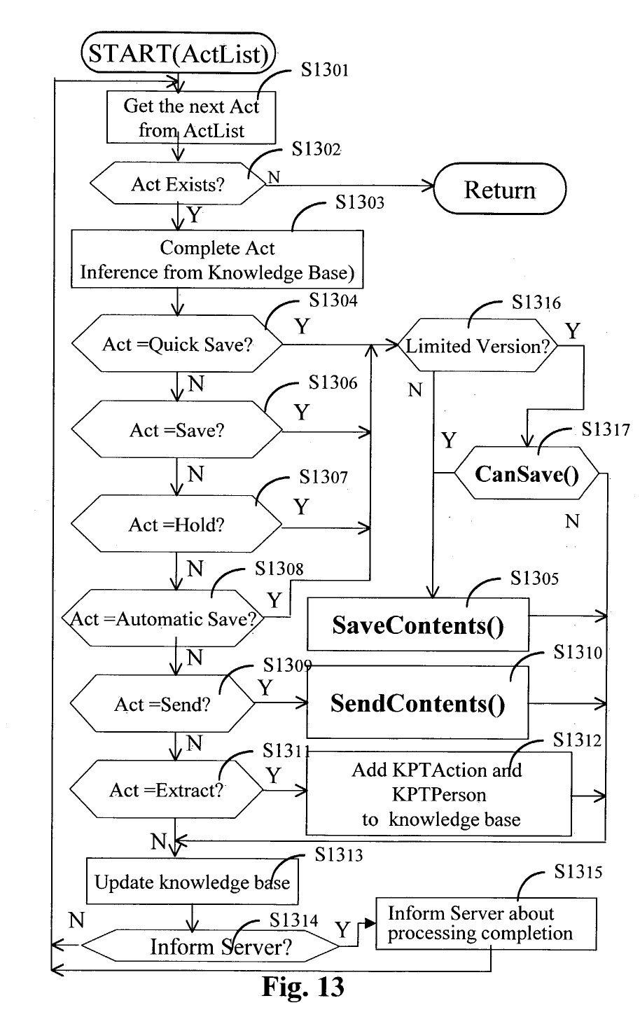

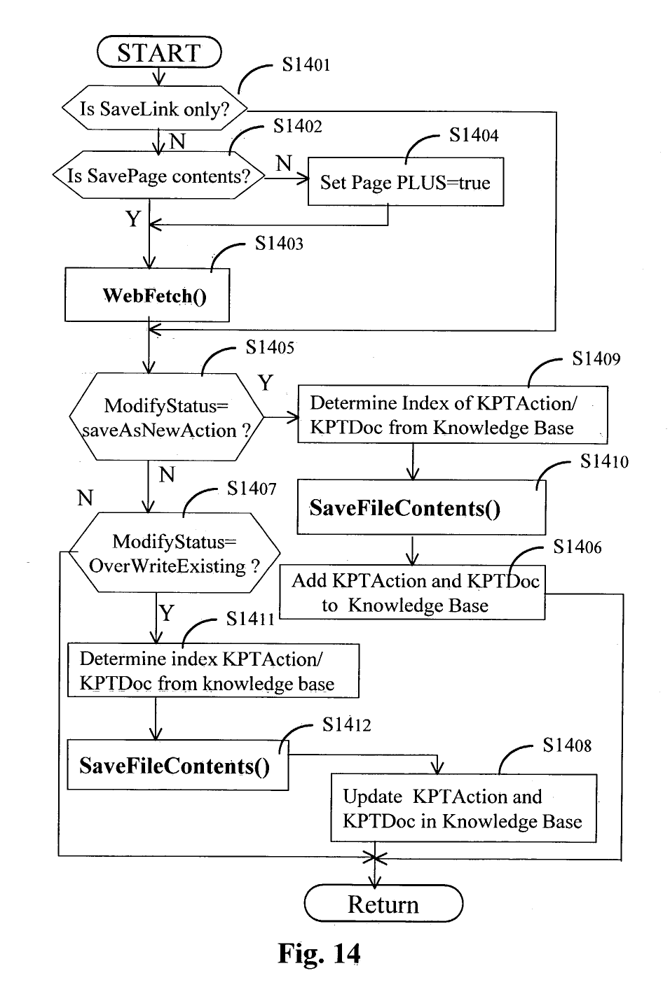

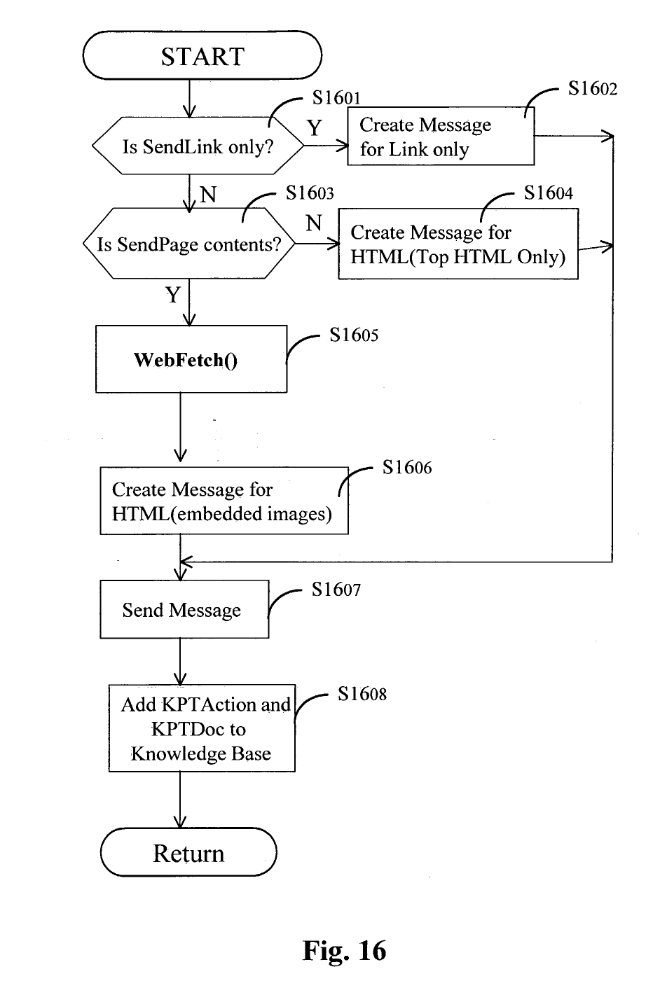

FIG. 13 is a flowchart of the procedural steps of S522 ExecuteAction. In step S1301, the next Act is got from the ActList. In step S1302, a check is made to determine if Act exists. If not, the process returns. Otherwise, in step S1303 inference is made using the knowledge base to complete the Act. A check is made in steps S1304-S1308 to determine if Act is Quick Save or Save or Hold or Automatic Save and if either one of them is true, step S1305, SaveContents as explained later in FIG. 14 is executed and goes to step S1313. Otherwise a check is made in step S1309 to determine if Act is send. If so, SendContents, as explained later in FIG. 16 is executed and goes to step S1313. If not, a check is made in step S1311 to check if Act is Extract. If so, the KPTAction and the corresponding KPTPerson are added to the knowledge base in step S1312 and in step S1313 the knowledge base is updated. A check is made in step S1314 to determine if the completed action needs to be informed to a server for purpose of logging or otherwise. If so, step S1315 is executed wherein the actual information is sent to either a predefined or user specified server about the processing completion and the process returns to step S1301 to fetch the next action from the ActList, till there are no more action left to be processed, at which stage the process returns.

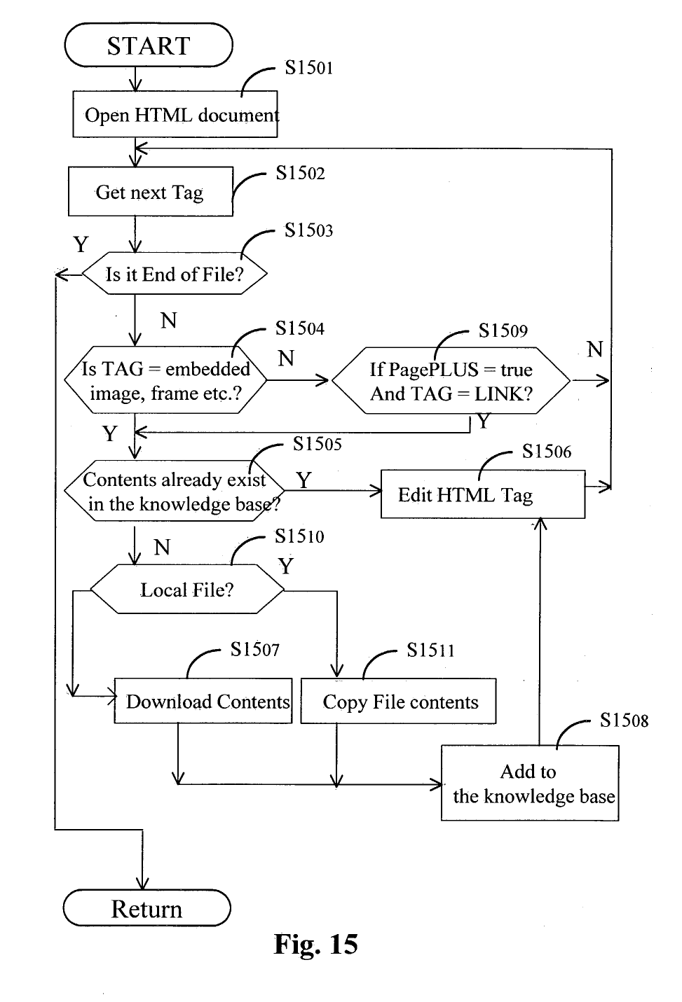

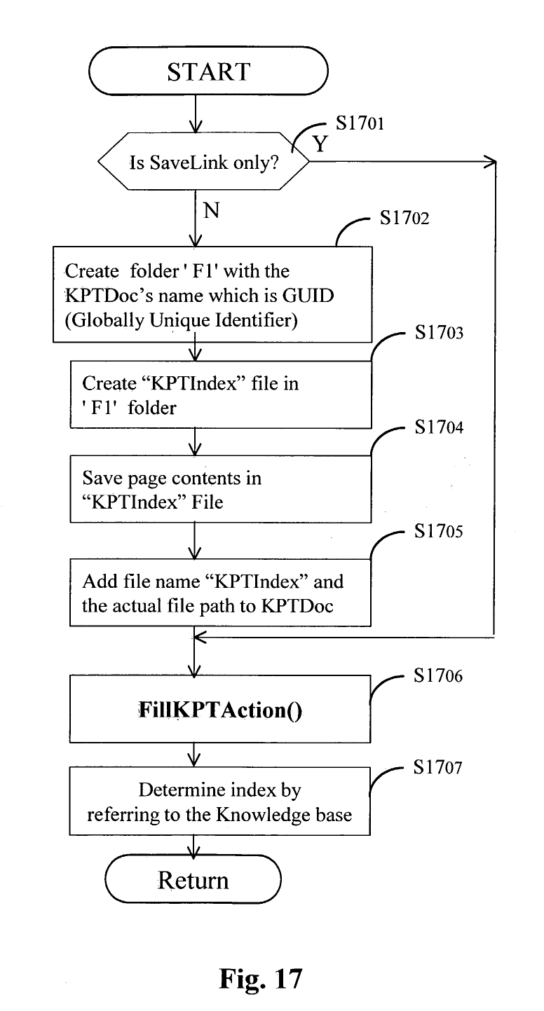

FIG. 14 is a flowchart of the procedural steps of SaveContents in step S1305 of this embodiment. A check is made in step S1401 to determine if it is a SaveLink only operation. If so, process proceeds to step S1405. Otherwise, a check is made to determine if it is a SavePage contents operation in step S1402. If so, Page PLUS is set to true in step S1404. In either case, step S1403, WebFetch is executed, which is explained in detail later in FIG. 15, in step S1403. In step S1405, a check is made to determine if ModifyStatus is saveAsNewAction or not. If so, indices of KPTAction and the associated KPTDocument is determined from Knowledge Base in step S1409 and SaveFileContents is executed as explained in FIG. 17, in step S1401. The KPTAction and KPTPerson are added to Knowledge Base in step S1406 and the process returns. If ModifyStatus is not saveAsNewAction, check is made in step S1407 to determine if it is OverWriteExisiting. If not the process returns, otherwise, in step S1411 indices of KPTAction and the associated KPTDocument is determined from Knowledge Base in step S1411 and SaveFileContents is executed as explained in FIG. 17, in step S1402. The KPTAction and KPTPerson are updated in the Knowledge Base in step S1408 and the process returns.

FIG. 15 is a flowchart of the procedural steps of WebFetch in step S1403 of this embodiment. In step S1501, HTML document obtained from the browser is opened. In step S1502, next tag is got. In step S1503, a check is made to determine if the end of file has been reached. If so the process returns. If not, a check is made to determine if the tag is for an embedded image, frame etc. in step S1504. If so, step S1505 is executed. If not, a check is made in step S1509 to determine if PagePLUS is true and the Tag type is of LINK. If not the process returns back to step S1502 to fetch the next tag. Otherwise, step S1505 is executed in which a check is made to see if the contents (i.e., embedded images etc.) already exist in our knowledge base and they are up to date in step S1505. If so, the HTML tag is edited in step S1506 to change the absolute or original path to the local path of the system where the file exists and process returns to step S1502. If not, a check is made to determine if the file to be fetched is a local file in step S1510. If so, the file contents are just copied, using a simple file copy command in step S1511, otherwise the contents are downloaded from the internet in step S1507. In either case step S1508 is executed, wherein the knowledge base is modified to update the information downloaded etc. and process returns to step S1502 to fetch the next tag in the HTML document. The process continues till end of file is reached at which instant the process returns.

It is possible that some data is in KB of KPT System and the rest of the data is in an external media like CD-ROM or on network like file server etc . . . For e.g., the index pages and top-level pages, which are used often, can be kept with KPT System and rest of the pages not used often can be in CD ROM. For example, in the case of the proceedings of a conference, the index and top level pages can be stored with KPT System but the actual details of papers presented, author biography etc. can be stored in a CD-ROM as they are less frequently used. 1516, a check is made to determine if some data exists in outside, and if the data can be accessed, for e.g., the CD may not be inserted or may not be connected to network, the user will be prompted as shown in FIG. 40 to insert the CD. Of course, using the KPT System, the user can choose and save the most relevant pages to the KPT System thus eliminating the need to always insert the CD for pages he or she uses frequently.

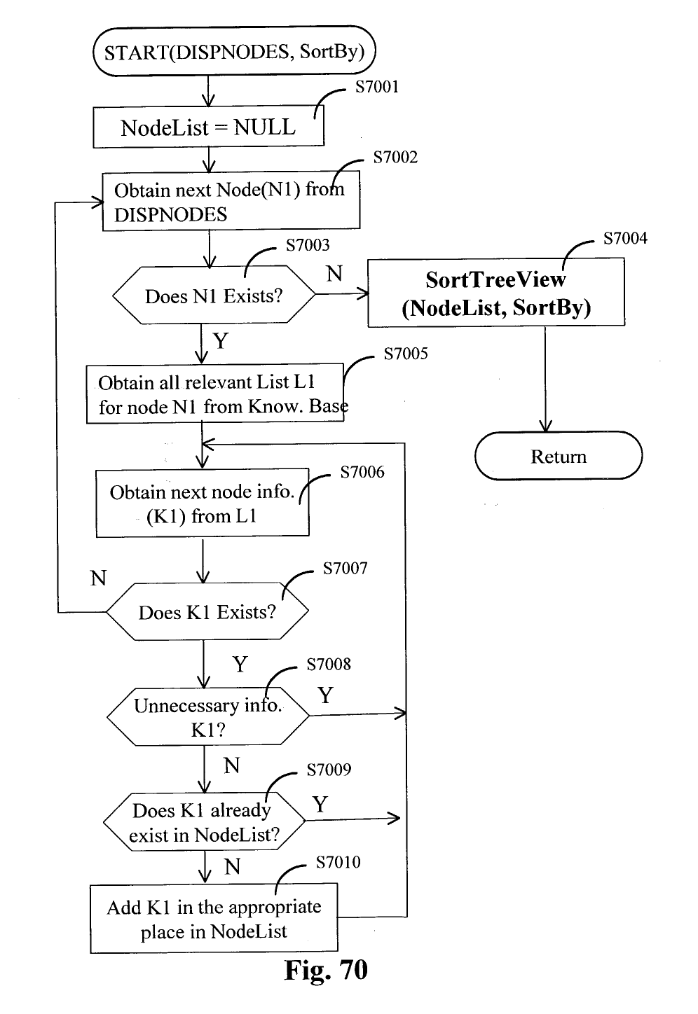

FIG. 16 is a flowchart of the procedural steps of SendContents in step S1310 of this embodiment. In step S1601, a check is made whether the contents to be sent are SendLink only. If so, a message is created with the given Link in step S1602 and proceeds to step S1607. If not so, a check is made to determine if the contents to be sent are SendPage (i.e., send the HTML page including the embedded images etc.), in step S1603. If not so, a message for only top HTML is created and proceeds to step S1607. Otherwise, Webfetch is executed as explained in FIG. 70 in step S1605. In step S1607, the created message is sent and the knowledge structures KPTAction and KPTDocument are added to knowledge base in step S1608 and the process returns.

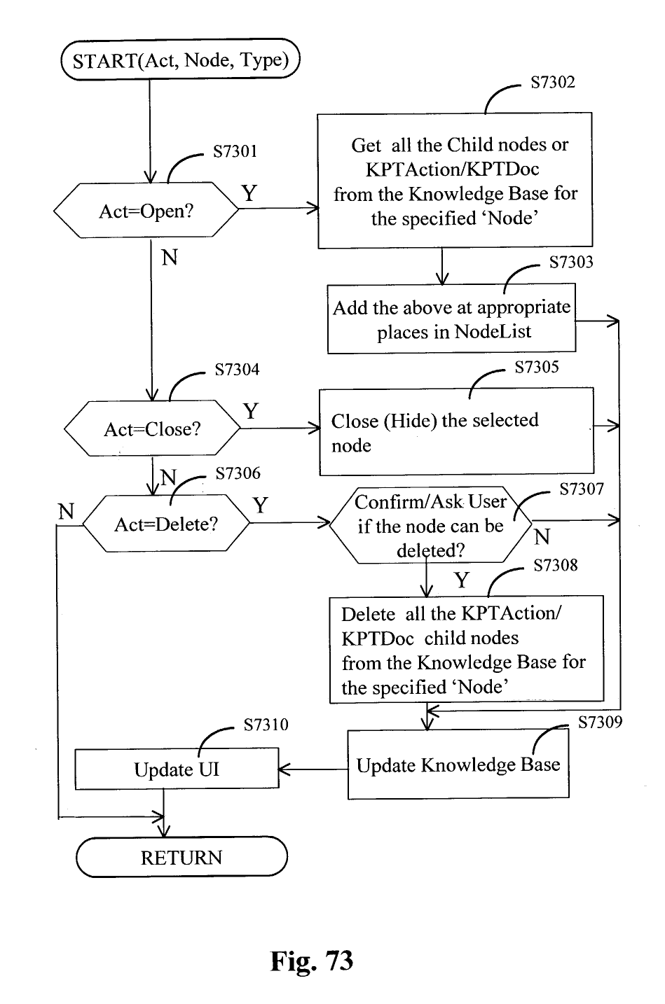

FIG. 17 is a flowchart of the procedural steps S1410, S1412 SaveFileContents of this embodiment. A check is made in step S1701 to determine if the contents to be saved is SaveLink only. If so, the process continues to step S1706. In step S1702, a folder F1 with the name based on the KPTDocument's name, which is a Globally unique identifier (GUID) is created, which ensures that the folder to be created is unique within and across the local system. In step S1703, a file called KPTIndex is created in the folder created in previous step. The actual page contents (i.e., HTML text) are saved to the file created in the previous step. The fully qualified file name (i.e., the folder name and the file name) is stored as the physical URL location of the KPTDocument. In step S1706, FillKPTAction is executed which is explained in detail in FIG. 73 and the other required indices are determined by referring to the knowledge base in step S1707 and the process returns.

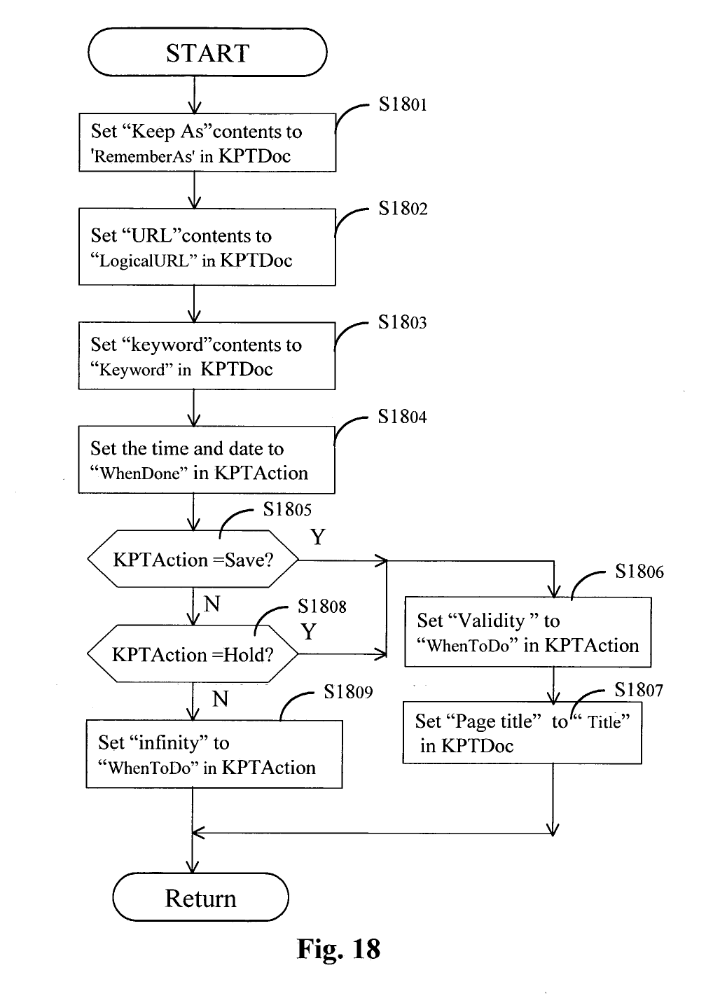

FIG. 18 is a flowchart of the procedural steps of S1706, FillKPTAction of this embodiment. In step S1801, the contents of ‘Keep As’ are set to ‘Remember As’ field of KPTDocument. In step S1802, the contents of ‘URL’ are set to ‘LogicalURL’ field of KPTDocument. In step S1803, the contents of ‘keyword’ are set to ‘Keyword’ field of KPTDocument. In step S1804, the time and date are set to ‘WhenDone’ field of KPTAction. In step S1805, a check is made to determine if KPTAction is Save. If so, step S1806 is executed. If not, a check is made in step S1808 to determine if KPTAction is Hold. If so, in step S1806, the ‘Validity’ is set to ‘WhenToDo’ field of KPTAction and in step S1807, ‘Page title’ is set to ‘Title’ of KPTDocument and process returns. If not, step S1809 is executed, in which the ‘WhenToDo’ field of KPTAction is filled with value ‘infinity’ and the process returns.

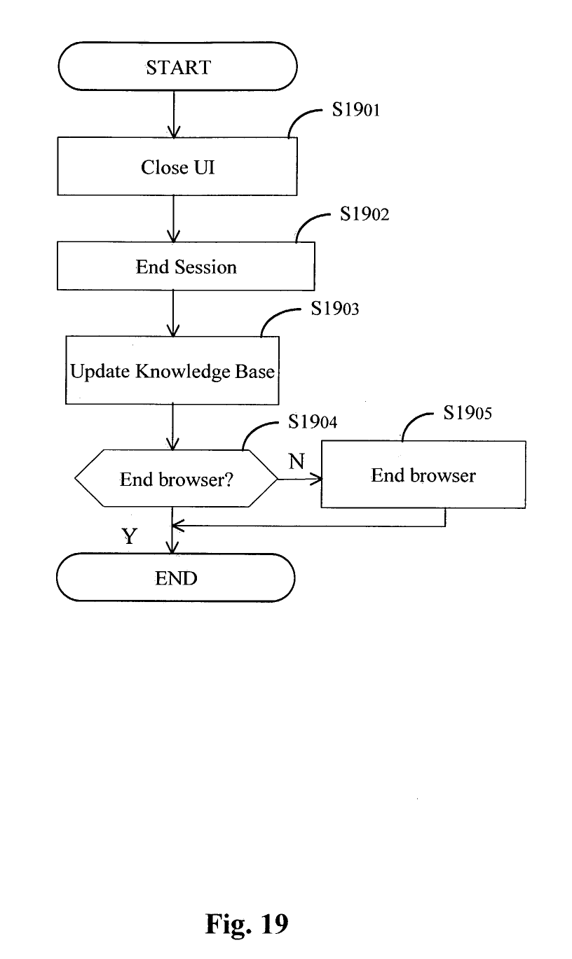

FIG. 19 is a flowchart of the procedural steps of TERMINATE of step S303 of this embodiment. In step S1901, the UI on display are closed. In step S1902, all the current sessions are ended. In step S1903, Knowledge base is updated. A check is made in step S1904 to determine if browser needs to be ended or terminated. If so, the browser will be terminated in step S1905 and the process ends.

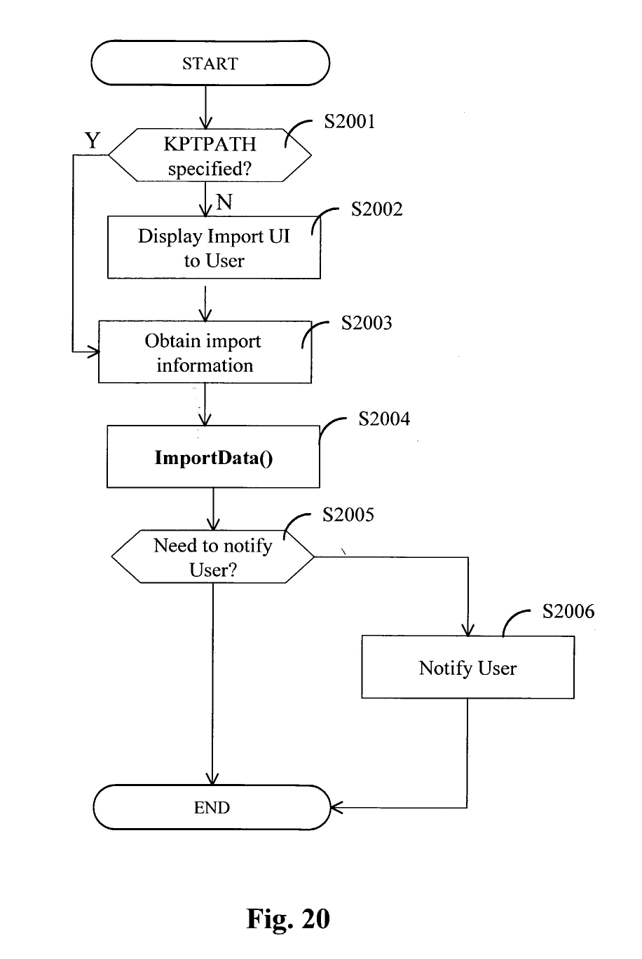

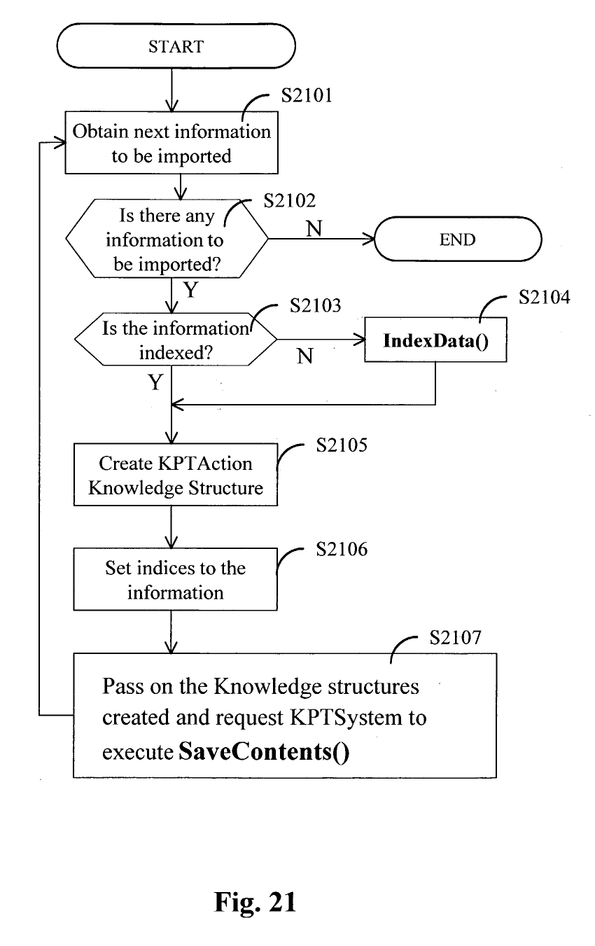

FIG. 20 is a flowchart of KPTIMPORT. In step S2001, a check is made to determine if the path KPTPATH, from where the information is to be imported is specified or not. If not, Import UI is displayed by this embodiment to the user. In either case step S2003 is executed, wherein information about the import data is obtained and moves to step S2004 ImportData, details of which are explained in detail in FIG. 21. In step S2005, a check is made to determine if the results of the import operation are to be notified to the user. If so, step S2006 is executed to notify the user and the process ends.

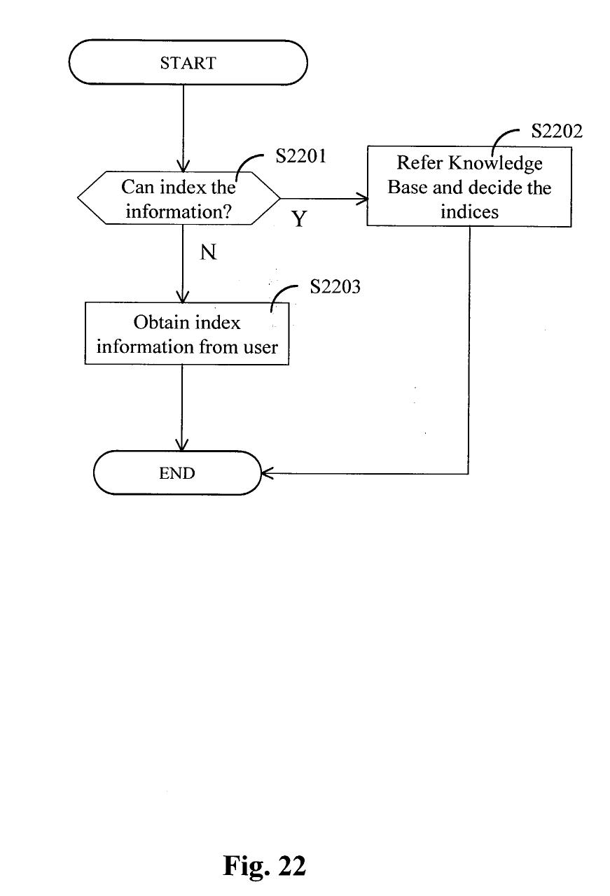

FIG. 21 is a flowchart of the procedural steps of ImportData of S2004 of this embodiment. In step S2101 the next information to be imported is obtained. A check is made in step S2102 to determine if there is any information to be imported. If not, the process returns. Otherwise, a check is made in step S2103 to determine if the information is indexed or not. If not, step S2104 IndexData is executed to index the information being imported, as explained in FIG. 22. In either case, step S2105 is executed, in which the relevant knowledge structures KPTAction etc. are created and the indices set in step S2106. In step S2107, the actual import operation is performed by passing on the request to KPTSystem along with the created knowledge structures to perform the SaveContent operation as explained in earlier in FIG. 14. The process then returns to S2102 and continues the import operation till no more information is left to be imported. It is obvious from the figure that it is also possible to first create all the knowledge structures along with indices first in a loop and then pass on save instruction to KPTSystem, to import all the information by a single instruction.

FIG. 22 is a flowchart of the procedural steps of IndexData S2104 of this embodiment. In step S2201, a check is made to determine if the embodiment can itself index the information. If so, step S2202 is executed, in which the embodiment refers to the knowledge base and decides the indices based on general or specific rules and the process ends. If not, the index information is obtained from the user from step S2203 and the process ends.

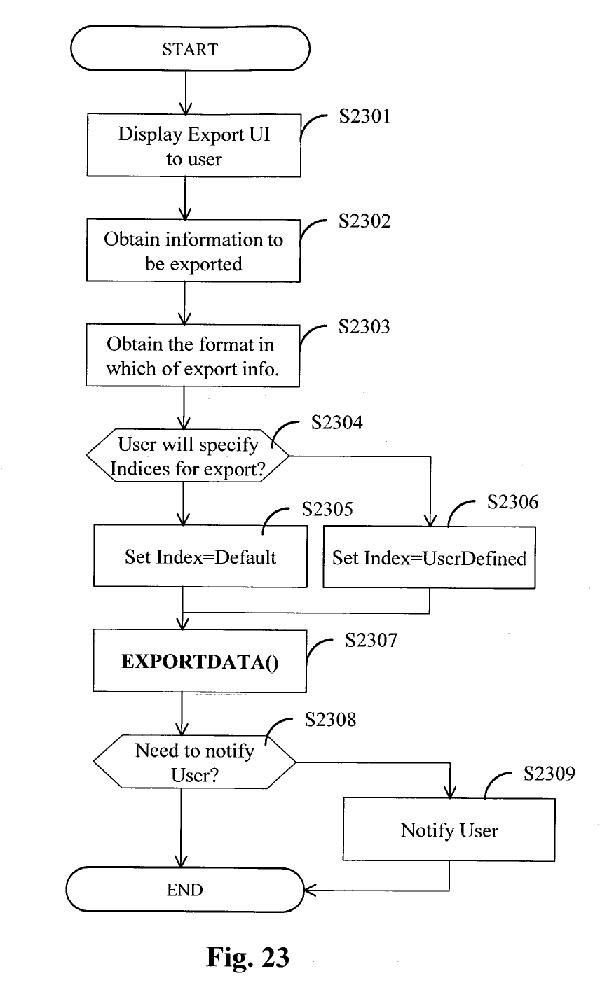

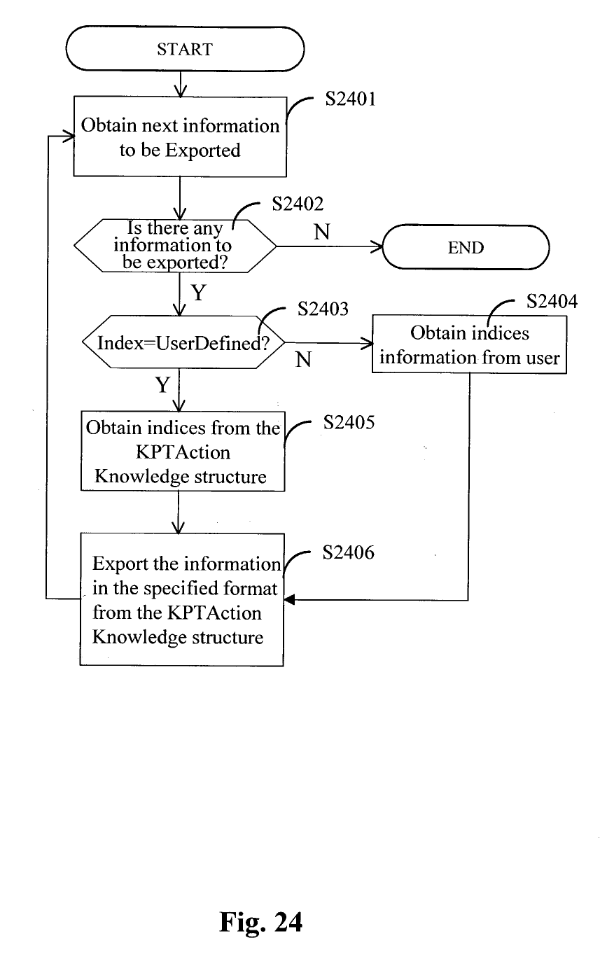

FIG. 23 is a flowchart of KPTEXPORT of this embodiment. In step S2301, Export UI is displayed to the user to obtain the information about what data needs to be exported by this embodiment. In step S2302, the actual information to be exported is obtained and in step S2303, the format in which the information needs to be exported is obtained. A check is made in step S2304, to determine if the user will specify the indices for export. If so, Index is set to UserDefined in step S2306, otherwise Index is set to Default in step S2305 and the process proceeds to step S2307, where in ExportData is executed, to export the actual information as explained in FIG. 24. In step S2308, a check is made to determine if the results of the export operation are to be notified to the user. If so, step S2309 is executed to notify the user and the process ends.

FIG. 24 is a flowchart of the procedural steps of ExportData, S2307 of this embodiment. In step S2401, the next information to be exported is obtained. In step S2402, a check is made to determine if there is any more information left to be exported. If not the process ends. Otherwise, step S2403 is executed, wherein a check is made to determine if the Index is UserDefined. If not step S2404 is executed and the indices are obtained from the user and proceeds to step S2406. Otherwise, step S2405 is executed to obtain the indices from the KPTAction knowledge structure or the knowledge base. In step S2406, the actual information is exported in the specified format and the process loops back to step S2401, to fetch the next information to be exported, till there are no more information left to be exported, at which the process ends. It is obvious from the figure that it is also possible to first create all the knowledge structures along with indices first in a loop and then export all the information in a single operation.

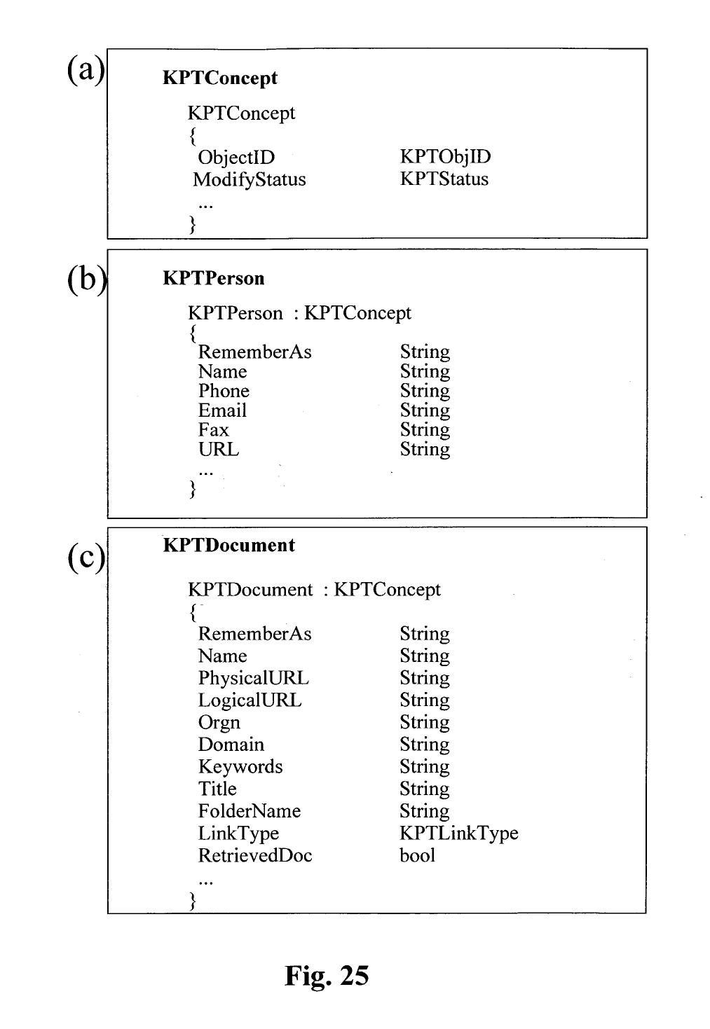

FIG. 25 shows an example of the knowledge structures in the knowledge base. (a), (b), (c) are the knowledge structure definitions for KPTConcept, KPTPerson and KPTDocument respectively.

FIG. 26 shows an example of the knowledge structures in the knowledge base. (a), (b) are the knowledge structure definitions for KPTAction and KPTContent respectively.

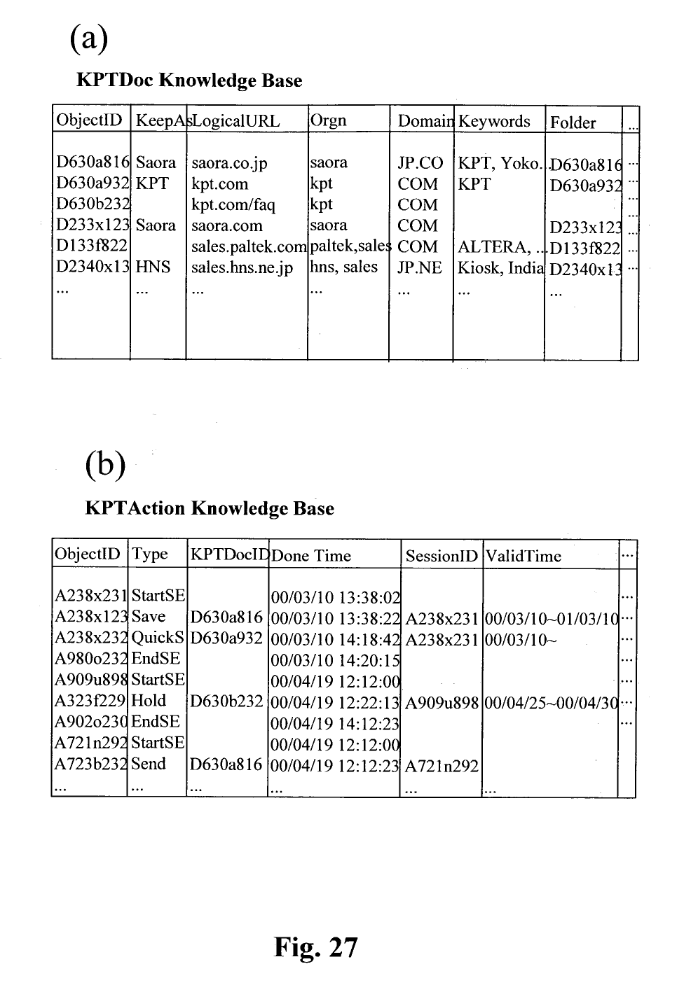

FIG. 27 shows an example content of the knowledge base. (a), (b) are the contents of the knowledge base for KPTDocument and KPTAction respectively.

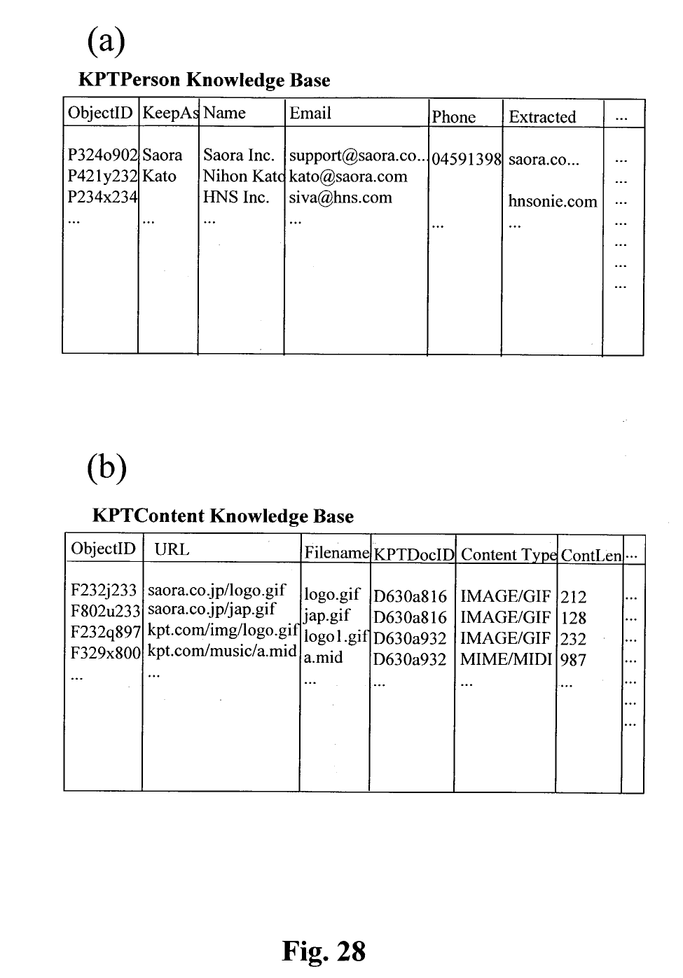

FIG. 28 shows an example content of the knowledge base. (a), (b) are the contents of the knowledge base for KPTPerson and KPTContent respectively.

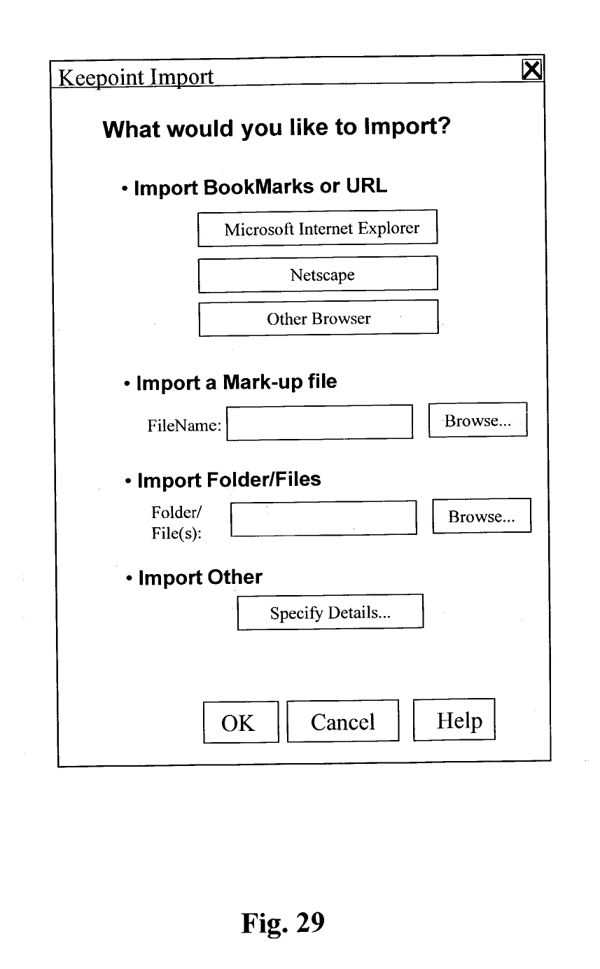

FIG. 29 is an example of Import UI. As can be seen from the figure, the information type to be imported is obtained from the user. For example, this could include, bookmarks or favorite URL(s) stored within a web browser, a marked up file like SGML, XML, a set of files or folders or other information, details of which will be input by the user.

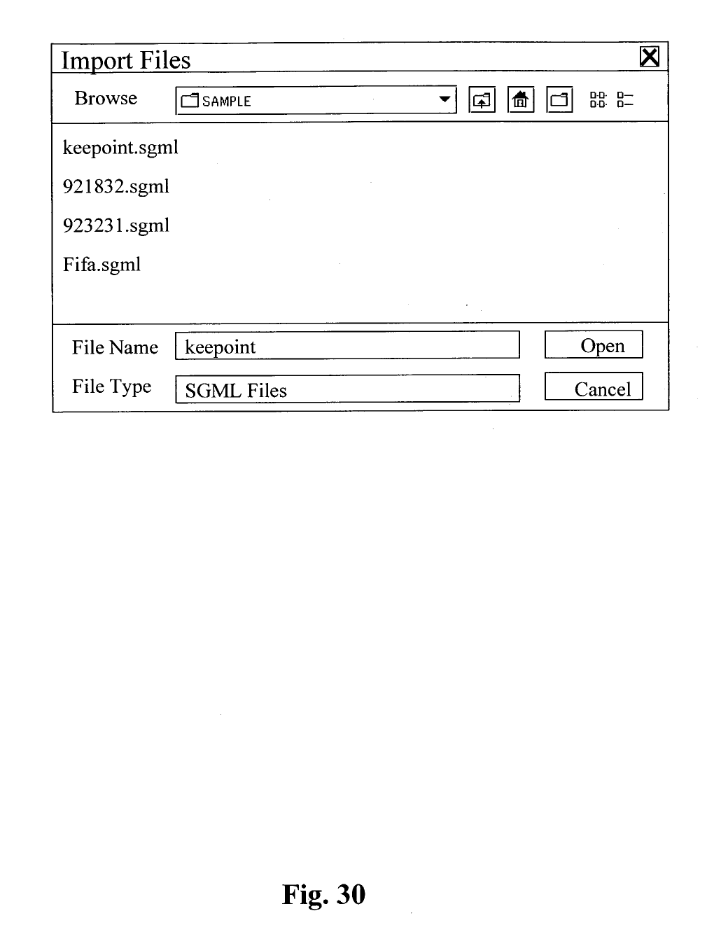

FIG. 30 is an example user interface of browsing files to import. In the example ImportUI of FIG. 29, the user can either directly input the name(s) of files/folders to be input or could select the Browse button to specify the name of the files/folders from the list of files in the underlying operating system.

FIG. 31 is an example of Show all Links sorted by Domain. The example, shows the information with the embodiment automatically sorted by Domains. For example, the Tokyo University information saved from www.u-tokyo.acjp is automatically shown below Japan, Universities based on the knowledge base rules.

FIG. 32 is an example of Show all Links sorted by Organizations. The example, shows the information with the embodiment automatically sorted by Organization name. The information was imported from the web browser bookmarks.

FIG. 33 is an example of Show Sessions. This example, shows the information with the embodiment in time sorted order, based on for e.g., when the action was performed, the validity of information or any other time based parameter. As can be seen from the figure, the right hand side displays an example XML file, imported into the system.

FIG. 34 is an example of Show all Links sorted by Keywords. As can be seen from the figure, the imported files/folders are sorted based on the keywords and the imported information is in a separate node below ‘My Keepoint’ and the web information being saved by the embodiment is stored in a separate node called ‘Web Information’. When multiple keywords have been assigned to information, unlike current filing systems, the embodiment allows the same document to occur below multiple keywords.

FIG. 35 is another example of Show Sessions, in which the imported conference sessions are shown. As can be seen, the ‘MW 2002’ conference proceedings are shown below the actual date, when the conference was held rather than when the information was saved by the embodiment. The figure also shows the Extract Data UI to extract address book related data extraction, as was explained earlier in detail.

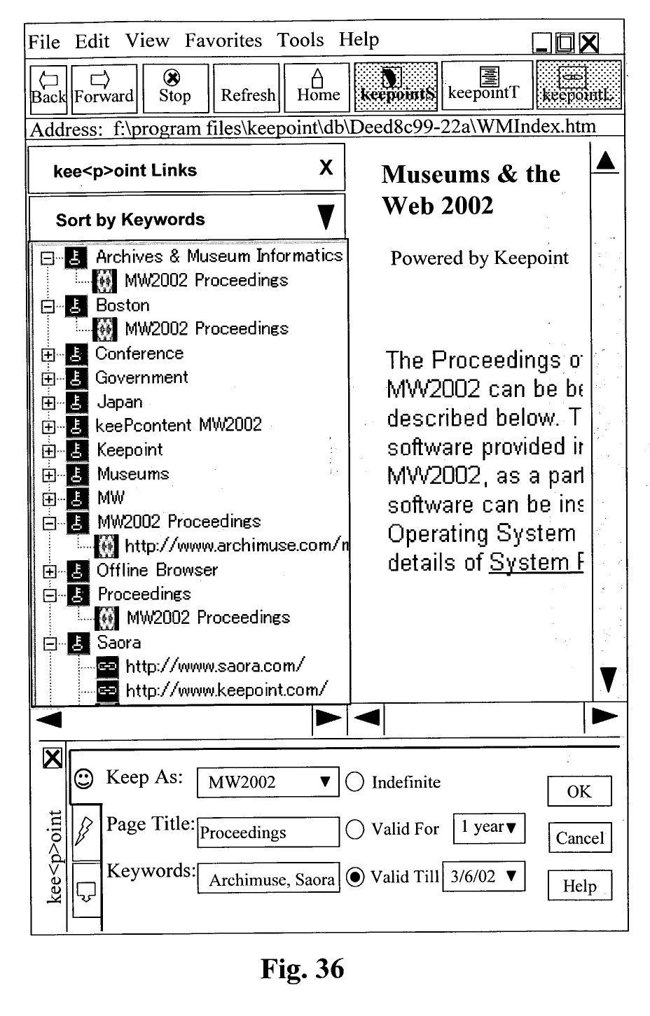

FIG. 36 is another example of Show all Links sorted by Keywords, for imported conference information. As can be seen, the same proceedings information ‘MW 2002 Proceedings’, can be viewed from multiple nodes—‘Boston’, ‘Proceedings’ etc . . . , since the information contains multiple keywords. The figure also shows the Save UI for saving the information, assigning/modifying keywords, page titles etc . . . .

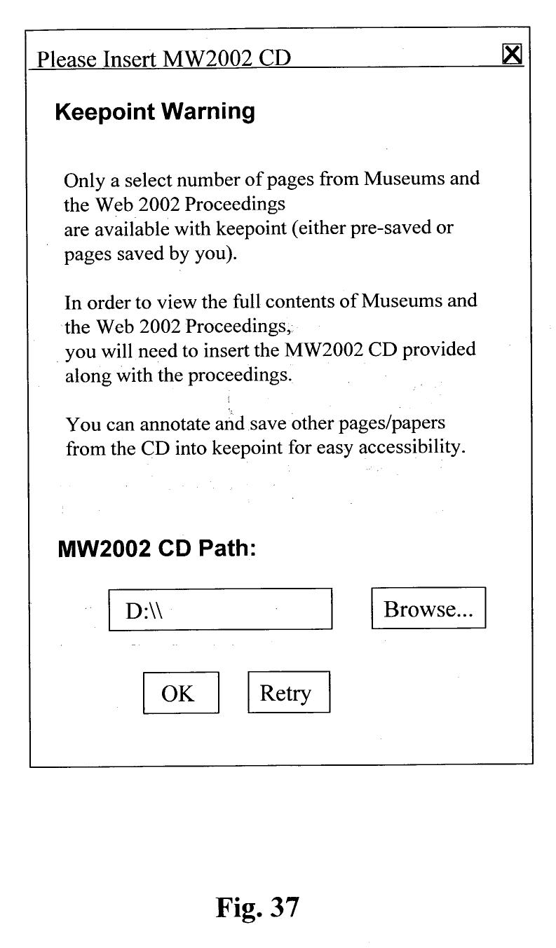

FIG. 37 is a warning dialog to prompt the user to insert the CD containing the full proceedings of the conference. As was explained earlier, it is possible that only the indices and a subset of information are copied by the embodiment and the full information resides on an external device or media like CD-ROM or Server, then the user is prompted to insert for e.g., the CD containing the full information, if such a media cannot be found by the embodiment. The embodiment remembers the path but it is also possible to specify a new path or a new server name, since it is likely that such things change over time.

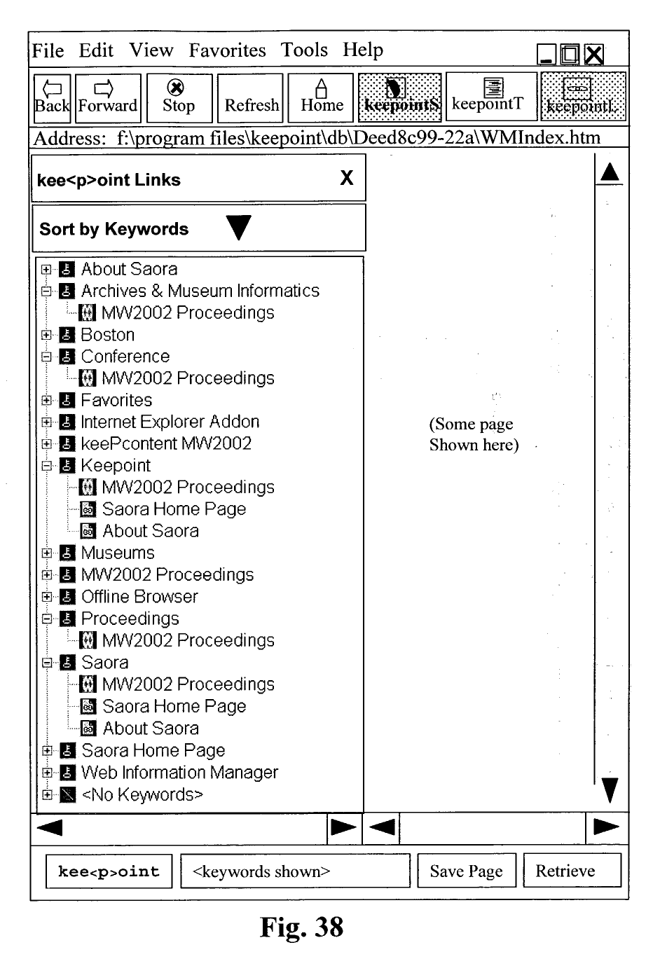

FIG. 38 is another example of Show all Links sorted by Keywords, for imported conference information, along with a simplified Save UI.

FIG. 39 is another example of Show all Links sorted by Organizations, for imported conference information. The example Annotate UI is also shown in this figure, to enable direct annotation of adding notes, adding foot notes, highlighting text, changing text color, deleting information etc.

FIG. 40 is another example of Show all Links, sorted by Table of Contents. As can be seen from the figure, the contents of the proceedings are shown as chapter, sub chapters. Also, once different types of information groups are shown in the Get All Links or the Sessions view, all the indices between the different types of information are not the same. Hence for example, in the figure, the first type of information is a Conference Proceedings and as can be seen from the figure, the contents of that node are sorted by Table of Content view. However, the web information saved by the user neither have any indices to for table of content type of sort nor does it make any sense to show the information gathered over a period of time. Hence the sort for the web information is not changed and shown either in the default sorted order or in the previous sorted order.

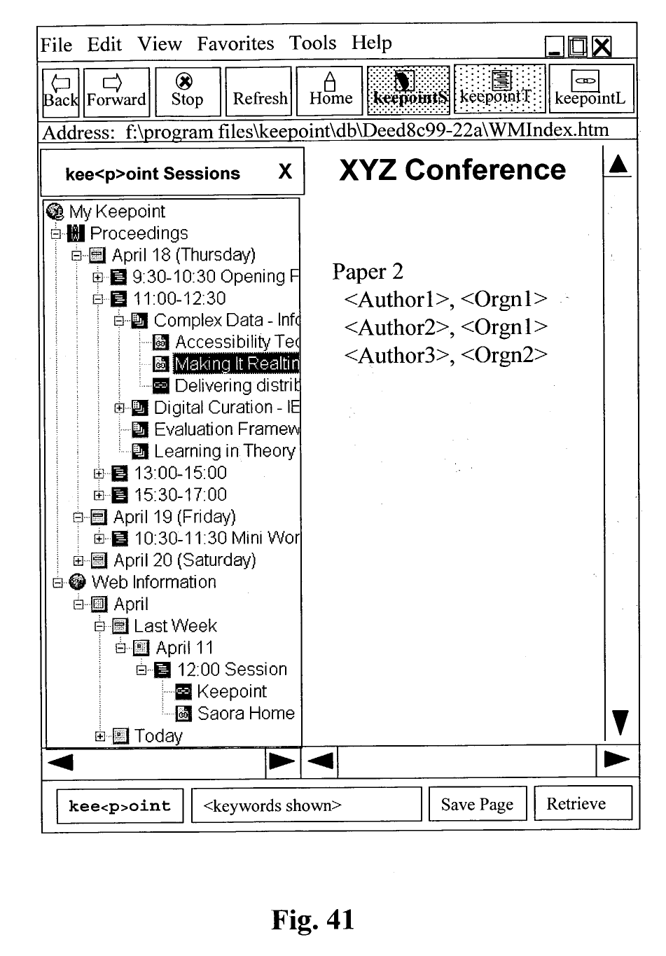

FIG. 41 is another example of Show Sessions, in which the conference information and other web information saved are shown in separate nodes. It is also possible that the information can be predefined and loaded into the KB of the KPT System. For example, as can be seen from the figure, the conference proceedings are preloaded into the KPT System. Thus when the user views the information using the KPT System, he can view the conference proceedings in a separate node and the web information he saves in a separate node. Also, it may be possible that only the top-level pages and the indices might be stored with KPT system and the actual detail information or pages may be on a CD-ROM.

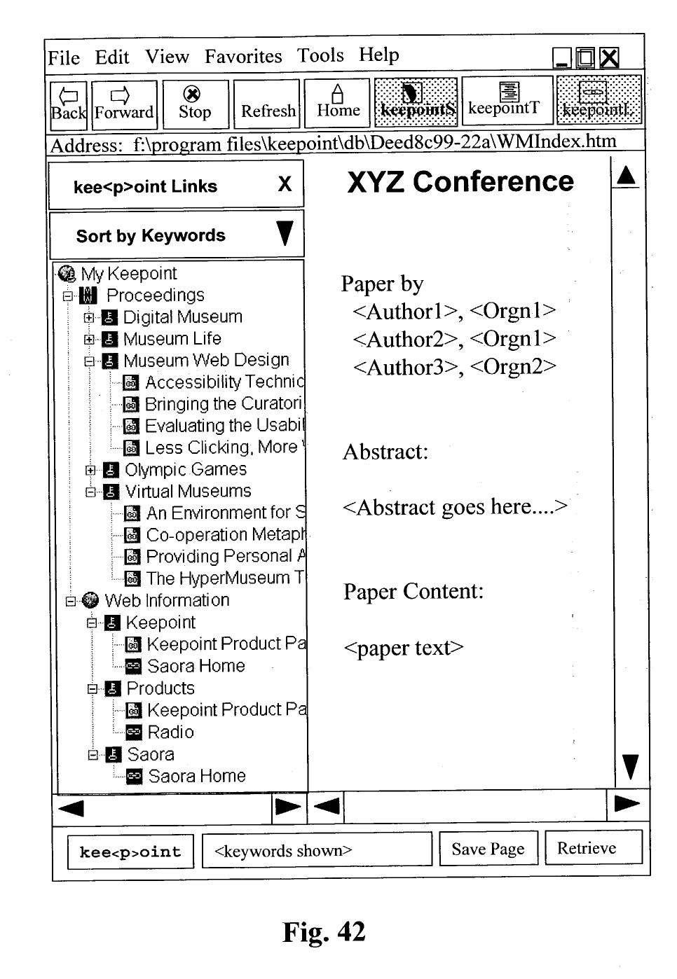

FIG. 42 is another example of Show all Links, sorted by Keywords, in which the conference information and other web information saved are shown in separate nodes.

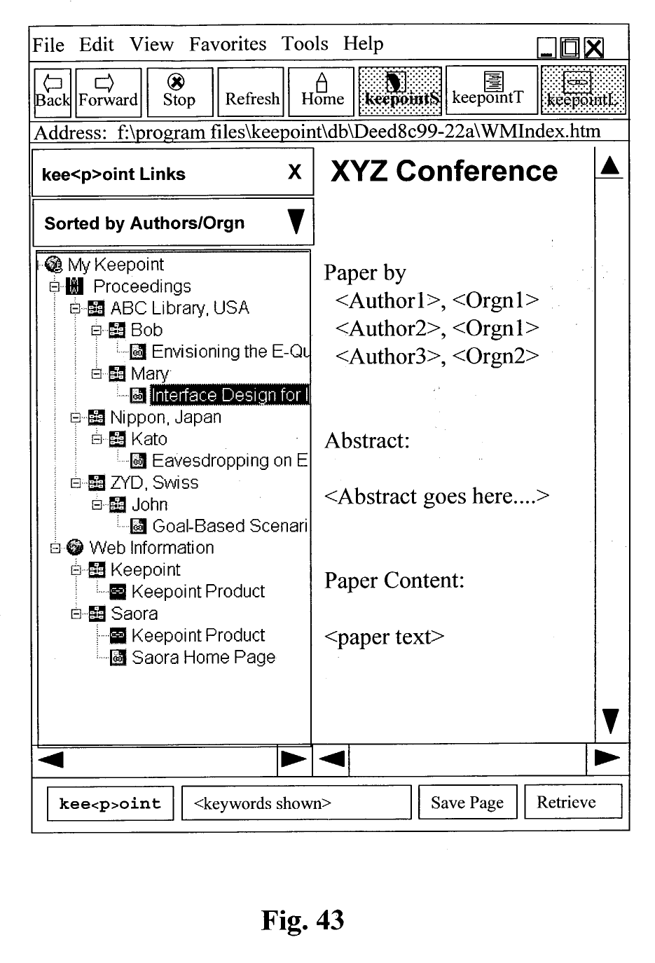

FIG. 43 is another example of Show all Links, first sorted by Organization and then by Authors below each node. As explained earlier, since different types of information exists with the embodiment, the conference proceedings, in this figure are sorted by Organization, followed by Authors for each of the Organization. However, for the web information stored by the user, the information is categorized only by Organizations.

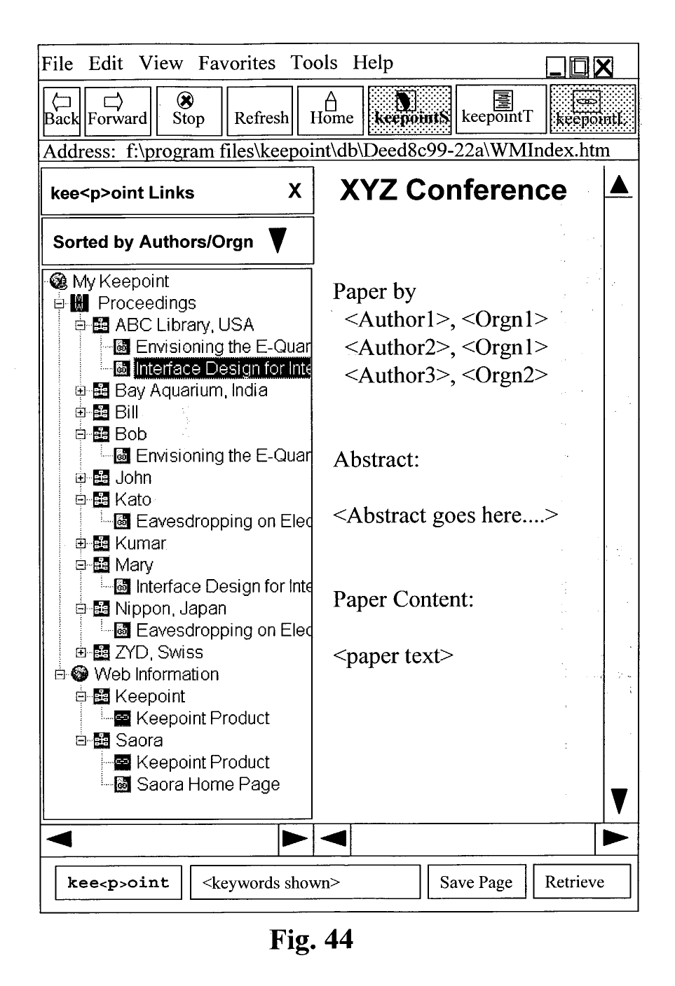

FIG. 44 is another example of Show all Links, sorted by Authors and Organization. In this example, the Author and Organization are at the same level i.e., the information is sorted using both the indices at the same level, as it is possible that we may either remember vaguely the name of the person or the name of the organization. In previous figure, the user had to know the organization name, to locate the information even if he knew the author name. It is possible to have several other obvious combinations like the information is sorted by Author.

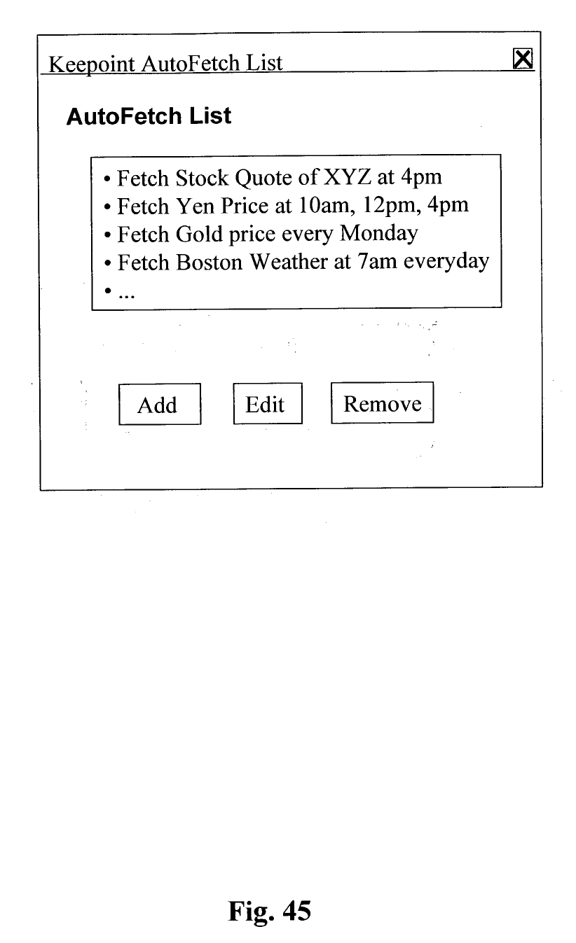

FIG. 45 is an example user interface of AutoFetch List. As can be seen from the figure, the list of information to be fetched are shown. It is possible to add a new instruction using the Add, edit the instruction using Edit or delete the instruction using Remove.

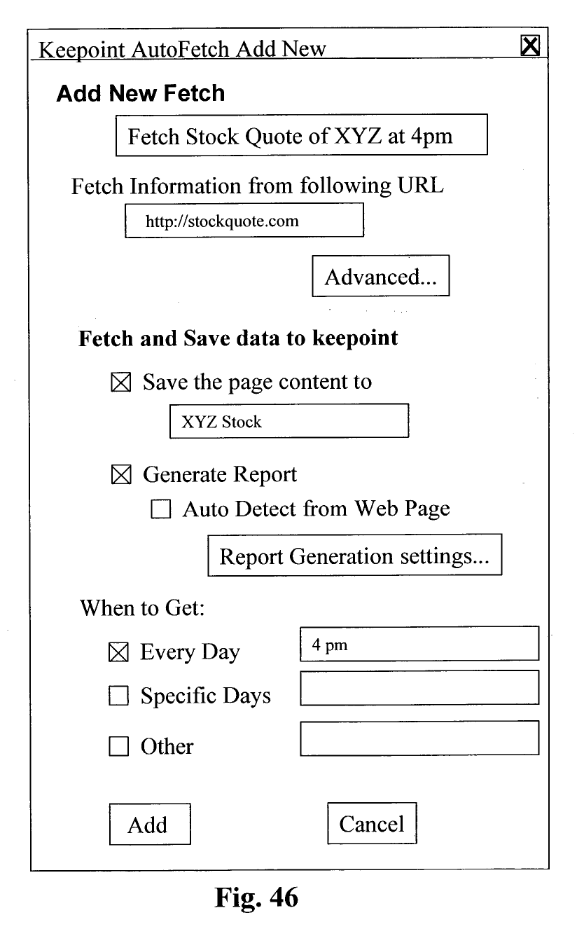

FIG. 46 is an example user interface of specifying a new auto fetch instruction. As can be seen from the figure, the name, the URL to fetch the information from, where to save, report to generate, time to get etc. can be specified.

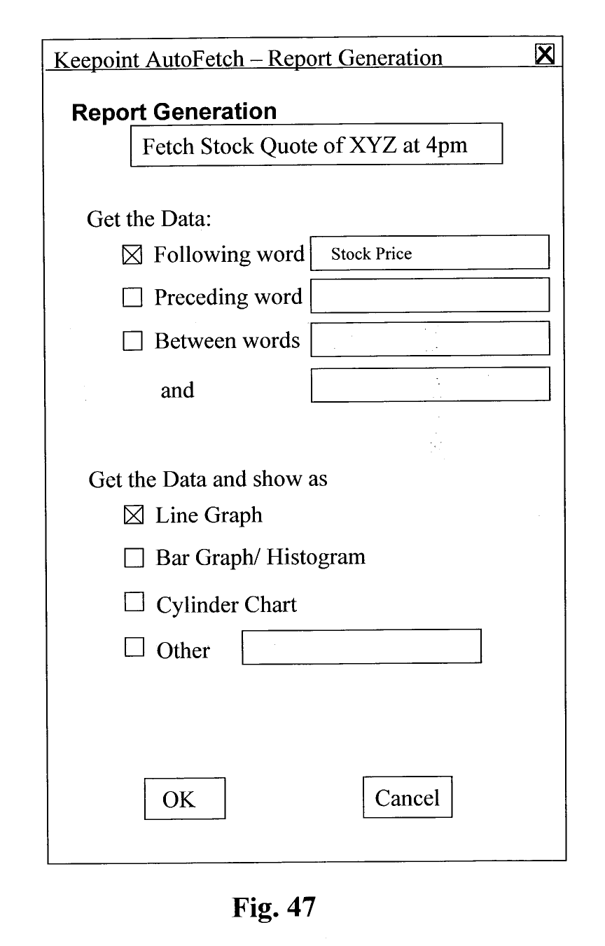

FIG. 47 is an example user interface for specifying the output report to be generated. As can be seen, it is possible to present the accumulated data in reports for e.g., Graphs or charts.

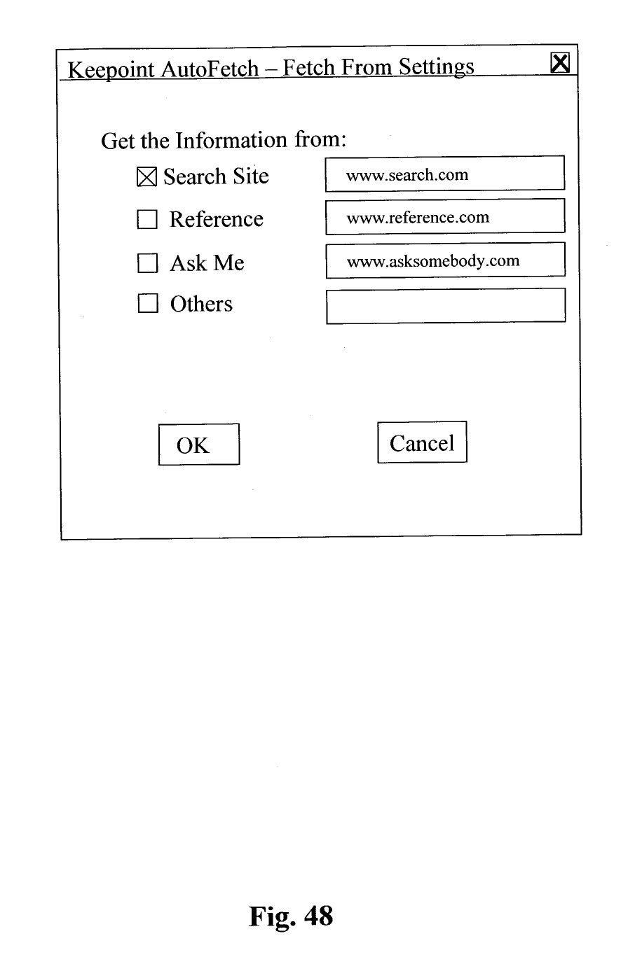

FIG. 48 is an example user interface to specify the information sources to look for.

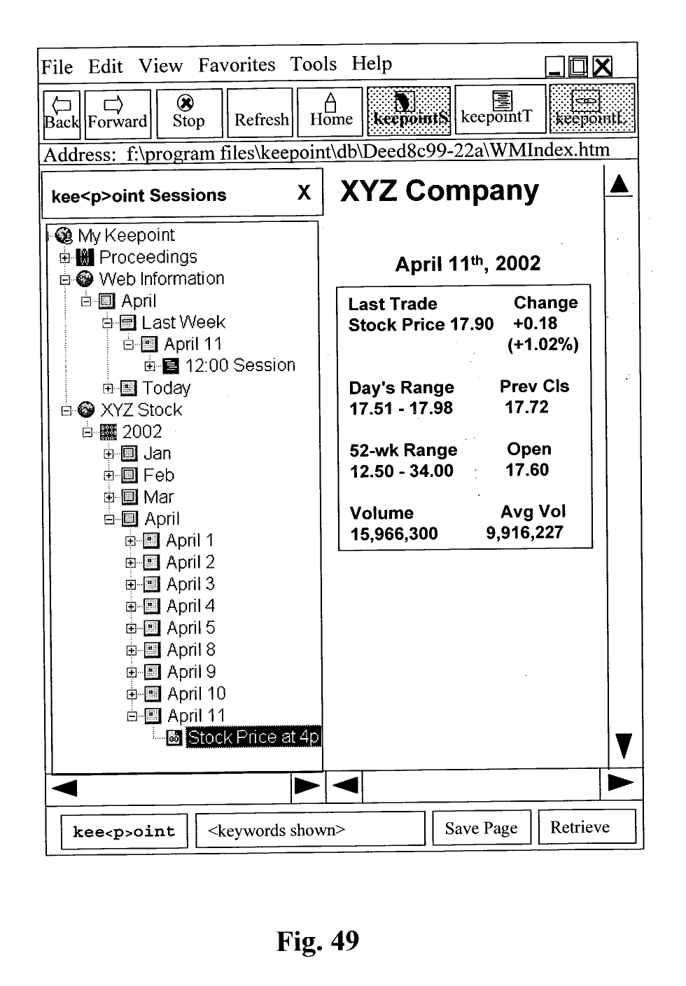

FIG. 49 is an example of Show Sessions of the auto fetch results. As can be seen from the figure the stock price information of an company is collected every day and presented in raw form.

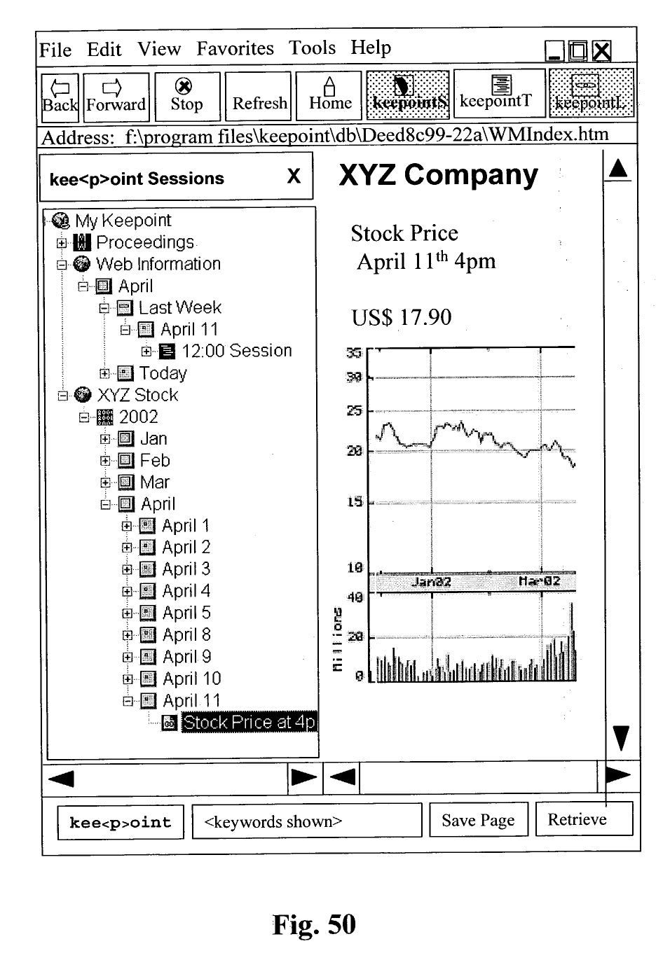

FIG. 50 is another example of Show Sessions of the auto fetch results in a graphical format. The stock price collected is displayed in a graphical form for easy viewing.

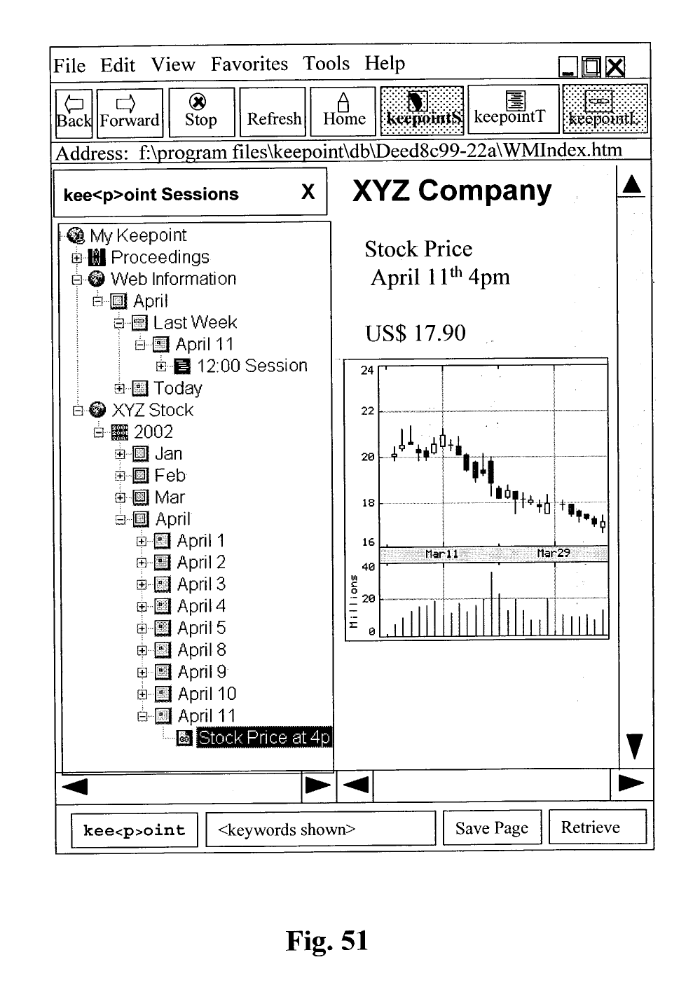

FIG. 51 is another example of Show Sessions of the auto fetch results in a graphical format.

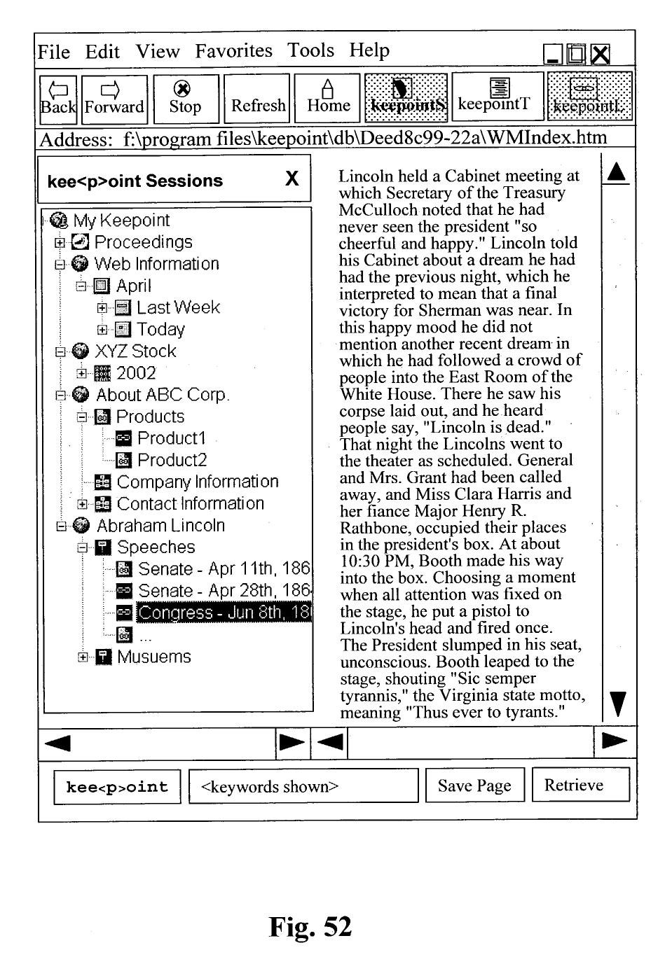

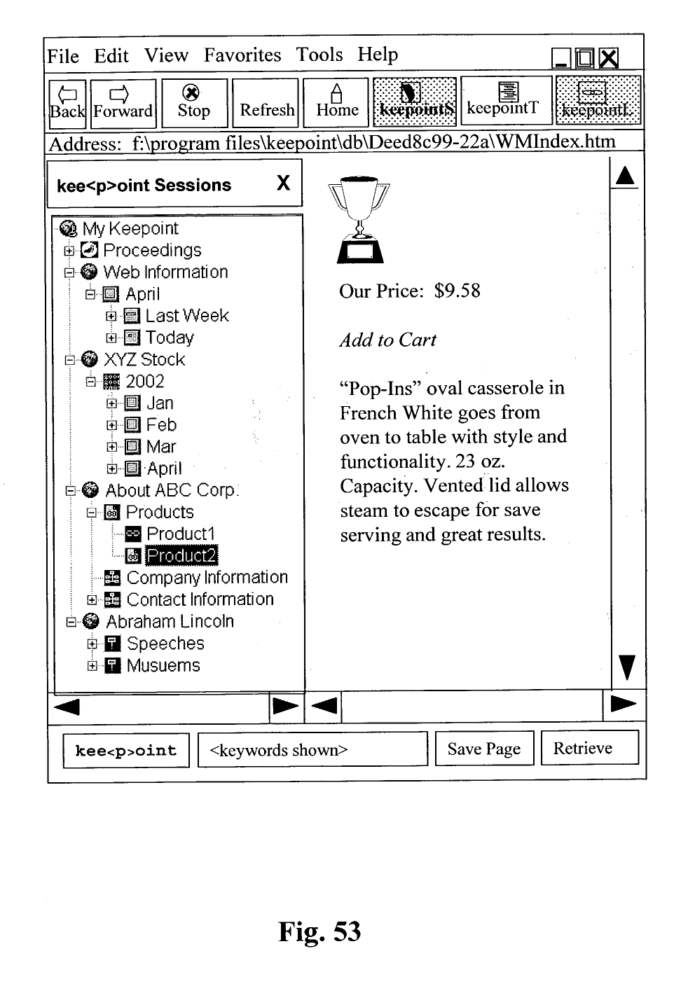

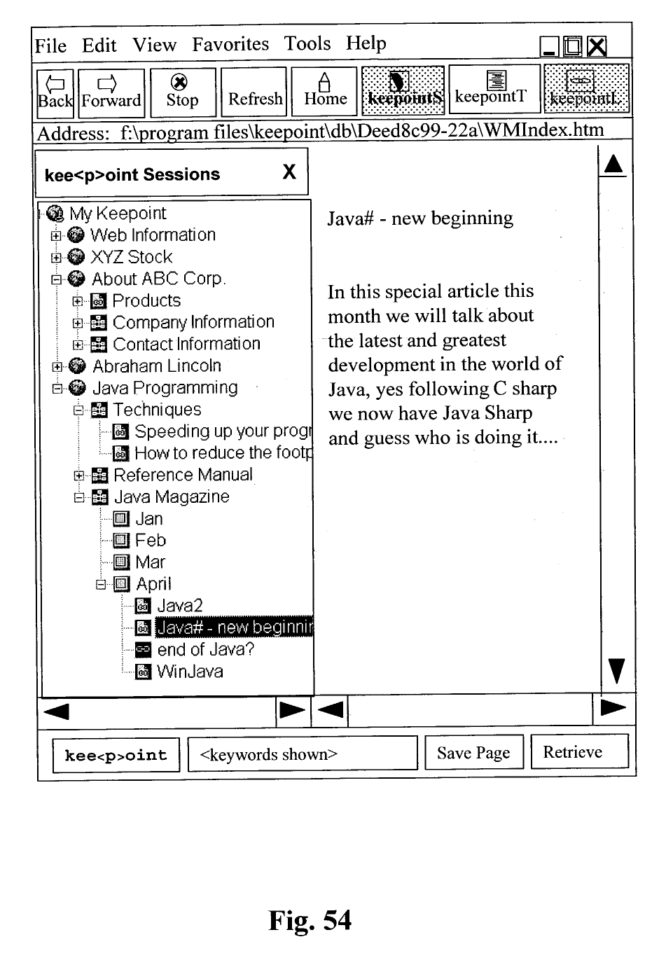

FIGS. 52, 53 and 54 are examples of Show Sessions of the several imported information. As can be seen in FIG. 52, the speeches of Abraham Lincoln have been collected and shown in the time sorted order of when they were delivered, rather than when the information was collected by the user. FIG. 53 shows an example of all the product information collected for a particular company. FIG. 54 shows an example of some of the technical articles collected on Java programming language.

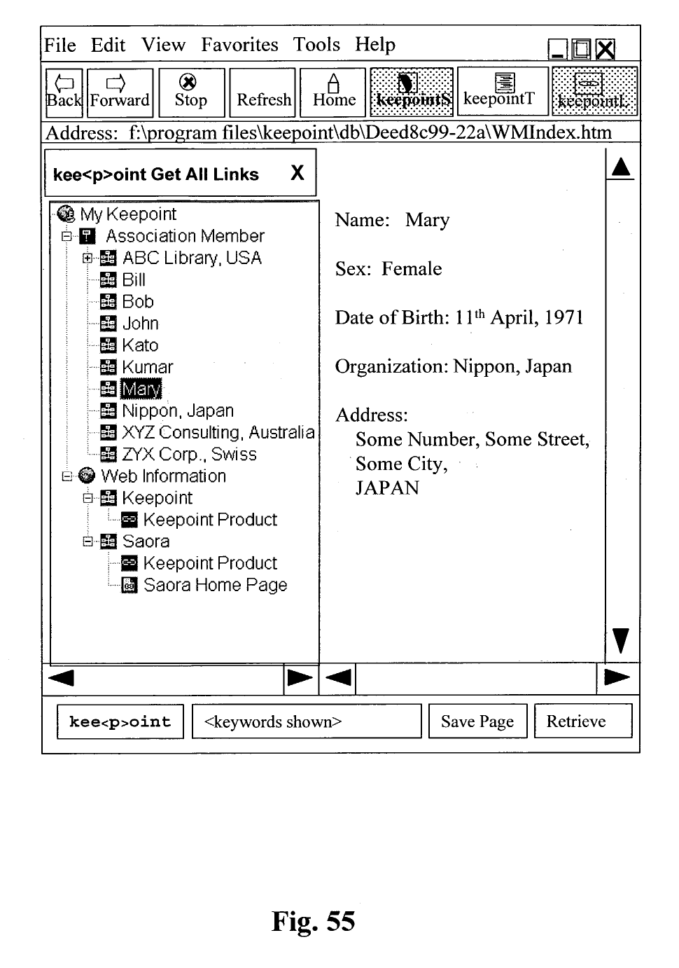

FIG. 55 is another example of Get all Links for imported association members. As can be seen from the figure, the members of the associate—individuals and organizations have been imported and shown in Get All Links view. The right side displays the details of member information.

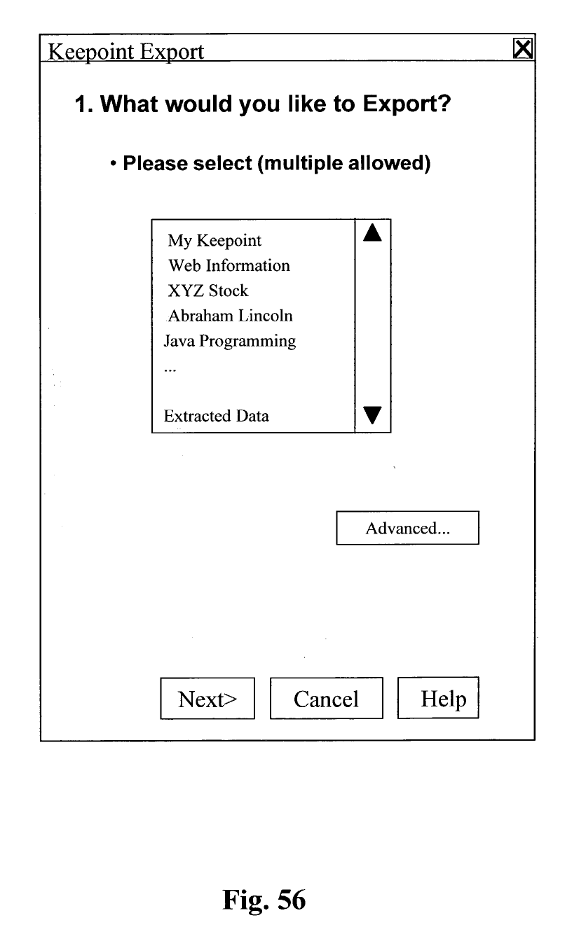

FIG. 56 is an example user interface of Export. As can be seen from the figure, it is possible to select multiple information to be exported.

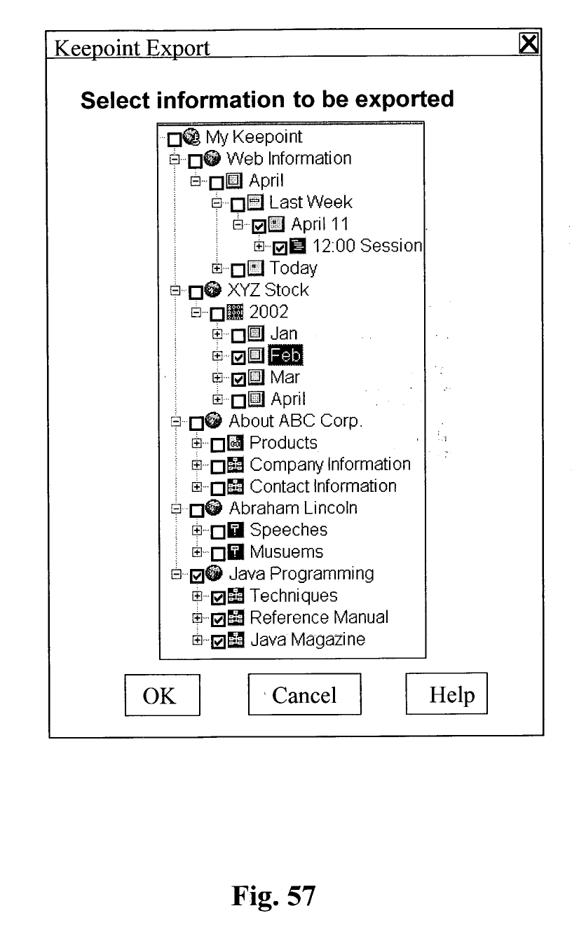

FIG. 57 is an example user interface to specify the information to be exported. As can be seen from the figure, it is possible to specify a complete node or only specific nodes.

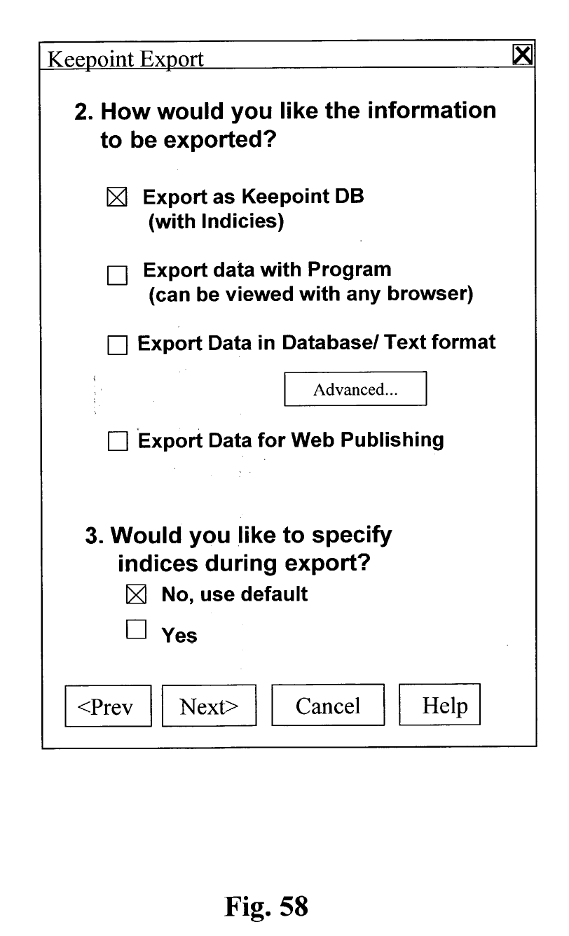

FIG. 58 is an example user interface to specify some other parameters for export.

As can be seen from the figure, it is possible to specify how the information needs to be exported for example, in Keepoint format with indices to other embodiment of similar nature, as data along with program, which can be viewed using a standard web browser i.e., the data is in HTML format and the program to sort the views in some scripting language like JavaScript or VBScript etc . . . It is also possible to specify if the indices needs to be exported along with the information being exported.

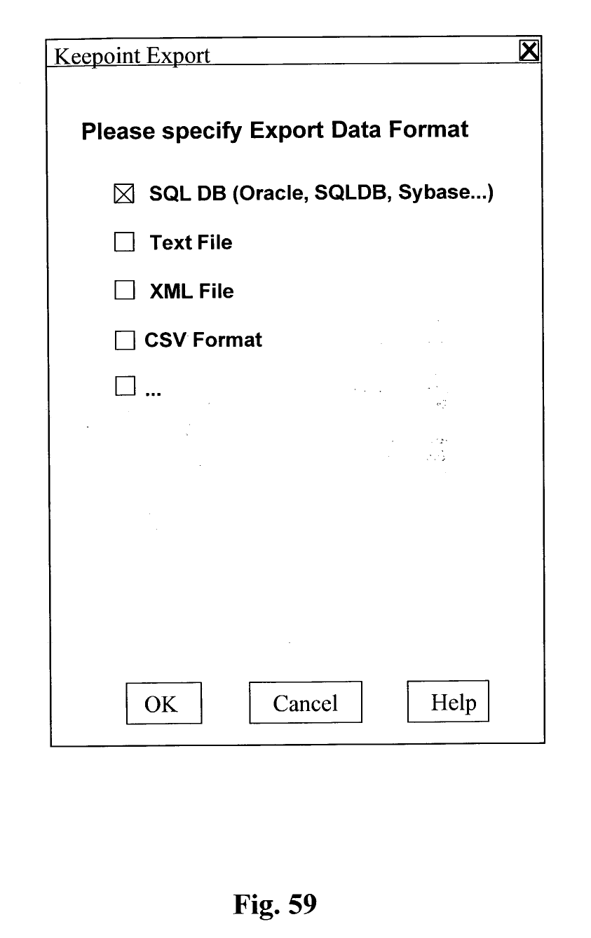

FIG. 59 is an example user interface to specify the format of the information to be exported. As can be seen from the figure, the Export Data format can be specified for e.g., SQL Database format, Text File, XML file, CSV format etc . . .

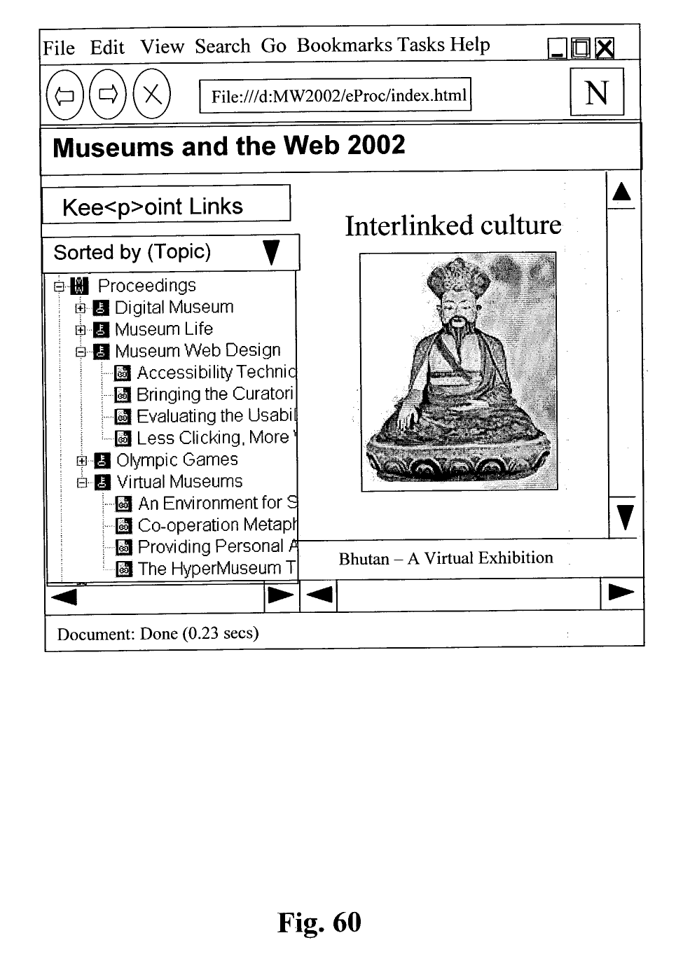

FIG. 60 is an example of exported data in a browser independent format. As can be seen from the figure, the exported data can not only be viewed from a standard web browser but it is possible to sort the information using various indices. This is done for e.g., by the JavaScript program embedded in the information.

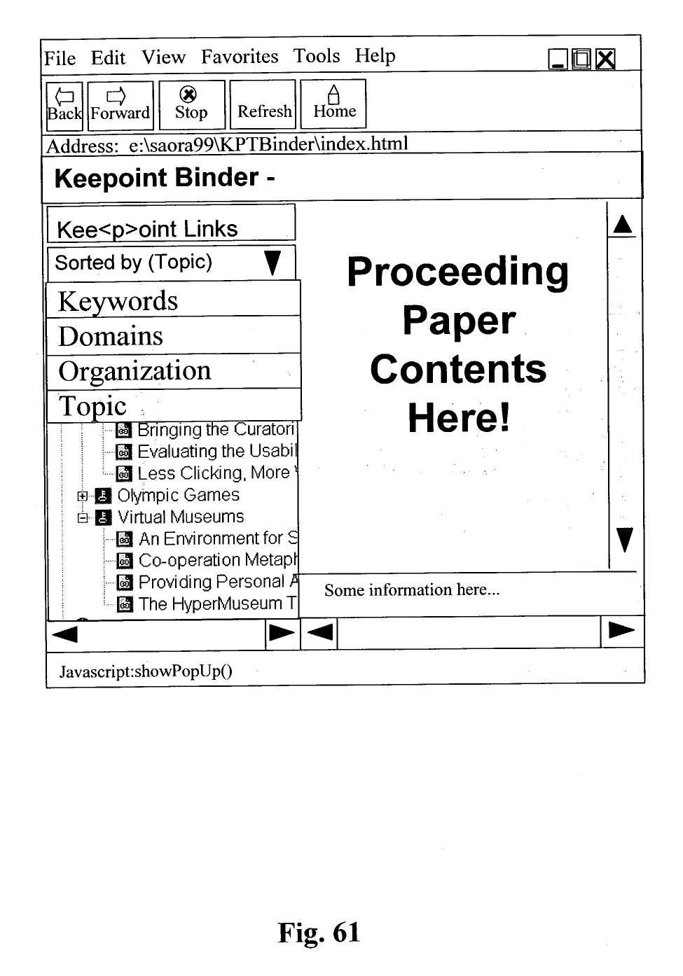

FIG. 61 is another example of exported data, in which the type by which the information is to be sorted is obtained using a pull down menu type of user interface.

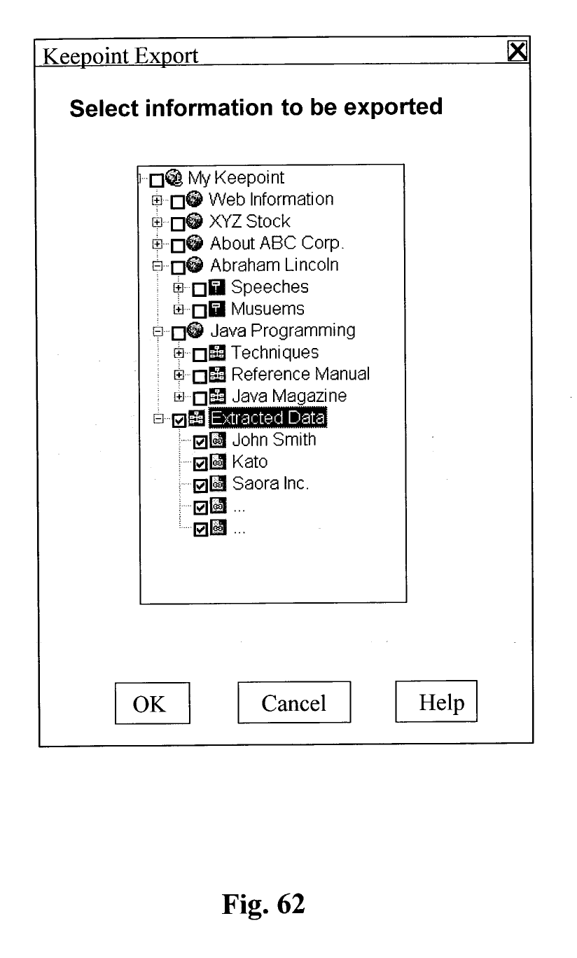

FIG. 62 is another example user interface to specify the information to be exported. As can be seen from the figure, the data extracted using this embodiment has been selected.

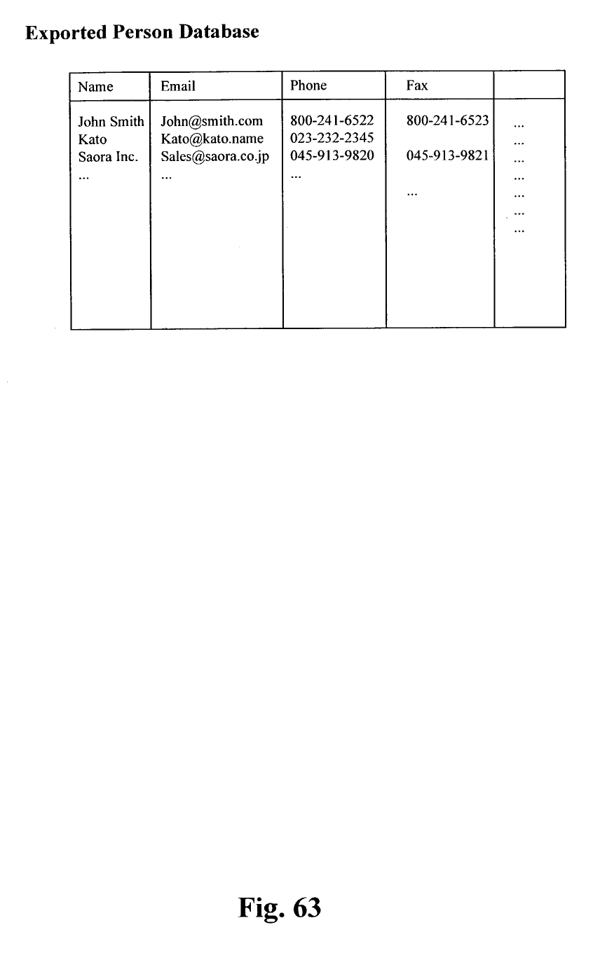

FIG. 63 is an example output of the exported address book data.

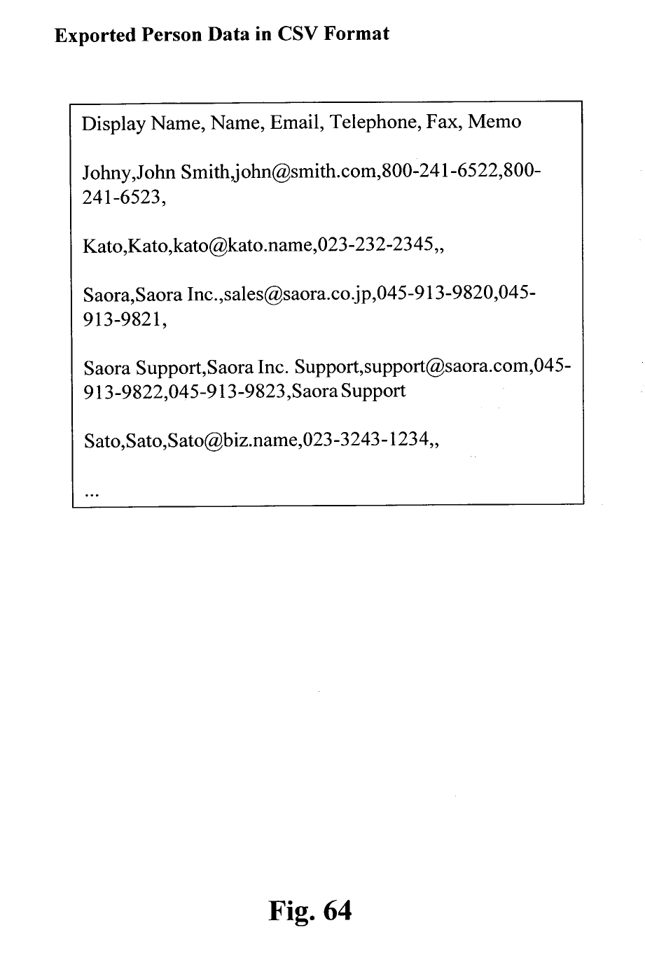

FIG. 64 is an example output of the exported address book data in a comma separated CSV format.

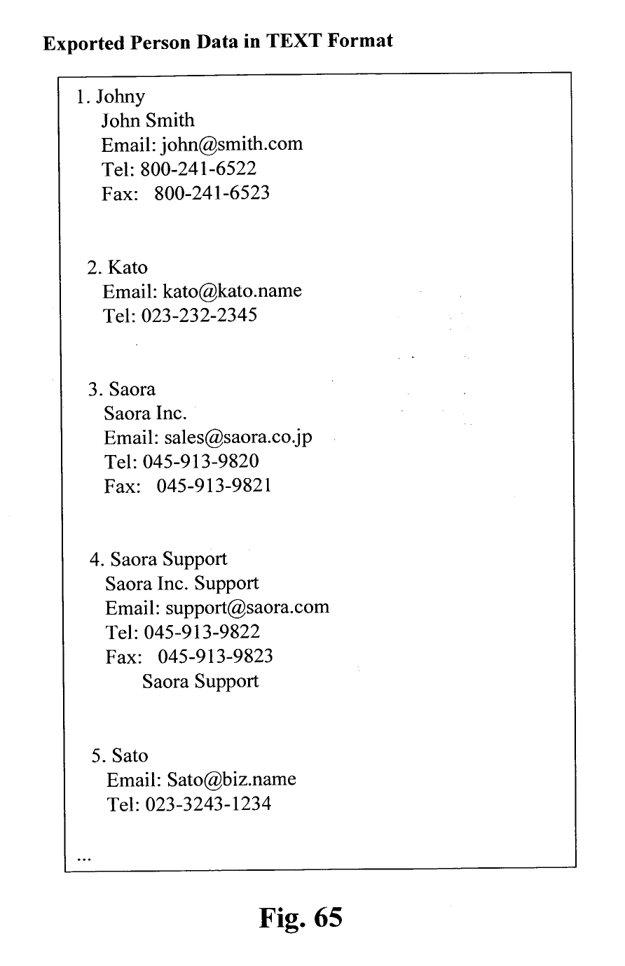

FIG. 65 is an example output of the exported address book data in Text format.

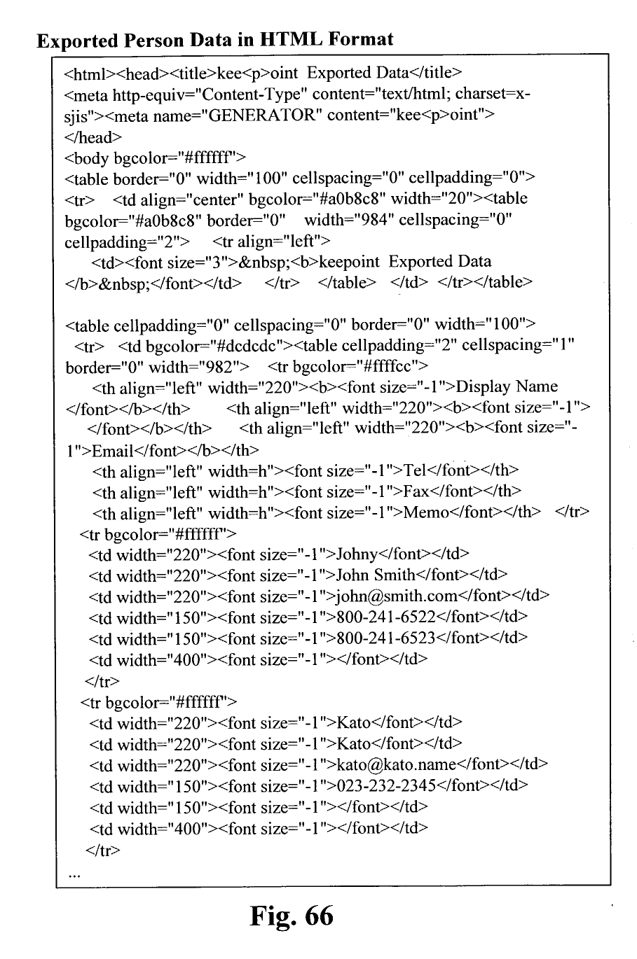

FIG. 66 is an example output of the exported address book data in HTML format.

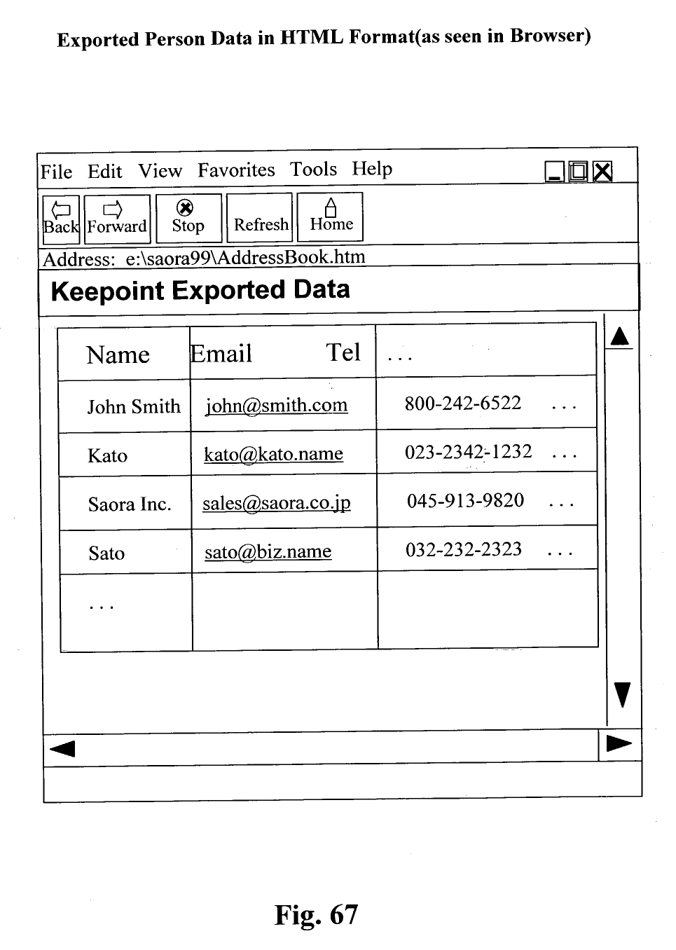

FIG. 67 is example information as seen in a browser of the exported address book data.

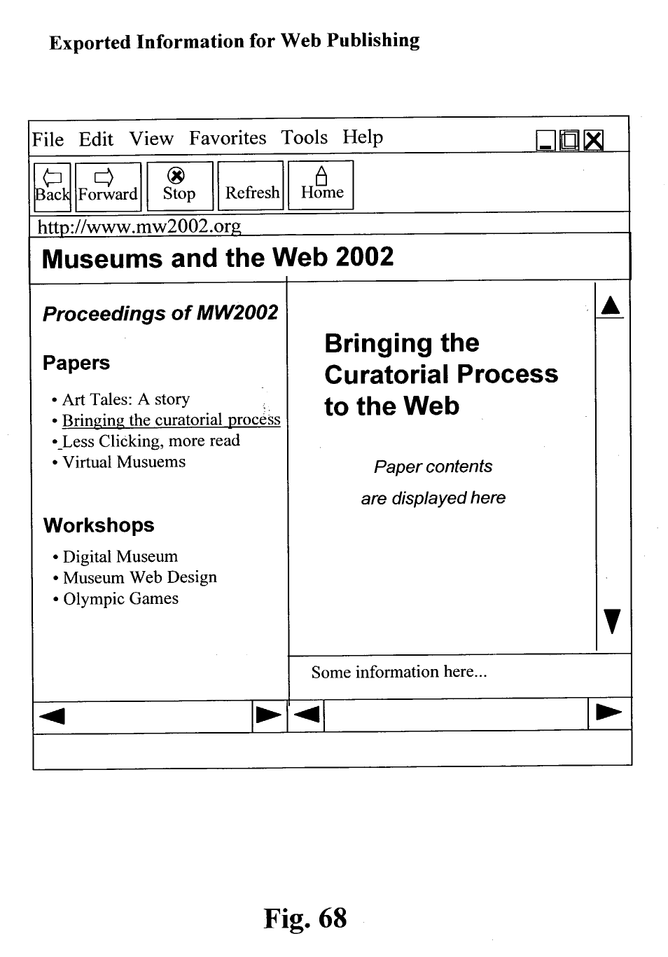

FIG. 68 is an example of viewing the published information from this embodiment. It is also possible to export information from this embodiment to allow publishing the information, for e.g., on a web server or in form of printed information.

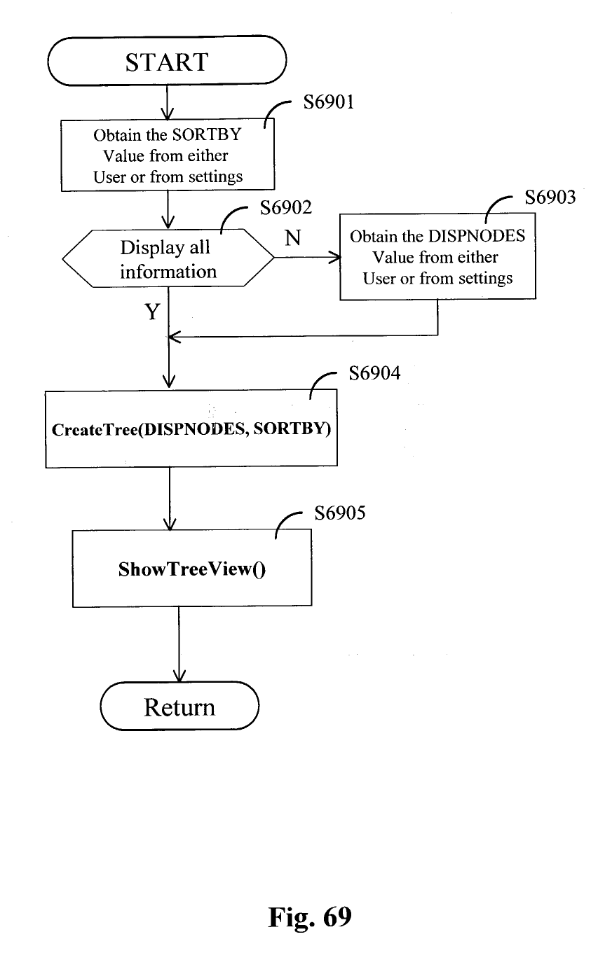

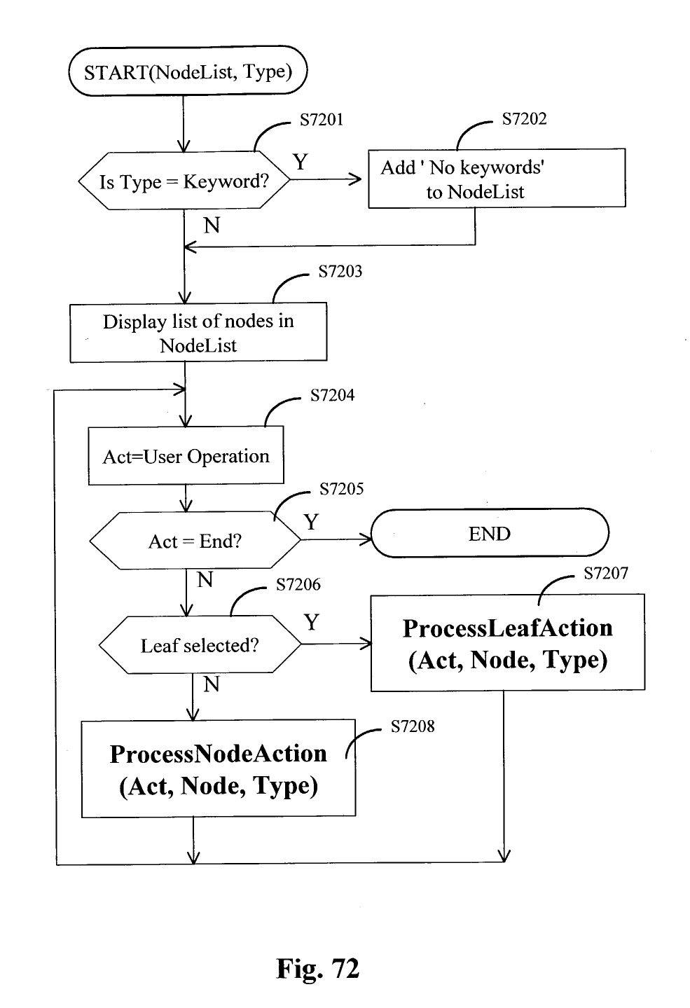

FIG. 69 is an alternative flowchart of the procedural steps of S1004 ShowLinks or S1006 ShowSession of this embodiment. In step S6901, the parameter in which the information is to be sorted, SORTBY is either obtained from the user or from system settings. In step S6902, a check is made to determine if all the information needs to be displayed. If not, the nodes to be displayed DISPNODES are either obtained from the user or from settings in step S6903. In either case, step S6904 CreateTree is executed, which is explained in detail later in FIG. 70. The actual tree view is displayed in step S6905 ShowTreeView, which is also explained in detail later in FIG. 72. When the user closes the view, the process returns.

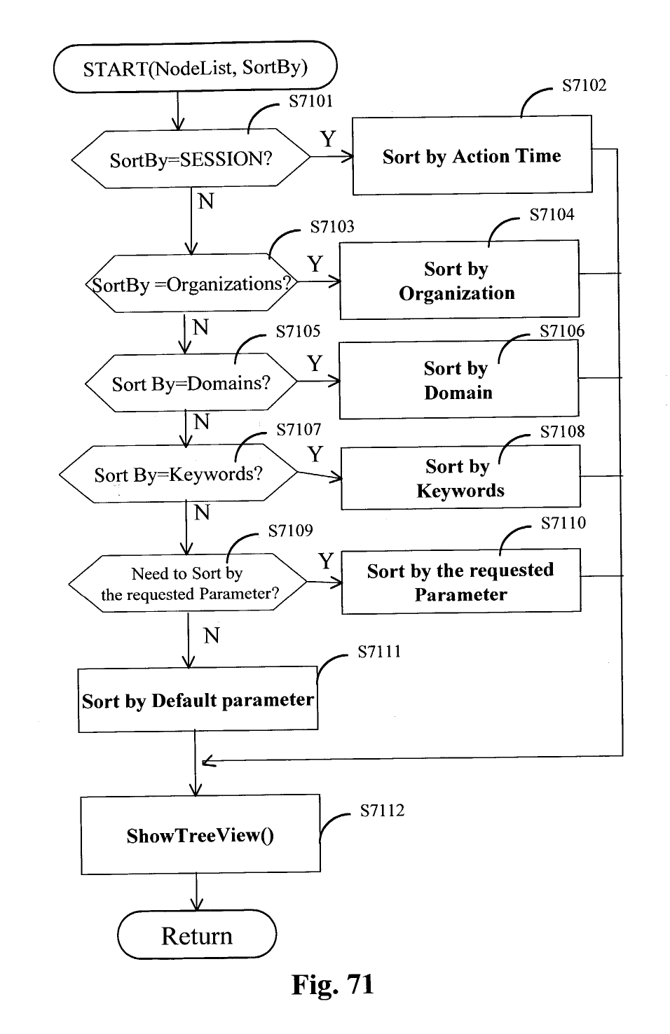

FIG. 70 is a flowchart of the procedural steps of CreateTree. In step S7001, the NodeList is set to NULL. In step S7002, the next node N1 is obtained from the list of nodes to be displayed, DISPNODES. A check is made in step S7003 to determine, if N1 exists. If all the nodes in the DISPNODES list has been exhausted, then step S7004, SortTreeView is executed to sort the information based on SortBy, as explained in FIG. 71 and the process returns. Otherwise, step S7005 is executed to obtain all the relevant list L1 for node N1 from the knowledge base. In step S7006, the next node information K1 is obtained from list L1. A check is made in step S7007 to determine if K1 exists. If node K1 does not exist, the control goes back to step S7002 to fetch the next node from DISPNODES. Otherwise, step S7008 is executed to determine, if the information K1 is unnecessary information. If so, the process loops back to S7006, to obtain the next information from L1. If not, step S7009 is executed, where in a check is made to determine if K1 already exists in nodelist. If so, the process loops back to S7006, to obtain the next information from L1. Otherwise, step S7010 is executed, in which the K1 is added to the appropriate place in NodeList and process loops back to S7006, to obtain the next information from L1, till there is no more information left, at which stage the process returns.

FIG. 71 is a flowchart of the procedural steps of SortTreeView. In step S7101, the a check is made to determine if SortBy is SESSION, in which case step S7102 is executed to sort all the action by time and process proceeds to step S7112. If not, a check is made in step S7103 to determine if SortBy is Organizations, in which case step S7104 is executed to sort all the actions by Organizations. If not, a check is made in step S7105 to determine if the SortBy is Domains, in which case step S7106 is executed to sort all the actions by Domain. If not, a check is made in step S7107 to determine if the SortBy is Keywords, in which case step S7108 is executed to sort all the actions by Keywords. If not a check is made in step S7109 to determine if there is a need to sort by the requested parameter. If so, step S7101 is executed and all the actions are sorted by the requested parameter, otherwise step S7111 is executed to sort by the default parameter, which could either be from user settings or from the previous parameter by which the sort was performed. In all of the above cases, step S7112 ShowTreeView is executed, which is explained in detail in next FIG. 72. and the process returns.

FIG. 72 is a flowchart of the procedural steps of ShowTreeView S7112 of this embodiment. First in step S7201, a check is made to determine if Type is Keyword. If so, No keywords is added to the NodeList in step S7202. In step S7203, the list of nodes in the NodeList is displayed. In step S7204 the process waits for user operation or Action Act and in step S7205, a check is made to determine if the Act is End, in which case the process returns. If not, a check is made in step S7206 to determine if a Leaf was selected. If so ProcessLeafAction(Act, Node, Type) is executed in step S7207. If not, ProcessNodeAction(Act, Node, Type) is executed in step S7208 and the process returns to step S7204.

FIG. 73 is a flowchart of the procedural steps of ProcessLeafAction(Act, Node, Type) of step S7207 of this embodiment. A check is made in step S7301, if the Act is Open. If so, all the child nodes and all the actions KPTAction and associated KPTDocument are fetched in step S7302, from the knowledge base for the selected node and added to the NodeList at appropriate places in step S7303 and continues to step S7309. If not, a check is made in step S7304, if the Act is Close. If so, all the child nodes below the selected node are closed or hidden in step S7305 and continues to step S7309. If not, a check is made to determine if the Act is Delete. If so, a confirmation is sought from the user, if required, in step S7307 and if delete is not to be performed, it continues to step S7309, else all the KPTAction and associated KPTDocument for all the child nodes below the selected node is deleted from the knowledge base in step S7308 and continues to step S7309. In step S7309, the knowledge base is updated based on the type of action performed and in step S7310 the user interface is updated to reflect the updates made in the knowledge base. If in step S7306, the action is not Delete, the process returns.

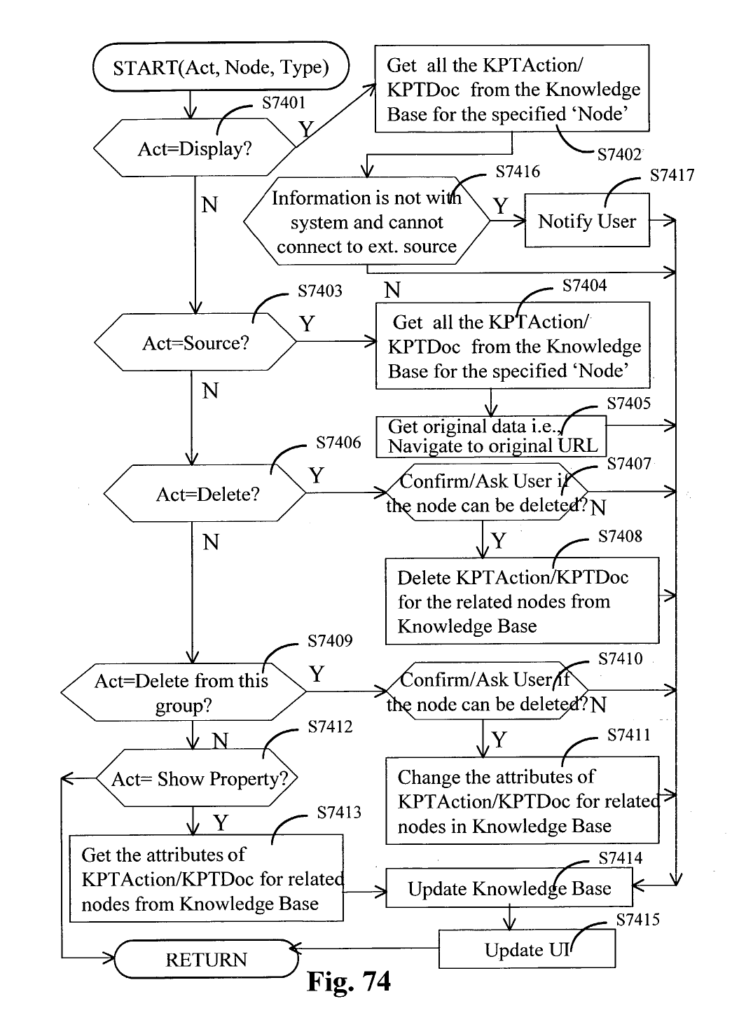

FIG. 74 is a flowchart of the procedural steps of ProcessNodeAction(Act, Node, Type) of step S7208 of this embodiment. A check is made in step S7401 to determine if the Act is Display i.e., to display the contents of the stored page, if contents are stored, otherwise, the original page needs to be displayed. If so, all the KPTAction and associated KPTDocument are fetched from the knowledge base for the selected node and added to the NodeList at appropriate place in step S7402 and a check is made in step S7416 to determine if the information is not with the system of this embodiment and that no connection could be made to the source of the information, then the user is notified in step S7417 and proceeds to step S7414. Otherwise also step S7414 is executed, wherein the knowledge base is updated. If not, a check is made in step S7403 to determine if the Act is Source i.e., to display the contents of the original page. If so, the KPTAction and associated KPTDocument are fetched from the knowledge base for the selected node in step S7404 and fetches the contents of the page from the original location or URL in step S7405 and continues to step S7414. If not, a check is made to determine if the Act is Delete in step S7406. If so, a confirmation is sought from the user, if required, in step S7407 and if delete is not to be performed, it continues to step S7414, else in step S7408, the associated KPTAction and KPTDocument are deleted from the knowledge base and continues to step S7414. If not, a check is made in step S7409 to determine if the Act is Delete from this group. If so, a confirmation is sought from the user, if required, in step S7410 and if delete is not to be performed, it continues to step S7414, else in step S7411, the associated attributes or properties of KPTAction and KPTDocument are modified in the knowledge base and continues to step S7414. If not, a check is made in step S7412 to determine if the Act is Show Property. If so, the associated properties or attributes of the KPTAction and KPTDocument for the associated node are fetched from the knowledge base in step S7413 and continues to step S7414. In step S7414, the knowledge base is updated based on the type of action performed and in step S7415 the user interface is updated to reflect the updates made in the knowledge base. If in step S7412, the action is not Show Property, the process returns.

It is possible that some data is in KB of KPT System and the rest of the data is in an external media like CD-ROM or on network like file server etc . . . For e.g., the index pages and top-level pages, which are used often, can be kept with KPT System and rest of the pages not used often can be in CD ROM. For example, in the case of the proceedings of a conference, the index and top level pages can be stored with KPT System but the actual details of papers presented, author biography etc. can be stored in a CD-ROM as they are less frequently used. 7316, a check is made to determine if some data exists in outside, and if the data can be accessed, for e.g., the CD may not be inserted or may not be connected to network, the user will be prompted as shown in FIG. 37 to insert the CD. Of course, using the KPT System, the user can choose and save the most relevant pages to the KPT System thus eliminating the need to always insert the CD for pages he or she uses frequently.

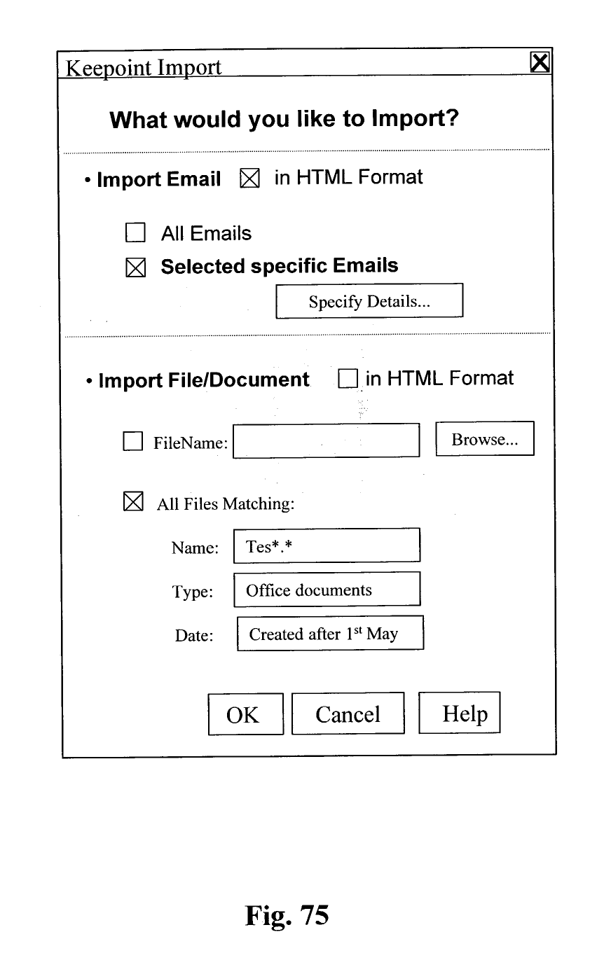

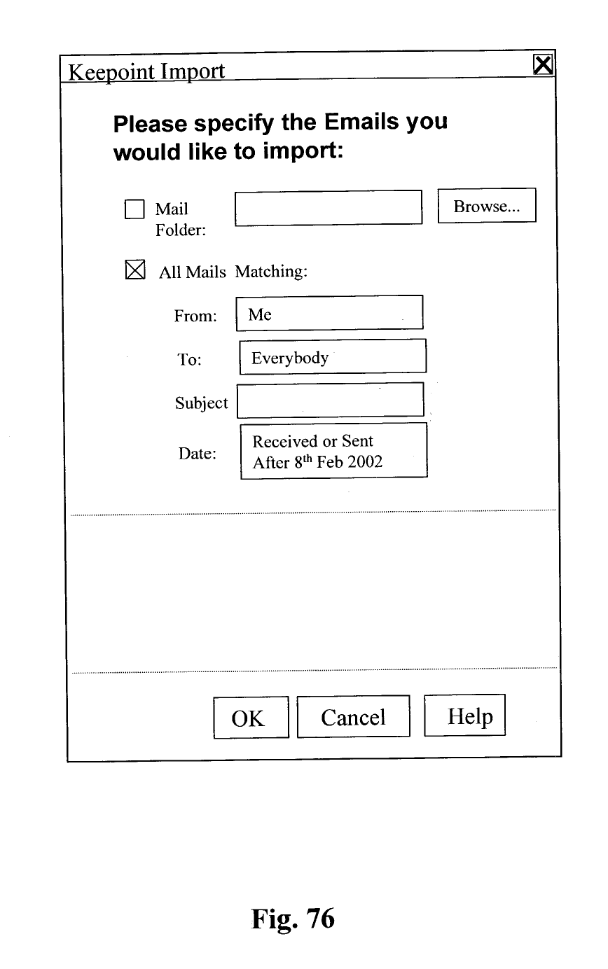

FIG. 75 shows an example UI for Importing Email or Documents, when import other is selected in FIG. 29. As can be seen from the figure, either all the Emails can be imported or only a selected set can be imported using the “specify details”, an example of which is shown in FIG. 76. Files or documents can also be imported in a similar fashion, by either specifying the document to import or using a filter to fetch the matching files e.g., by name or by type i.e., all Word Processed documents, and/or by date. Also, the emails or files or documents can be imported either in ASIS or can be converted to HTML during the import process.

FIG. 76 shows an example UI for specifying the mails that needs to be imported into the current embodiment. As can be seen from the figure, the user can either import all the mails from a specified folder or can specify a complex condition using various parameters. For e.g., From, To, Subject and date.

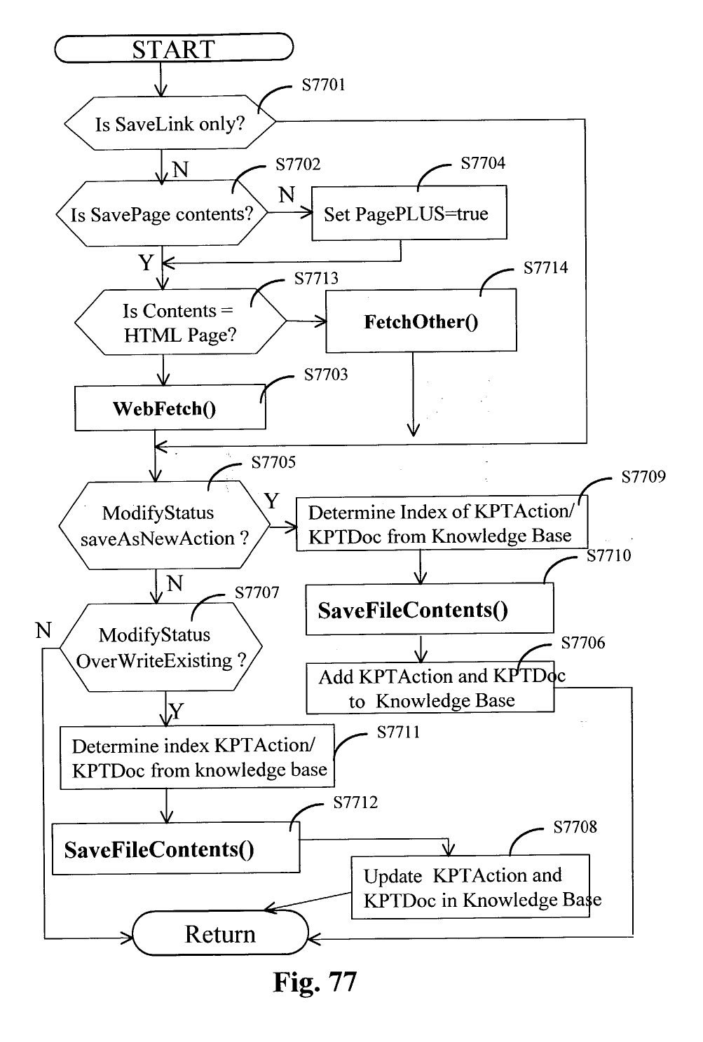

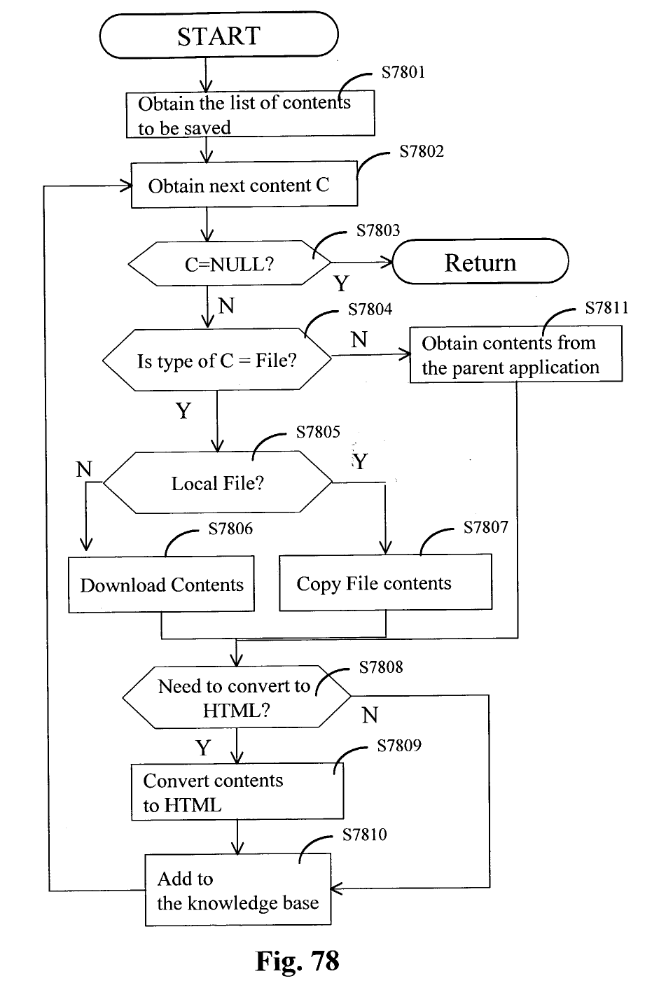

FIG. 77 shows another flowchart of SaveContent to enable importing of non-HTML documents into the current embodiment. The main flow is similar to FIG. 14 of this embodiment and a check is made in step S7713 to see if the imported document content is a HTML page, in which case WebFetch( ) is called, which was explained in detail in FIG. 15. Otherwise, FetchOther( ) is called in step S7714, details of which are explained in FIG. 78. Other steps of this Figure are similar to FIG. 14 of this embodiment.

FIG. 78 shows the flowchart of FetchOther of this embodiment. The list of contents to be saved are first obtained in step S7801 and instep S7802, the next content to be saved C is obtained. A check is made in step S7803 to determine if C is NULL, in which case the process returns. Otherwise, a check is made in step S7804 to determine if C is a file. If not, the contents are obtained from the parent or owner application in step S7811 and process proceeds to step S7808. Otherwise, a check is made in step S7805 to determine if C is a local file, in which case step S7807 is executed to copy the file contents, otherwise step S7806 is executed and the contents are downloaded. In either case S7808 is executed to check if the contents needs to be converted to HTML. If so, the contents are converted to HTML in step S7809. In either case step S7810 is executed, wherein the contents are added to the knowledge base and the process returns to step S7802 to obtain the next content C from the list of contents, till no more contents are left in the list. If fetch type is a file, then the contents needs to be only downloaded or copied otherwise the contents or data to be imported needs to be first obtained from the underlying application. For example, during import of email, the email data needs to be obtained from the mailing application. It may so happen that the email application may store the data in normal file, in which case the embodiment can fetch it as normal file. Also several ways exist to obtain the information from the parent or underlying application, for example, Dynamic Data Exchange (DDE), OLE Automation, COM, COBRA etc.

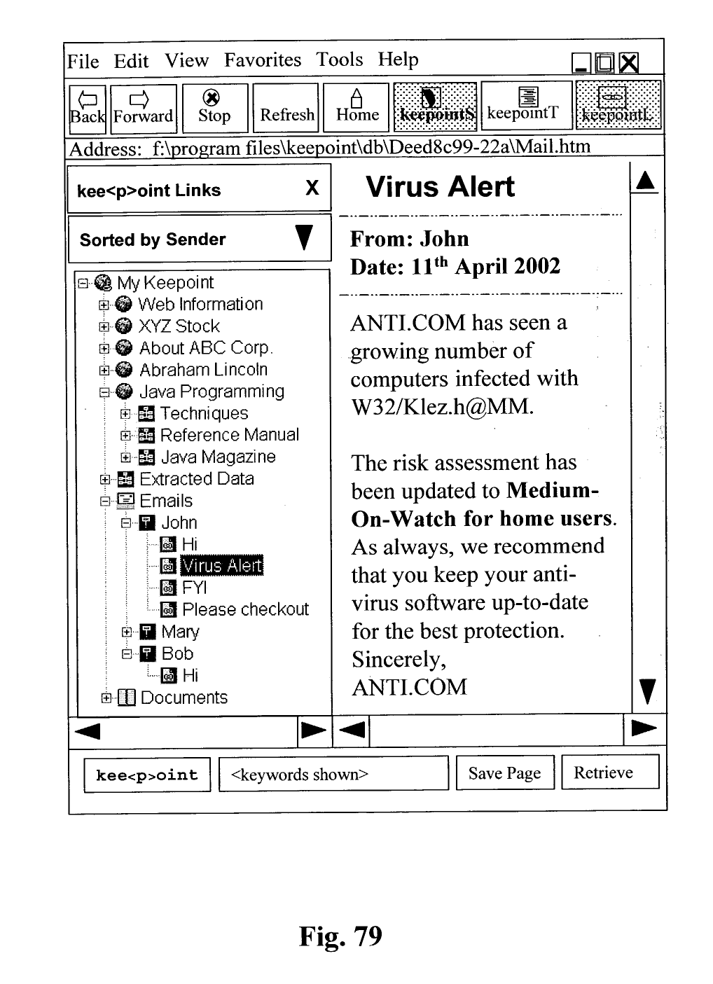

FIG. 79 is an example of Get all Links sorted by Sender for the imported email information. As can be seen from the figure, the imported emails are shown sorted by Sender.

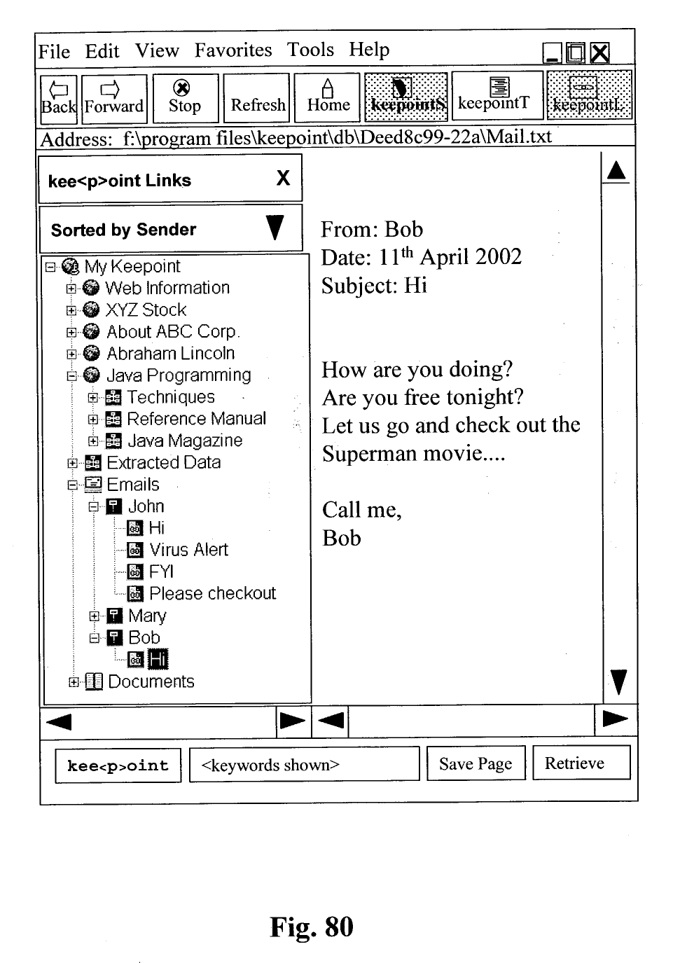

FIG. 80 is another example of Get all Links sorted by Sender for the imported email information.

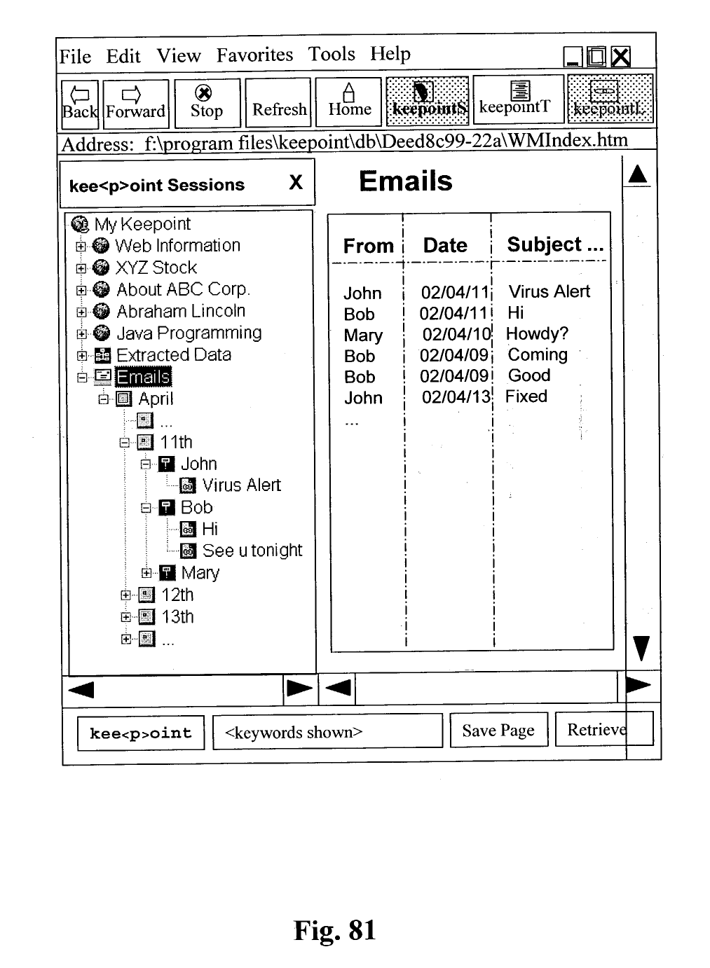

FIG. 81 is an example of Show Sessions for the imported email information. The mail list is shown in tabular form.

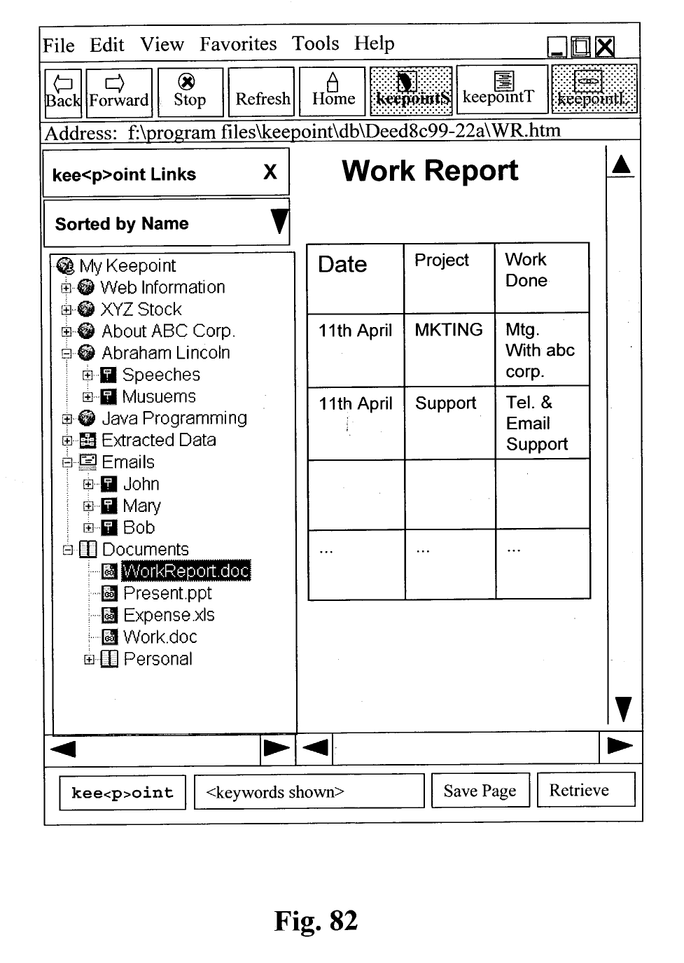

FIG. 82 is an example of Get all Links sorted by Name for the imported documents. The various documents are shown below the Documents node, and the contents of the document are shown on the right hand side.

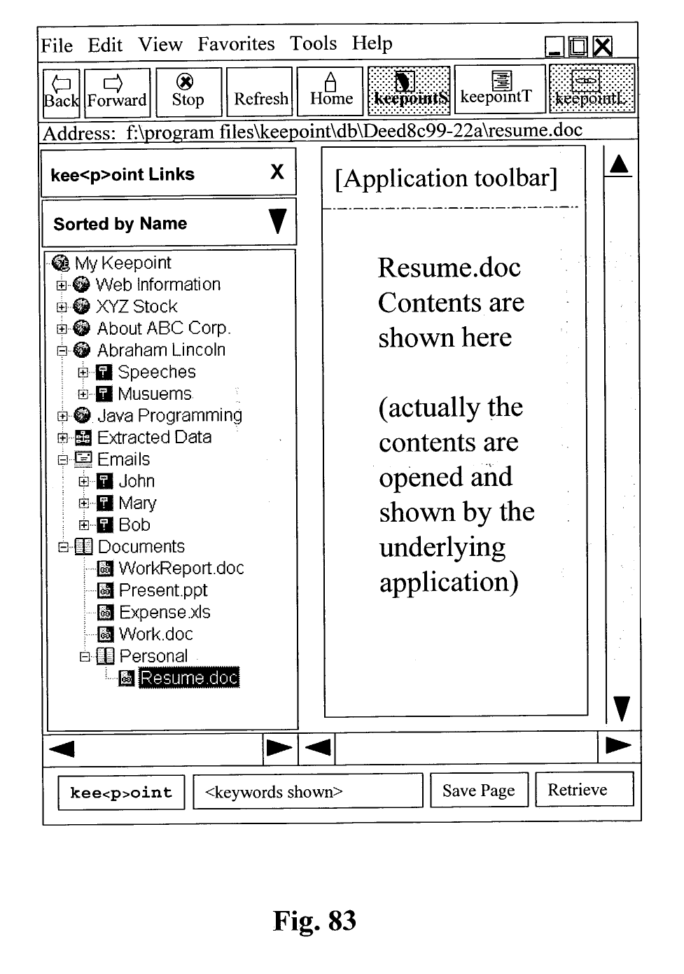

FIG. 83 is another example of Get all Links sorted by Name for the imported documents, which is imported in AS IS format. When user views the application in the browser, the relevant application, for e.g., word processor is launched within the browser as shown in the figure.

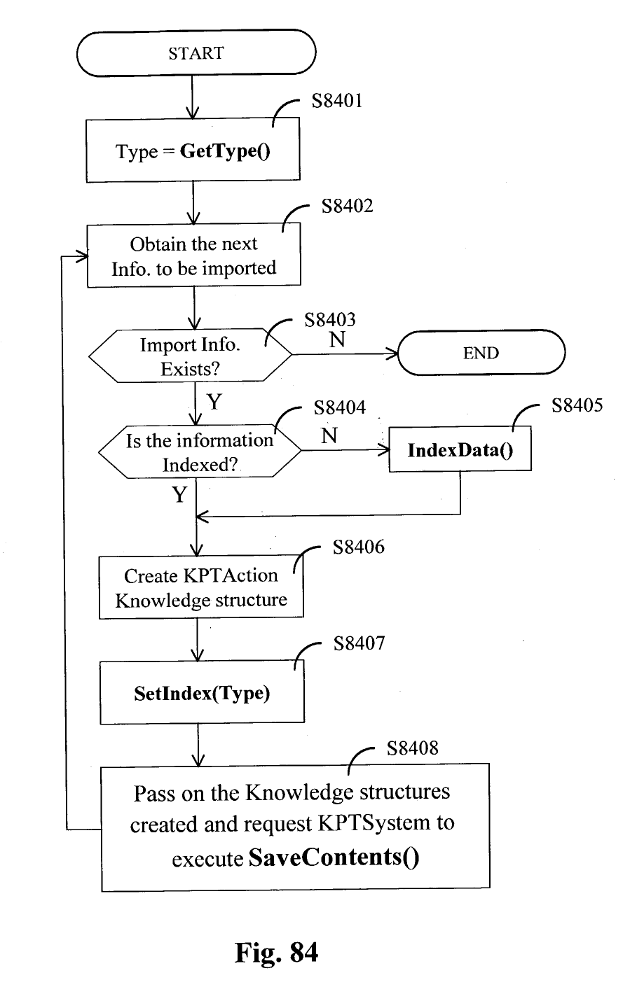

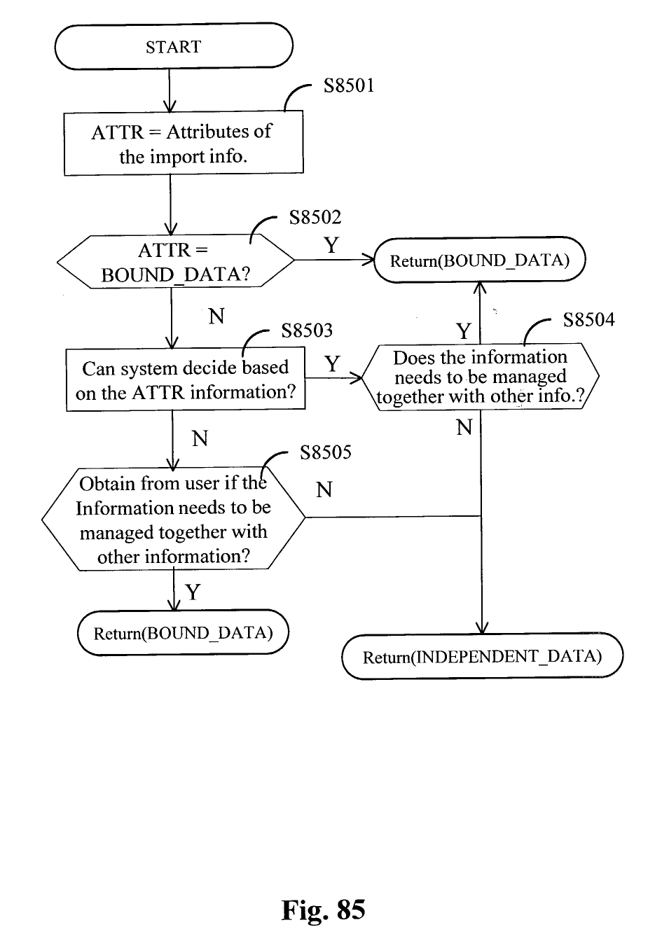

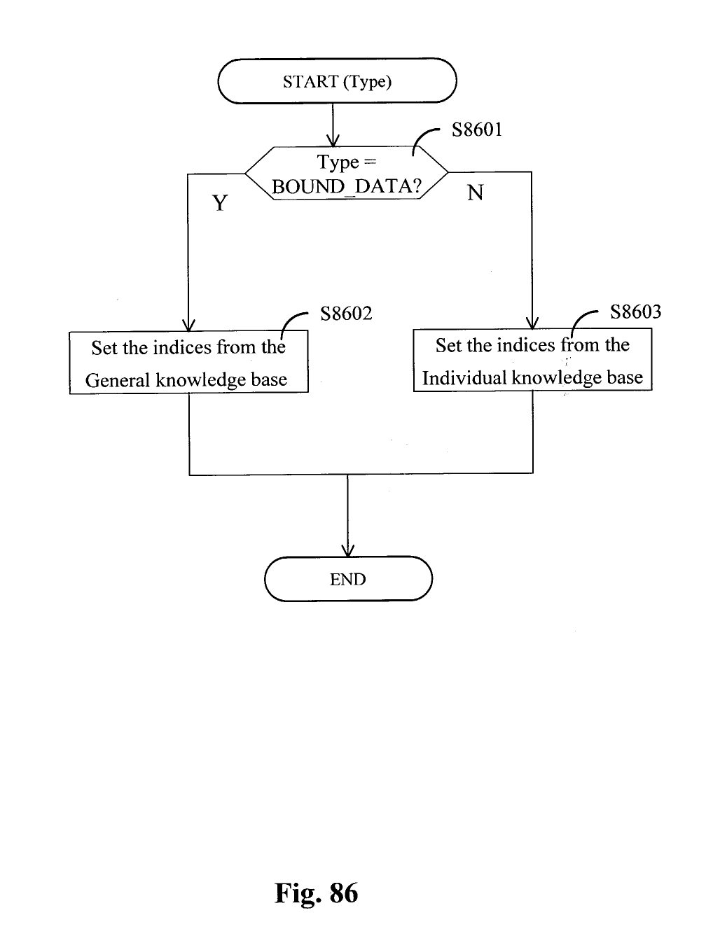

FIG. 84 is a flowchart of the procedural steps of another implementation of ImportData for this embodiment. In step S8401, the type of the information being imported is obtained using GetType, which is explained in detail in FIG. 85 and in step S8402, the next information to be imported is obtained. A check is made in step S8403 to determine if the Import information exists. If not the process ends otherwise a check is made in step S8404 to determine if the information is indexed. If not, step S8405 IndexData is executed, which was explained earlier in FIG. 22. In either case step S8406 is executed to create the KPTAction knowledge structure and in step S8407, SetIndex is executed, which is explained in detail in FIG. 86. In step S8408, the necessary knowledge structures are created and a request is made to KPTSystem of this embodiment to execute SaveContents for the created contents and loops back to step S8402 to fetch the next information to be imported, till there are no more information left to be imported.

FIG. 85 is a flowchart of the procedural steps of GetType. In step S8501, the attributes of the information being imported is obtained and set to ATTR. In step S8502, a check is made to determine if ATTR is BOUND_DATA. If so, BOUND_DATA is returned. If not, a check is made in step S8503 to determine if the system can decide based on the ATTR information. If so, a check is made in step S8504 to determine if the information needs to be managed together with other information. If so, the process returns BOUND_DATA, otherwise INDEPENDENT_DATA is returned. If the system cannot decide based on the ATTR information, the necessary information is obtained from the user in step S8505 and if the information is to be managed with other information, BOUND_DATA is returned, otherwise INDEPENDENT_DATA is returned.

FIG. 86 is a flowchart of the procedural steps of SetIndex. A check is made in step S8601 to determine if Type is BOUND_DATA. If so, step S8602 is executed in which the indices from the general knowledge base, otherwise the indices are obtained from the individual knowledge base and the process ends.

The present invention described above may be applied to a system constituted of a plurality of computers, or a specific computer within a system. The object of the present invention can also be achieved by supplying a storage medium storing program codes of software for implementing the function of the above embodiment to a system or an apparatus, and reading out and executing the program codes stored in the storage medium by a computer (or a CPU or MPU) of the system or apparatus. In this case, the program codes read out from the storage medium implement the function of the present invention, and the storage medium storing these program codes constitutes the invention. Also, besides the function of the above embodiment is implemented by executing the readout program codes by the computer, the present invention includes a case where an OS (Operating System) or the like running on the computer performs a part or the whole of actual processing in accordance with designations by the program codes and thereby implements the function of the above embodiment.

Furthermore, the present invention also includes a case where, after the program codes read out from the storage medium are written in a memory of a function extension board inserted into the computer or of a function extension unit connected to the computer, a CPU or the like of the function extension board or function extension unit performs a part or the whole of actual processing in accordance with designations by the program codes and thereby implements the function of the above embodiment.

Although the present invention has been described in its preferred form with a certain degree of particularity, many apparently widely different embodiments of the invention can be made without departing from the spirit and scope thereof. It is to be understood that the invention is not limited to the specific embodiments thereof except as defined in the appended claims.

What is claimed is:

1. A data processing method comprising the steps of:
obtaining data displayed by a browser;
importing data without displaying the data; and
storing and managing the obtained data and the imported data.

2. The method according to claim 1, wherein in said managing step, the stored data are managed with distinguishing between the obtained data and the imported data.

3. The method according to claim 1, wherein in said managing step, the stored data are managed without distinguishing between the obtained data and the imported data.

4. The method according to claim 1, wherein in said managing step, it is determined whether or not the stored data are managed with distinguishing between the obtained data and the imported data, and the stored data are managed based upon the result of the determination.

5. The method according to claim 4, wherein in said managing step, the determination is performed in accordance with the imported data.

6. The method according to claim 1, wherein the imported data is a book mark or a URL.

7. The method according to claim 1, wherein the imported data is a text described in a markup language.

8. The method according to claim 1, wherein the imported data is a folder including files of a plurality of layers.

9. The method according to claim 1, further comprising the indexing step for assigning a index to the imported data.

10. The method according to claim 9, wherein in said indexing step, the index is assigned in accordance with a predetermined rule.

11. The method according to claim 9, wherein in said indexing step, an index of data is maintained if the index has already been assigned to the data.

12. The method according to claim 9, wherein in said indexing step, an index specified by a user is assigned to the data.

13. The method according to claim 9, further comprising the steps of:
sorting indices assigned in said assigning step; and
displaying the sorted indices on a display.

14. The method according to claim 9, wherein the index includes at least one of domain, organization, author, and session.

15. The method according to claim 1, wherein in said importing step, the imported data are a set of data with the same feature.

16. The method according to claim 15, wherein in said importing step, the imported data is a bulletin or a list of names.

17. The method according to claim 15, wherein in said importing step, the imported data is a data of a particular organization or person.

18. The method according to claim 1, wherein in said importing step, the data is imported from a specified URL at a designated time.

19. The method according to claim 1, wherein in said managing step, the imported data is stored in a specified folder.

20. The method according to claim 19, further comprising the steps of:
assigning a index to the imported data;
sorting assigned indices in each folder; and
displaying the sorted indices on a display.

21. The method according to claim 1, wherein in said importing step, the data having a predetermined index is imported from a whole of a network.

22. The method according to claim 1, further comprising the steps of:
determining a display form of the imported data; and
displaying the imported data in the determined form.

23. The method according to claim 22, wherein in said determining step, the display form is determined based on an instruction by a user.

24. The method according to claim 22, wherein in said determining step, a type of the imported data is discriminated and the display form is determined in accordance with the discriminated type.

25. The method according to claim 22, wherein a first or a second display form is determined in said determining step, the data is displayed without any changes in the first display form and the data is displayed after processing the data in the second display form.

26. The method according to claim 22, wherein the data is displayed in the form of graph in the second display form.

27. A data processing method comprising the steps of:
obtaining data displayed by a browser;
storing and managing the obtained data; and
exporting the managed data.

28. The method according to claim 27, wherein in said exporting step, the data to be exported is specified from the managed data and the specified data is exported.

29. The method according to claim 27, wherein in said exporting step, a data form for exporting the data is specified.

30. The method according to claim 27, further comprising the indexing step for assigning a index to the data to be exported.

31. The method according to claim 30, wherein in said indexing step, the index is assigned in accordance with a predetermined rule.

32. The method according to claim 30, wherein in said indexing step, an index specified by a user is assigned to the data.

33. The method according to claim 27, further comprising the generating step for generating a program for sorting the assigned indices and displaying the sorted indices in another browser and in said exporting step, the program is exported with the data to which the index is assigned.

34. The method according to claim 27, wherein in said exporting step, the data is exported to a specified database.

35. The method according to claim 34, wherein in said exporting step, the data is processed so that the data can be stored in the specified database.

36. The method according to claim 27, wherein in said exporting step, the data is modified so that the data can be easily opened to the public.

37. The method according to claim 27, further comprising the steps of:
importing data without displaying the data; and
managing the imported data so that the data can be exported.

38. A data processing apparatus comprising:
obtaining means for obtaining data displayed by a browser;
importing means for importing data without displaying the data; and
management means for storing and managing the obtained data and the imported data.

39. A data processing apparatus comprising:
obtaining means for obtaining data displayed by a browser;
management means for storing and managing the obtained data; and
exporting means for exporting the managed data.

40. A computer-executable program for controlling a computer to perform data processing, said program comprising codes for causing the computer to perform the steps of:
obtaining data displayed by a browser;
importing data without displaying the data; and
storing and managing the obtained data and the imported data.

41. A data processing method comprising the steps of:
obtaining means for obtaining data displayed by a browser;
management means for storing and managing the obtained data; and
exporting means for exporting the managed data.

42. A computer-executable program for controlling a computer to perform data processing, said program comprising codes for causing the computer to perform the steps of:
obtaining data displayed by a browser;
storing and managing the obtained data; and
exporting the managed data.
